(19) United States
(12) Patent Application Publication
(10) Pub. No.: US 2020/0254737 A1
(43) Pub. Date: Aug. 13, 2020

(54) MACHINE DIRECTION-ORIENTED POLYMERIC FILM, AND METHOD OF MAKING THE MACHINE DIRECTION-ORIENTED POLYMERIC FILM

(71) Applicant: BERRY GLOBAL, INC., Evansville, IN (US)

(72) Inventors: Bryan S. GILLESPIE, Altoona, WI (US); Paul Z. WOLAK, Indianapolis, IN (US)

(21) Appl. No.: 16/778,516

(22) Filed: Jan. 31, 2020

Related U.S. Application Data
(60) Provisional application No. 62/804,281, filed on Feb. 12, 2019.

(51) Int. Cl. B32B 27/08; B32B 27/32

(52) U.S. Cl. CPC B32B 27/08; B32B 27/306; B32B 27/32

(57) ABSTRACT

Machine direction-oriented polymeric films include a polyolefin. Methods for forming polymeric films and articles of manufacture prepared therefrom are described.

### CROSS REFERENCE TO RELATED APPLICATIONS

This application claims the benefit of U.S. Provisional Application No. 62/804,281, filed Feb. 12, 2019. The entire content of this priority application is incorporated herein by reference, except that in the event of any inconsistent disclosure or definition from the present specification, the disclosure or definition herein shall be deemed to prevail.

### BACKGROUND

The present disclosure relates to polymeric materials, and particularly to polymeric films. More particularly, the present disclosure relates to polymeric films formed from polymeric material.

### SUMMARY

According to the present disclosure, a machine direction-oriented polymeric film is made using a manufacturing process. The manufacturing process comprises the step of stretching a pre-heated multi-layer film to form the machine direction-oriented polymeric film.

In illustrative embodiments, the machine direction-oriented polymeric film comprises a first skin layer comprising medium molecular weight high density polyolefin, a core layer, and a second skin layer comprising a heat-sealable polymer.

In illustrative embodiments, the machine direction-oriented polymeric film comprises a first skin layer, a core layer, and a second skin layer comprising a heat-sealable polymer, wherein a heat seal initiation temperature of the heat-sealable polymer is less than about 110° C. as measured by ASTM F2029-00 and ASTM F88-00.

In illustrative embodiments, the machine direction-oriented polymeric film has a strain at break in a machine direction of less than about 100%, and a 1% secant modulus in the machine direction of greater than about 150,000 pounds per square inch.

In illustrative embodiments, a packaging article comprises a machine direction-oriented polymeric film. In other illustrative embodiments, a packaging article comprises a machine direction-oriented polymeric film and a barrier film laminated thereto.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a diagrammatic view of a representative embodiment of a machine direction-oriented polymeric film that includes three layers;

FIG. 2 is a diagrammatic view of an exemplary process for machine direction (MD) stretching of a polymeric film

FIG. 3 is a diagrammatic view of a representative embodiment of a machine direction-oriented polymeric film that includes four layers;

FIG. 4 is a diagrammatic view of a representative embodiment of a machine direction-oriented polymeric film that includes five layers;

FIG. 5 is a diagrammatic view of a representative embodiment of a machine direction-oriented polymeric film that includes nine layers;

FIG. 6 is a diagrammatic view of an exemplary process for pre-heating, stretching, annealing, and cooling a precursor film;

FIG. 7 is a heat seal curve of load (grams) vs. temperature (° C.) for the film prepared from formulation X18-056B described in Example 4;

FIG. 8 is a heat seal curve of load (grams) vs. temperature (° C.) for the film prepared from formulation X18-108C described in Example 5;

FIG. 9 is a heat seal curve of load (grams) vs. temperature (° C.) for the film prepared from formulation X18-056G described in Example 6;

FIG. 10 is a heat seal curve of load (grams) vs. temperature (° C.) for the film prepared from formulation X18-056G.1 described in Example 7; and

FIG. 11 is a heat seal curve of load (grams) vs. temperature (° C.) for the film prepared from formulation X19-129A described in Example 8.

### DETAILED DESCRIPTION

In illustrative embodiments, the present disclosure provides a formulation for making a precursor film, which may be stretched via machine direction orientation (MDO) to provide a barrier film having a low activation sealant, reduced gauge, high stiffness, and/or low elongation. The MDO process aligns polymer chains in a manner that may improve barrier to moisture and, in some embodiments, satisfy the shelf life requirements of dry food packaging bag-in-box applications.

In illustrative embodiments, a skin layer with a low melting point is provided on one side of a film, and a non-nucleated polyethylene-containing skin layer is provided on the opposite side of the film. In some embodiments, an oxygen barrier polymer (e.g., EVOH) may be present in the film (e.g., in one of the non-skin layers), while in other embodiments, an oxygen barrier polymer is not present. In some embodiments, non-nucleated HDPE may be used as the bulk of the formulation in order to increase moisture barrier. In some embodiments, one or more toughening layers may be added in order to satisfy key physical properties like tear and puncture.

In illustrative embodiments, a barrier film in accordance with the present disclosure may be heat sealable on one surface, heat resistant on another surface, and exhibit both excellent moisture barrier and excellent oxygen barrier properties. The heat sealable surface of a film in accordance with the present disclosure is configured to create hermetic seals with low initiation temperatures, thereby facilitating high efficiency functioning on both horizontal form fill seal (HFFS) and vertical form fill and seal (VFFS) equipment. The formulation and process in accordance with the present disclosure may be used to increase moisture barrier on one hand while down-gauging film thickness on the other. In some embodiments, film thickness may be down-gauged to levels heretofore not observable for conventional high density polyethylene (HDPE).

In illustrative embodiments, the formulation for making the precursor film includes a minimum of a first skin layer containing polyethylene, a core layer containing polyethylene or an oxygen barrier polymer, and a second skin layer containing a heat-sealable polymer. In some embodiments, the first skin layer contains high density polyethylene (HDPE). In other embodiments, the first skin layer contains medium molecular weight high density polyethylene (MMW-HDPE). Using a draw ratio of greater than about 5:1 in an MDO process—in illustrative embodiments between about 5:1 and about 10:1—permits reduction of the gauge of the polymeric film to below 1.50 mils and, in illustrative embodiments, to below 1 mil.

In illustrative embodiments, an MD-oriented polymeric film in accordance with the present disclosure has one or more of the following properties: an MVTR of less than about 0.30 grams/100 in²/day @ 90% RH, a 1% secant modulus in a machine direction (i.e., stiffness) of greater than about 150 psi (in some embodiments greater than about 225,000 psi), a heat seal initiation of less than about 100° C. (in some embodiments, less than about 190° F.), a strain at break in a machine direction (i.e., elongation) of less than about 100% (in some embodiments, less than about 50% and in other embodiments less than about 30%), a stress at break in the machine direction of greater than about 25,000 pounds per square inch (psi), good heat resistance allowing for strong seal formation in packaging applications, or a combination thereof.

In some embodiments, an MD-oriented polymeric film in accordance with the present disclosure may be used as a print web. The low extensibility (elongation) of the resultant polymeric film facilitates printing onto the film with high accuracy (e.g., by keeping repeats more stable, minimizing stretching of print, and the like). In addition, the low extensibility of the resultant polymer film facilitates lamination of the film to other surfaces (e.g., by facilitating a lie-flat configuration of the film, minimizing undesirable curl, minimizing structural defects caused by adhesive smear, and the like). In illustrative embodiments, a polyethylene-containing polymeric film in accordance with the present disclosure may be advantageously used in packaging applications.

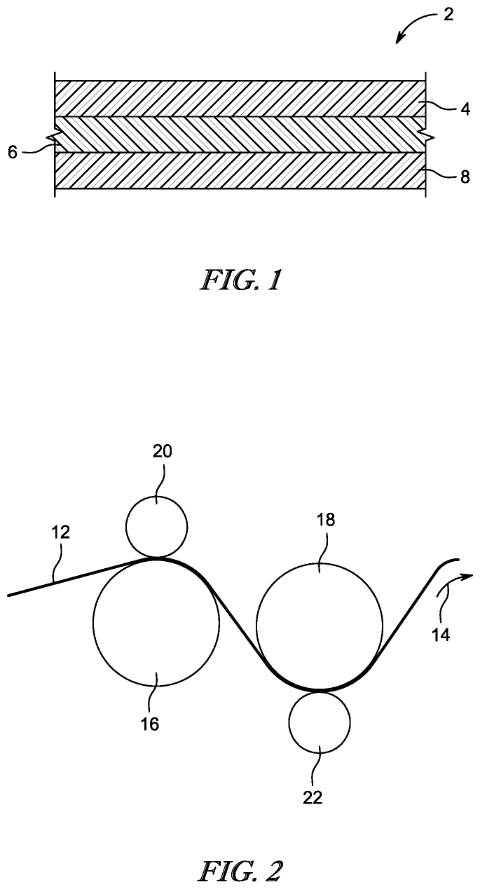

A first embodiment of a multi-layered, machine direction-oriented polymeric film 2 in accordance with the present disclosure is shown, for example, in FIG. 1. The machine direction-oriented polymeric film 2 has, at a minimum, a three-layer structure that includes a first skin layer 4, a second skin layer 8, and a core layer 6 interposed between the first skin layer 4 and the second skin layer 8. Each of the first skin layer 4, the core layer 6, and the second skin layer 8 may include a thermoplastic polymer (or combination of thermoplastic polymers). The choice of the thermoplastic polymer or combination of thermoplastic polymers in each of the first skin layer 4, the core layer 6, and the second skin layer 8 is independent of the other layers. However, in some embodiments, the first skin layer 4 includes high density polyethylene (HDPE). In other embodiments, the first skin layer 4 includes medium molecular weight high density polyethylene (MMW-HDPE). In some embodiments, the core layer 6 also includes high density polyethylene, whereas in other embodiments, the core layer 6 includes an oxygen barrier polymer (e.g., ethylene vinyl alcohol, a polyamide, a polyester, or polyvinylidene chloride). In illustrative embodiments, the second skin layer 8 includes a heat-sealable polymer which, in illustrative embodiments, may include polyethylene or a copolymer thereof. The heat-sealable polymer used in accordance with the present disclosure may include any polyethylene or copolymer thereof (e.g., ethylene-vinyl acetate) that melts at a lower temperature than a structural polymer (e.g., HDPE) of the polymeric film 2.

A precursor substrate film (i.e., a film prior to MDO) containing one or a combination of thermoplastic polymers may be produced by either a cast film process or a blown film process. In one example, a precursor substrate film to be stretched via MDO to form a machine direction-oriented polymeric film 2 in accordance with the present disclosure is formed via a blown film process. In another example, the precursor substrate film is formed via a cast film process. The cast film process involves the extrusion of molten polymers through an extrusion die to form a thin film, which is then pinned to the surface of a chill roll.

In one example, a machine direction-oriented polymeric film in accordance with the present disclosure may be manufactured by feed block coextrusion. In another example, a machine direction-oriented polymeric film in accordance with the present disclosure may be made by blown film (tubular) coextrusion. Methods for feed block and blown film extrusion are described in The Wiley Encyclopedia of Packaging Technology, pp. 233-238 (Aaron L. Brody et al. eds., 2nd Ed. 1997), which is incorporated herein by reference, except that in the event of any inconsistent disclosure or definition from the present specification, the disclosure or definition herein shall be deemed to prevail. Methods for film extrusion are also described in U.S. Pat. No. 6,265,055, the entire contents of which are likewise incorporated by reference herein, except that in the event of any inconsistent disclosure or definition from the present specification, the disclosure or definition herein shall be deemed to prevail.

The precursor substrate film thus produced may then be stretched via machine direction (MD) orientation by a process analogous to that shown in simplified schematic form in FIG. 2 in order to form a machine direction-oriented polymeric film in accordance with the present disclosure. For example, the film 12 shown in FIG. 2 may be passed between at least two pairs of rollers in the direction of an arrow 14. In this example, first roller 16 and a first nip 20 run at a slower speed (V₁) than the speed (V₂) of a second roller 18 and a second nip 22. The ratio of V_{2/}V₁ determines the degree to which the film 14 is stretched. Since there may be enough drag on the roll surface to prevent slippage, the process may alternatively be run with the nips open. Thus, in the process shown in FIG. 2, the first nip 20 and the second nip 22 are optional.

A precursor substrate film containing one or more thermoplastic polymers that is subsequently stretched to form a machine direction-oriented polymeric film 2 in accordance with the present disclosure may be prepared by any suitable film-forming process presently known in the art or as yet to be developed. For example, the precursor substrate film may be manufactured by casting or extrusion using blown-film, co-extrusion, or single-layer extrusion techniques and/or the like. In one example, the precursor substrate film may be wound onto a winder roll for subsequent stretching in accordance with the present disclosure. In another example, the precursor substrate film may be manufactured in-line with a film stretching apparatus. Prior to stretching, the precursor substrate film may have an initial thickness of between about 2 mil and about 15 mil.

Although the representative example of a machine direction-oriented polymeric film 2 shown in FIG. 1 includes three layers, it is to be understood that the total number of layers in a polymeric film in accordance with the present disclosure is not restricted. Depending on the equipment available for the extrusion, and on the nature of the polymeric materials themselves, one or more additional layers may likewise be provided between the first skin layer 4 and the core layer 6 and/or between the second skin layer 8 and the core layer 6 of the structure 2 shown in FIG. 1. In some embodiments, 1 to 4 additional layers may be provided between the first skin layer 4 and the core layer 6 and/or between the second skin layer 8 and the core layer 6 of the structure 2 shown in FIG. 1. In some embodiments, a machine direction-oriented polymeric film in accordance with the present disclosure may contain four, five, seven, nine, eleven, or more total layers. An example of a representative four-layer structure is given below.

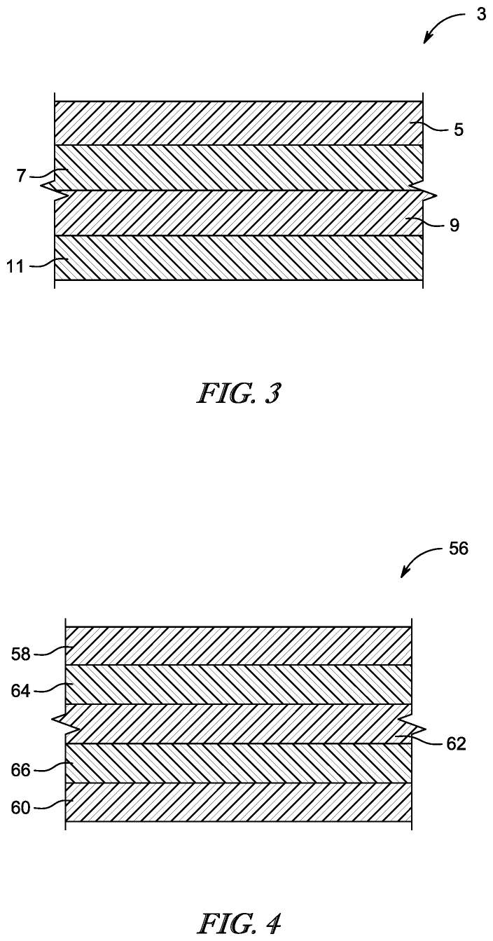

A second embodiment of a machine direction-oriented polymeric film 3 in accordance with the present disclosure is shown in FIG. 3. The machine direction-oriented polymeric film 3 has a four-layer structure and includes a first skin layer 5, a core layer 7, a second skin layer 11, and a first sub-skin layer 9 interposed between the second skin layer 11 and the core layer 7. In some embodiments, the first sub-skin layer 9 may alternatively be interposed between the first skin layer 5 and the core layer 7. Each of the first skin layer 5, the second skin layer 11, the core layer 7, and the first sub-skin layer 9 may include a thermoplastic polymer (or combination of thermoplastic polymers). The choice of the thermoplastic polymer or combination of thermoplastic polymers in each of the first skin layer 5, the second skin layer 11, the core layer 7, and the first sub-skin layer 9 is independent of the other layers. However, in some embodiments, the first skin layer 5 includes high density polyethylene. In other embodiments, the first skin layer 5 includes medium molecular weight high density polyethylene. In some embodiments, the core layer 7 also includes high density polyethylene, whereas in other embodiments, the core layer 7 includes an oxygen barrier polymer (e.g., ethylene vinyl alcohol, a polyamide, a polyester, or polyvinylidene chloride). In illustrative embodiments, the second skin layer 8 includes a heat-sealable polymer which, in illustrative embodiments, may include polyethylene or a copolymer thereof. In some embodiments, the first sub-skin layer 9 includes polyethylene and may function as a toughening layer to protect against tear and puncture of the polymeric film 3. In illustrative embodiments, the first sub-skin layer 9 includes linear low density polyethylene, high density polyethylene, or a combination thereof. In illustrative embodiments, the first sub-skin layer 9 includes metallocene linear low density polyethylene.

A third embodiment of a machine direction-oriented polymeric film 56 in accordance with the present disclosure is shown in FIG. 4. The machine direction-oriented polymeric film 56 has a five-layer structure and includes a first skin layer 58, a core layer 62, a second skin layer 60, a first sub-skin layer 64 interposed between the first skin layer 58 and the core layer 62, and a second sub-skin layer 66 interposed between the second skin layer 60 and the core layer 62. Each of the first skin layer 58, the second skin layer 60, the core layer 62, the first sub-skin layer 64, and the second sub-skin layer 66 may include a thermoplastic polymer (or combination of thermoplastic polymers). The choice of the thermoplastic polymer or combination of thermoplastic polymers in each of the first skin layer 58, the second skin layer 60, the core layer 62, the first sub-skin layer 64, and the second sub-skin layer 66 is independent of the other layers. However, in some embodiments, the first skin layer 58 includes high density polyethylene. In other embodiments, the first skin layer 58 includes medium molecular weight high density polyethylene. In some embodiments, the core layer 62 also includes high density polyethylene, whereas in other embodiments, the core layer 6 includes an oxygen barrier polymer. In illustrative embodiments, the second skin layer 8 includes a heat-sealable polymer which, in illustrative embodiments, may include polyethylene or a copolymer thereof. In some embodiments, each of the first sub-skin layer 64 and the second sub-skin layer 66 serves as a toughening layer and, in illustrative embodiments, includes linear low density polyethylene, high density polyethylene, or a combination thereof. In illustrative embodiments, each of the first sub-skin layer 64 and the second sub-skin layer 66 contains metallocene linear low density polyethylene, high density polyethylene, or a combination thereof. In other embodiments, one or both of the first sub-skin layer 64 and the second sub-skin layer 66 may serve as a tie layer as further described below.

Multi-layer films containing adjacent layers of dissimilar materials (e.g., polyethylene and EVOH) are prone to delamination and may exhibit poor physical properties as a result. To minimize or prevent this tendency, a tie layer containing a tie resin may be interposed between the adjacent layers of dissimilar materials. For example, to improve adhesion between a polyethylene-containing layer (e.g., the first skin layer 58 in FIG. 4) and an adjacent oxygen-barrier polymer-containing layer (e.g., an EVOH-containing core layer 62), an intervening tie layer containing an adhesive polymer or tie resin may be used. For example, in some embodiments, one or both of the first sub-skin layer 64 and the second sub-skin layer 66 contains a tie resin and may serve as a tie layer between the core layer 62 and an adjacent layer. In such embodiments, one or both of the first tie layer 64 and the second tie layer 66 independently includes a tie resin, which may be the same as one another or different, and which may be selected based on the specific oxygen barrier polymer contained in the core layer 62. Representative tie resins for use in accordance with the present disclosure include but are not limited to ethylene vinyl acetate (EVA), ethylene methyl acrylate (EMA), ethylene acrylic acid (EAA), ethylene methacrylic acid (EMAA), ethylene-grafted-maleic anhydride (AMP), and the like. In illustrative embodiments, the core layer 62 contains ethylene vinyl alcohol (EVOH), and one or both of the first tie layer 64 and the second tie layer 66 includes an anhydride-modified polyethylene. In addition to a tie resin, each of the first tie layer 64 and the second tie layer 66 may further include a thermoplastic polymer (e.g., a polyethylene) which, in illustrative embodiments, includes metallocene linear low density polyethylene (mLLDPE).

In some embodiments of the five-layered machine direction-oriented polymeric film 56 shown in FIG. 4, each of the first skin layer 58 and the second skin layer 60 independently includes from about 5% to about 45% by weight of the machine direction-oriented polymeric film, in other embodiments from about 10% to about 40%. In some embodiments of the five-layered machine direction-oriented polymeric film 56 shown in FIG. 4, each of the first sub-skin layer 64 and the second sub-skin layer 66 independently includes from about 3% to about 45% by weight of the machine direction-oriented polymeric film, in other embodiments from about 5% to about 25%. In some embodiments of the five-layered machine direction-oriented polymeric film 56 shown in FIG. 4, the core layer 62 includes from about 2% to about 80% by weight of the machine direction-oriented polymeric film, in other embodiments from about 10% to about 60%. In some embodiments of the five-layered machine direction-oriented polymeric film 56 shown in FIG. 4, the first skin layer 58, the first sub-skin layer 64, the core layer 62, the second sub-skin layer 66, and the second skin layer 60 are provided, respectively, in an amount of 15/8/20/8/40 by weight of the machine direction-oriented polymeric film. In other embodiments of the five-layered machine direction-oriented polymeric film 56 shown in FIG. 4, the first skin layer 58, the first sub-skin layer 64, the core layer 62, the second sub-skin layer 66, and the second skin layer 60 are provided, respectively, in an amount of 15/11/39/8/17 by weight of the machine direction-oriented polymeric film. In further embodiments of the five-layered machine direction-oriented polymeric film 56 shown in FIG. 4, the first skin layer 58, the first sub-skin layer 64, the core layer 62, the second sub-skin layer 66, and the second skin layer 60 are provided, respectively, in an amount of 15/8/52/8/17 by weight of the machine direction-oriented polymeric film. In some embodiments of the five-layered machine direction-oriented polymeric film 56 shown in FIG. 4, the first skin layer 58, the first sub-skin layer 64, the core layer 62, the second sub-skin layer 66, and the second skin layer 60 correspond, respectively, to an HDPE/mLLDPE/HDPE/mLLDPE/EVA film structure.

A fourth embodiment of a multi-layered, machine direction-oriented polymeric film 68 in accordance with the present disclosure is shown, for example, in FIG. 4. The machine direction-oriented polymeric film 68 has, at a minimum, a nine-layer structure that includes a first skin layer 70, a core layer 74, a second skin layer 72, a first sub-skin layer 76 interposed between the first skin layer 70 and the core layer 74, a second sub-skin layer 78 interposed between the second skin layer 72 and the core layer 74, a third sub-skin layer 84 interposed between the first sub-skin layer 76 and the first skin layer 70, a fourth sub-skin layer 86 interposed between the second sub-skin layer 78 and the second skin layer 72, a fifth sub-skin layer 80 interposed between the first sub-skin layer 76 and the third sub-skin layer 84, and a sixth sub-skin layer 82 interposed between the second sub-skin layer 78 and the fourth sub-skin layer 86. Each of the first skin layer 70, the second skin layer 72, the core layer 74, the first sub-skin layer 76, the second sub-skin layer 78, the third sub-skin layer 84, the fourth sub-skin layer 86, the fifth sub-skin layer 80, and the sixth sub-skin layer 82 may include a thermoplastic polymer (or combination of thermoplastic polymers). The choice of the thermoplastic polymer or combination of thermoplastic polymers in each of first skin layer 70, the second skin layer 72, the core layer 74, the first sub-skin layer 76, the second sub-skin layer 78, the third sub-skin layer 84, the fourth sub-skin layer 86, the fifth sub-skin layer 80, and the sixth sub-skin layer 82 is independent of the other layers. However, in some embodiments, the first skin layer 70 includes high density polyethylene. In other embodiments, the first skin layer 70 includes medium molecular weight high density polyethylene. In some embodiments, the core layer 74 also includes high density polyethylene, whereas in other embodiments, the core layer 74 includes an oxygen barrier polymer. In illustrative embodiments, the second skin layer 72 includes a heat-sealable polymer which, in illustrative embodiments, may include polyethylene or a copolymer thereof. In some embodiments, one or more of the first sub-skin layer 76, the second sub-skin layer 78, the third sub-skin layer 84, the fourth sub-skin layer 86, the fifth sub-skin layer 80, and the sixth sub-skin layer 82 serves as a toughening layer and, in illustrative embodiments, includes linear low density polyethylene, high density polyethylene, or a combination thereof. In illustrative embodiments, one or more of the first sub-skin layer 76, the second sub-skin layer 78, the third sub-skin layer 84, the fourth sub-skin layer 86, the fifth sub-skin layer 80, and the sixth sub-skin layer 82 includes metallocene linear low density polyethylene.

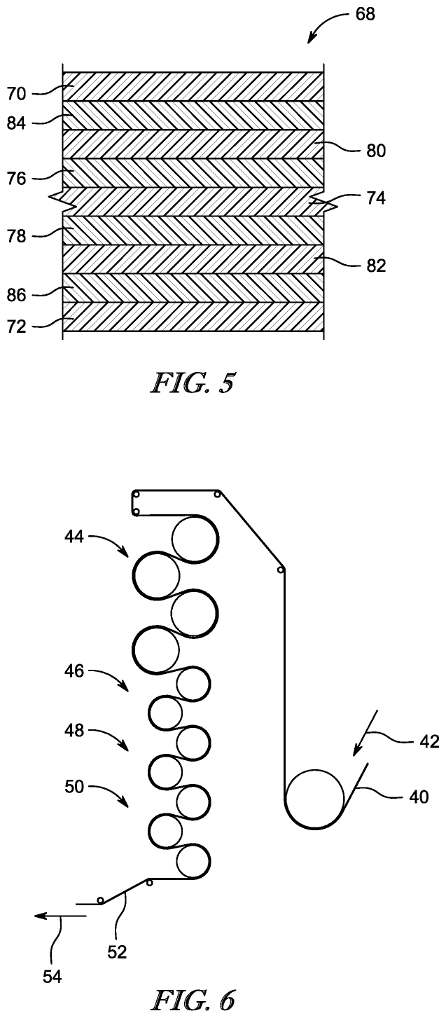

In some embodiments of the nine-layered machine direction-oriented polymeric film 68 shown in FIG. 5, the core layer 74 includes an oxygen barrier polymer such as EVOH, and each of the first sub-skin layer 76 and the second sub-skin layer 78 include a tie resin and serves as a tie layer. In some embodiments, each of the first skin layer 70 and the second skin layer 72 independently includes from about 5% to about 45% by weight of the machine direction-oriented polymeric film, in other embodiments from about 10% to about 40%. In some embodiments of the nine-layered machine direction-oriented polymeric film 68 shown in FIG. 5, each of the first tie layer 76 and the second tie layer 78 independently includes from about 3% to about 25% by weight of the machine direction-oriented polymeric film, in other embodiments from about 5% to about 25%. In some embodiments of the nine-layered machine direction-oriented polymeric film 68 shown in FIG. 5, the core layer 74 includes from about 2% to about 80% by weight of the machine direction-oriented polymeric film, in other embodiments from about 10% to about 60%. In some embodiments of the nine-layered machine direction-oriented polymeric film 68 shown in FIG. 5, each of the first sub-skin layer 76, the second sub-skin layer 78, the third sub-skin layer 84, the fourth sub-skin layer 86, the fifth sub-skin layer 80, and the sixth sub-skin layer 82 includes from about 3% to about 45% by weight of the machine direction-oriented polymeric film. In some embodiments of the nine-layered machine direction-oriented polymeric film 68 shown in FIG. 5, the first skin layer 70, the third sub-skin layer 84, the fifth sub-skin layer 80, the first tie layer 76, the core layer 74, the second tie layer 78, the sixth sub-skin layer 82, the fourth sub-skin layer 86, and the second skin layer 72 are provided, respectively, in an amount of 15/13/12/7/3.5/7/14/13.5/15 by weight of the machine direction-oriented polymeric film. In other embodiments of the nine-layered machine direction-oriented polymeric film 68 shown in FIG. 5, the first skin layer 70, the third sub-skin layer 84, the fifth sub-skin layer 80, the first tie layer 76, the core layer 74, the second tie layer 78, the sixth sub-skin layer 82, the fourth sub-skin layer 86, and the second skin layer 72 are provided, respectively, in an amount of 15/12/12/9/3.5/9/12/12.5/15 by weight of the machine direction-oriented polymeric film. In further embodiments of the nine-layered machine direction-oriented polymeric film 68 shown in FIG. 5, the first skin layer 70, the third sub-skin layer 84, the fifth sub-skin layer 80, the first tie layer 76, the core layer 74, the second tie layer 78, the sixth sub-skin layer 82, the fourth sub-skin layer 86, and the second skin layer 72 are provided, respectively, in an amount of 15/11/10/6/5/7/15/16/15 by weight of the machine direction-oriented polymeric film. In further embodiments of the nine-layered machine direction-oriented polymeric film 68 shown in FIG. 5, the first skin layer 70, the third sub-skin layer 84, the fifth sub-skin layer 80, the first tie layer 76, the core layer 74, the second tie layer 78, the sixth sub-skin layer 82, the fourth sub-skin layer 86, and the second skin layer 72 are provided, respectively, in an amount of 15/13/12/7/3.5/7/14/13.5/15 by weight of the machine direction-oriented polymeric film. In further embodiments of the nine-layered machine direction-oriented polymeric film 68 shown in FIG. 5, the first skin layer 70, the third sub-skin layer 84, the fifth sub-skin layer 80, the first tie layer 76, the core layer 74, the second tie layer 78, the sixth sub-skin layer 82, the fourth sub-skin layer 86, and the second skin layer 72 are provided, respectively, in an amount of 15/11/10/9/9/9/12/8/17 by weight of the machine direction-oriented polymeric film. In further embodiments of the nine-layered machine direction-oriented polymeric film 68 shown in FIG. 5, the first skin layer 70, the third sub-skin layer 84, the fifth sub-skin layer 80, the first tie layer 76, the core layer 74, the second tie layer 78, the sixth sub-skin layer 82, the fourth sub-skin layer 86, and the second skin layer 72 are provided, respectively, in an amount of 15/8/12.5/9/9/9/12.5/8/17 by weight of the machine direction-oriented polymeric film. In further embodiments of the nine-layered machine direction-oriented polymeric film 68 shown in FIG. 5, the first skin layer 70, the third sub-skin layer 84, the fifth sub-skin layer 80, the first tie layer 76, the core layer 74, the second tie layer 78, the sixth sub-skin layer 82, the fourth sub-skin layer 86, and the second skin layer 72 are provided, respectively, in an amount of 17.5/12.5/12/6.5/3.5/6.5/12/13.5/16 by weight of the machine direction-oriented polymeric film. In some embodiments of the nine-layered machine direction-oriented polymeric film 68 shown in FIG. 5, the first skin layer 70, the third sub-skin layer 84, the fifth sub-skin layer 80, the first tie layer 76, the core layer 74, the second tie layer 78, the sixth sub-skin layer 82, the fourth sub-skin layer 86, and the second skin layer 72 correspond, respectively, to an HDPE/HDPE/HDPE/tie/EVOH/tie/HDPE/HDPE/EVA film structure.

In illustrative embodiments, a polyethylene-containing polymeric film in accordance with the present disclosure may be advantageously used in recyclable packaging. However, when two or more polymers (e.g., polyethylene and EVOH) are blended together, either as recycle streams or in other blends and alloys, the polymers may not be compatible with one another, thereby resulting in blends with inadequate properties and characteristics to make them suitable for recycling. To address this problem, functional additives known as compatibilizers may be used to improve the compatibility of the different polymeric materials. While neither desiring to be bound by any particular theory nor intending to limit in any measure the scope of the appended claims or their equivalents, it is presently believed that the use of a compatibilizing resin acts to reduce interfacial energy between two different polymers in order to increase adhesion and/or to enhance the dispersion of the polar polymers into the polyolefin matrix, such that the haze of the resulting structure is minimized. The use of a compatibilizing resin may result in a finer dispersion as well as more regular and stable morphologies.

In order to render a polymeric film that contains an oxygen barrier film (e.g., EVOH) in accordance with the present disclosure recyclable, a compatibilizing resin may be used to facilitate the secondary processing and breakdown of the oxygen barrier polymer. Thus, in some embodiments, the machine direction-oriented polymeric film 2 shown in FIG. 1, the machine direction-oriented polymeric film 3 shown in FIG. 3, the machine direction-oriented polymeric film 56 shown in FIG. 4, and the machine direction-oriented polymeric film 68 shown in FIG. 5 may further include one or more compatibilizing layers in their respective structures. Each compatibilizing layer includes a compatibilizing resin, which may be the same as or different than a compatibilizing resin used in another compatibilizing layer within the film structure, and which may be selected based on the specific oxygen barrier polymer contained in the respective core layer. Representative compatibilizing resins for use in accordance with the present disclosure include but are not limited to maleic anhydride-grafted polyethylene. In illustrative embodiments, the compatibilizing resin for use in accordance with the present disclosure includes the maleic anhydride-grafted polymeric material sold under the tradename RETAIN 3000 by The Dow Chemical Company (Midlands, Mich.). In addition to a compatibilizing resin, the compatibilizing layers may further include a thermoplastic polymer (e.g., a polyethylene) which, in illustrative embodiments, may include metallocene linear low density polyethylene (mLLDPE), a high density polyethylene, or a combination thereof.

In accordance with the present disclosure, the thermoplastic polymer (or combination of thermoplastic polymers) used to make the first skin layer 4, the second skin layer 8, and the core layer 6 of the machine direction-oriented polymeric film 2 shown in FIG. 1, the thermoplastic polymer (or combination of thermoplastic polymers) used to make the first skin layer 5, the second skin layer 11, the first sub-skin layer 9, and the core layer 7 of the machine-direction oriented polymeric film 3 shown in FIG. 3, the thermoplastic polymer (or combination of thermoplastic polymers) used to make the first skin layer 58, the second skin layer 60, the core layer 62, the first sub-skin layer 64, and the second sub-skin layer 66 of the machine direction-oriented polymeric film 56 shown in FIG. 4, and the thermoplastic polymer (or combination of thermoplastic polymers) used to make the first skin layer 70, the second skin layer 72, the first sub-skin layer 76, the second sub-skin layer 78, the third sub-skin layer 84, the fourth sub-skin layer 86, the fifth sub-skin layer 80, the sixth sub-skin layer 82, and the core layer 74 of the machine direction-oriented polymeric film 68 shown in FIG. 5 is not restricted, and may include all manner of thermoplastic polymers. In illustrative embodiments, the thermoplastic polymer is a polyolefin, including but not limited to homopolymers, copolymers, terpolymers, and/or blends thereof.

Representative polyolefins that may be used in accordance with the present disclosure include but are not limited to low density polyethylene (LDPE), high density polyethylene (HDPE), medium molecular weight high density polyethylene (MMW-HDPE), high molecular weight high density polyethylene (HMW-HDPE), medium density polyethylene (MDPE), linear low density polyethylene (LLDPE), metallocene linear low density polyethylene (mLLDPE), metallocene polyethylene (mPE), very low density polyethylene (VLDPE), ultra-low density polyethylene (ULDPE), polypropylene, ethylene-propylene copolymers, polymers made using a single-site catalyst, ethylene maleic anhydride copolymers (EMAs), ethylene vinyl acetate copolymers (EVAs), polymers made using Zeigler-Natta catalysts, styrene-containing block copolymers, and/or the like, and combinations thereof. Methods for manufacturing LDPE are described in The Wiley Encyclopedia of Packaging Technology, pp. 753-754 (Aaron L. Brody et al. eds., 2nd Ed. 1997) and in U.S. Pat. No. 5,399,426, both of which are incorporated by reference herein, except that in the event of any inconsistent disclosure or definition from the present specification, the disclosure or definition herein shall be deemed to prevail. Medium molecular weight high density polyethylene (MMW-HDPE) for use in accordance with the present disclosure has a number average molecular weight and a weight average molecular weight from about 5,000 to about 1,000,000 grams/mole (in some embodiments from about 15,000 to about 500,000 grams per mole, in other embodiments from about 15,000 to about 400,000 grams per mole, and, in further embodiments, from about 15,000 to about 300,000 grams per mole). High molecular weight high density polyethylene (HMW-HDPE) for use in accordance with the present disclosure has a number average molecular weight and a weight average molecular weight above about 1,000,000 grams/mole. ULDPE may be produced by a variety of processes, including but not limited to gas phase, solution and slurry polymerization as described in The Wiley Encyclopedia of Packaging Technology, pp. 748-50 (Aaron L. Brody et al. eds., 2nd Ed. 1997), incorporated by reference above, except that in the event of any inconsistent disclosure or definition from the present specification, the disclosure or definition herein shall be deemed to prevail. ULDPE may be manufactured using a Ziegler-Natta catalyst, although a number of other catalysts may also be used. For example, ULDPE may be manufactured with a metallocene catalyst. Alternatively, ULDPE may be manufactured with a catalyst that is a hybrid of a metallocene catalyst and a Ziegler-Natta catalyst. Methods for manufacturing ULDPE are also described in U.S. Pat. Nos. 5,399,426, 4,668,752, 3,058,963, 2,905,645, 2,862,917, and 2,699,457, each of which is incorporated by reference herein in its entirety, except that in the event of any inconsistent disclosure or definition from the present specification, the disclosure or definition herein shall be deemed to prevail. The density of ULDPE is achieved by copolymerizing ethylene with a sufficient amount of one or more monomers. In illustrative embodiments, the monomers are selected from 1-butene, 1-hexene, 4-methyl-1-pentene, 1-octene, and combinations thereof. Methods for manufacturing polypropylene are described in Kirk-Othmer Concise Encyclopedia of Chemical Technology, pp. 1420-1421 (Jacqueline I. Kroschwitz et al. eds., 4th Ed. 1999), which is incorporated herein by reference, except that in the event of any inconsistent disclosure or definition from the present specification, the disclosure or definition herein shall be deemed to prevail.

In illustrative embodiments, a polyolefin for use in accordance with the present disclosure includes polyethylene. In one example, the polyethylene includes a linear low density polyethylene, medium density polyethylene, high density polyethylene, ethylene vinyl acetate, polybutene, ethylene-based hexene plastomer, or a combination thereof. In another example, the polyethylene includes metallocene linear low density polyethylene.

In addition to containing one or more thermoplastic polymers, one or more of the first skin layer 4, the second skin layer 8, and the core layer 6 of the machine direction-oriented polymeric film 2 shown in FIG. 1, one or more of the first skin layer 5, the second skin layer 11, the first sub-skin layer 9, and the core layer 7 of the machine-direction oriented polymeric film 3 shown in FIG. 3, one or more of the first skin layer 58, the second skin layer 60, the core layer 62, the first sub-skin layer 64, and the second sub-skin layer 66 of the machine direction-oriented polymeric film 56 shown in FIG. 4, and one or more of the first skin layer 70, the second skin layer 72, the first sub-skin layer 76, the second sub-skin layer 78, the third sub-skin layer 84, the fourth sub-skin layer 86, the fifth sub-skin layer 80, the sixth sub-skin layer 82, and the core layer 74 of the machine direction-oriented polymeric film 68 shown in FIG. 5 may optionally contain one or more additional components to improve the film properties or processing of the machine direction-oriented polymeric films or the unstretched substrate films that are precursors to the machine direction-oriented polymeric films. Representative optional components include but are not limited to anti-oxidants (e.g., added to reduce the tendency of the film to discolor over time) and processing aids (e.g., added to facilitate extrusion of the precursor film). In one example, the amount of one or more anti-oxidants in the precursor film is less than about 1% by weight of the film, and the amount of one or more processing aids is less than about 5% by weight of the film. Additional optional additives include but are not limited to antistatic agents, UV agents (e.g., UV blockers, UV stabilizers, UV absorbers, and/or the like), antiblocking agents (e.g., diatomaceous earth) and slip agents (e.g. erucamide), which may be added to allow film rolls to unwind properly and to facilitate secondary processing. In one example, the amount of one or more antiblocking agents and/or one or more slip agents is less than about 5% by weight of the film. Further additional optional additives include but are not limited to scents, deodorizers, pigments, noise reducing agents, and/or the like, and combinations thereof. In one example, the amount of one or more scents, deodorizers, pigments other than white, and/or noise reducing agents is less than about 10% by weight of the film.

In illustrative embodiments, a process for making a machine direction-oriented polymeric film in accordance with the present disclosure (e.g., films 2, 3, 56, and 68) includes (a) preheating a precursor film of a type described herein (e.g., an un-stretched multi-layer film) at or below a melt temperature of a polymer contained in the precursor film to form a preheated precursor film, (b) stretching the preheated precursor film in a machine direction at a draw ratio of greater than or equal to about 5:1 at a temperature at or below the melt temperature of the polymer to form a machine direction-oriented stretched film, (c) annealing the machine direction-oriented stretched film to form the machine direction-oriented polymeric film, and (d) cooling the machine direction-oriented polymeric film after the annealing.

An exemplary process for making a machine direction-oriented polymeric film in accordance with the present disclosure (e.g., films 2, 3, 56, and 68) is shown in FIG. 6 in simplified form. For example, a precursor film 40 prepared via an extrusion process (not shown) traveling in a direction 42 enters a preheat section 44 prior to being stretched. In some embodiments, the preheating may be achieved by running the film over 2-3 heated rolls. The purpose of the preheating step is to uniformly raise the temperature of the film 40 to orientation temperature. In illustrative embodiments, the roll and film temperature for HDPE-based films is between about 170° F. and about 260° F. (in other embodiments about 200° F. and about 260° F.). As a general rule of thumb, the precursor film may be preheated to a temperature that is about 10 to about 20 degrees below the melt temperature of the polymer, thereby facilitating stretching at higher draw ratios and preventing sticking to the rolls.

The preheated precursor film exits preheat section 44 and enters draw section 46, as shown in FIG. 6. In the draw section 46, the preheated precursor film is stretched in a machine direction at a draw ratio of greater than or equal to about 3:1 at a temperature at or below the melt temperature of the polymer to form a machine direction-oriented stretched film. In illustrative embodiments, the draw ratio is greater than or equal to about 4:1, in some embodiments greater than or equal to about 5:1, in some embodiments greater than or equal to about 6:1, in some embodiments greater than or equal to about 7:1, in some embodiments greater than or equal to about 8:1, in some embodiments greater than or equal to about 9:1, and in some embodiments greater than or equal to about 10:1.

The preheated precursor film is stretched across a pair of heated draw rolls in an S-wrap configuration to the desired draw ratio and final film thickness. In illustrative embodiments, the heated roll and film temperature are similar to that of the preheat rolls in the preheat section 44. For example, in illustrative embodiments, the roll and film temperature is about 10 to about 20 degrees below the melt temperature of an HDPE-containing skin layer. In some embodiments, the preheated precursor film is drawn up to 10:1 or even higher depending on the application. In some embodiments, the preheated precursor film is stretched in a draw ratio ranging from about 3:1 to about 10:1. In illustrative embodiments, the preheated precursor film is stretched in a draw ratio ranging from about 4:1 to about 8:1, and, in further illustrative embodiments, in a draw ratio of at least about 6:1. By way of example, for a draw ratio of 6:1, a preheated precursor film having an initial thickness of 5.75 mils would be stretched to provide a machine direction-oriented stretched film having a thickness of 0.96 mils. In the draw section 46, the gap between the two draw rolls should be as narrow as possible to prevent excessive neck-in from stretching the film. In illustrative embodiments, the draw roll temperatures in draw section may range from about 170° F. to about 260° F. for HDPE-based preheated precursor films.

The machine direction-oriented stretched film exits the draw section 46 and enters the anneal section 48 as shown in FIG. 6. In the anneal section 48, the machine direction-oriented stretched film is heat-treated in order to lock-in the final properties of the film. The first annealing roll after the draw section 46 is typically run at a reduced speed to allow for some relaxation, which helps to minimize curl and shrinkage when the film is later exposed to heat in downstream converting steps. The annealing rolls are typically set to the same temperature as the draw rolls. In illustrative embodiments, the roll temperatures in the anneal section 48 are in the range of about 125° F. to about 260° F. (in some embodiments, about 160° F. to about 260° F.). In some embodiments, multiple larger outer diameter rolls may be provided in the anneal section 48 in order to increase the film-to-roll contact time, which improves annealing efficacy.

The machine direction-oriented polymeric film exits the anneal section 48 and enters the cool section 50 as shown in FIG. 6. In the cool section 50, the machine direction-oriented polymeric film is cooled to ambient temperature for rewinding into rollstock. Since the film is shrinking during this stage, cooling is achieved in a step-down process over 3 to 4 rolls in order to minimize the chance for forming wrinkles or surface defects. In illustrative embodiments, the roll temperature in the cool section 50 ranges from about 250° F. down to about 140° F.

In illustrative embodiments, a process for making a machine direction-oriented polymeric film 2 in accordance with the present disclosure further includes (e) co-extruding at least a first composition, a second composition, and a third composition to form the precursor film. In some embodiments, the co-extruding is achieved via a blown film process, and in other embodiments via a cast film process. In some embodiments, the co-extruding, the preheating, the stretching, and the annealing are achieved sequentially in an in-line process. In other embodiments, the co-extruding is performed in one process, and the preheating, the stretching, and the annealing are performed in a separate process. In illustrative embodiments, a process for making a machine direction-oriented polymeric film 2 in accordance with the present disclosure further includes (f) treating the machine direction-oriented polymeric film (e.g., to enhance a print surface and/or lamination surface thereof). Representative types of treatments include but are not limited to corona, flame, and plasma treatments.

In illustrative embodiments, a machine direction-oriented polymeric film prepared in accordance with the present disclosure (e.g., films 2, 3, 56, and 68) may have reduced strain at break in a machine direction (i.e., elongation), increased 1% secant modulus in a machine direction (i.e., stiffness), reduced haze, increased gloss, increased stress at break in the machine direction, reduced MVTR, reduced heat seal initiation, reduced thickness, or a combination of one or more of these physical properties, as compared to conventional polymeric films.

In illustrative embodiments, a machine direction-oriented polymeric film in accordance with the present disclosure exhibits a reduced strain at break in the machine direction (i.e., elongation) than conventional polymeric films of similar thickness. In one example, a machine direction-oriented polymeric film in accordance with the present disclosure has a strain at break in the machine direction of less than about 100%. In another example, a machine direction-oriented polymeric film in accordance with the present disclosure has a strain at break in the machine direction of less than about 50%. In a further example, a machine direction-oriented polymeric film in accordance with the present disclosure has a strain at break in the machine direction of less than about 30%. In a further example, a machine direction-oriented polymeric film in accordance with the present disclosure has a strain at break in the machine direction of less than about 25%. In a further example, a machine direction-oriented polymeric film in accordance with the present disclosure has a strain at break in the machine direction of less than about 20%.

The strain at break in machine direction of a machine direction-oriented polymeric film in accordance with the present disclosure may be one of several different values or fall within one of several different ranges. For example, for a machine direction-oriented polymeric film having a thickness of less than about 2.0 mil—in some embodiments, less than about 1.9 mil, 1.8 mil, 1.7 mil, 1.6 mil, 1.5 mil, 1.4 mil, 1.3 mil, 1.2 mil, 1.1 mil, 1.0 mil, 0.9 mil, 0.8 mil, 0.7 mil, 0.6 mil, 0.5 mil, or 0.4 mil—it is within the scope of the present disclosure to select a strain at break in the machine direction to be less than or equal to one of the following values: about 100%, 99%, 98%, 97%, 96%, 95%, 94%, 93%, 92%, 91%, 90%, 89%, 88%, 87%, 86%, 85%, 84%, 83%, 82%, 81%, 80%, 79%, 78%, 77%, 76%, 75%, 74%, 73%, 72%, 71%, 70%, 69%, 68%, 67%, 66%, 65%, 64%, 63%, 62%, 61%, 60%, 59%, 58%, 57%, 56%, 55%, 54%, 53%, 52%, 51%, 50%, 49%, 48%, 47%, 46%, 45%, 44%, 43%, 42%, 41%, 40%, 39%, 38%, 37%, 36%, 35%, 34%, 33%, 32%, 31%, 30%, 29%, 28%, 27%, 26%, 25%, 24%, 23%, 22%, 21%, 20%, 19%, 18%, 17%, 16%, or 15%.

It is also within the scope of the present disclosure for the strain at break in the machine direction of the machine direction-oriented polymeric film to fall within one of many different ranges. In a first set of ranges, the strain at break in the machine direction for a machine direction-oriented polymeric film having a thickness of less than about 2.0 mil—in some embodiments, less than about 1.9 mil, 1.8 mil, 1.7 mil, 1.6 mil, 1.5 mil, 1.4 mil, 1.3 mil, 1.2 mil, 1.1 mil, 1.0 mil, 0.9 mil, 0.8 mil, 0.7 mil, 0.6 mil, 0.5 mil, or 0.4 mil—is in one of the following ranges: about 10% to 100%, 11% to 99%, 12% to 98%, 13% to 97%, 14% to 96%, 15% to 95%, 16% to 94%, 17% to 93%, 18% to 92%, 17% to 91%, 18% to 90%, 19% to 89%, 20% to 88%, 21% to 87%, 22% to 86%, 23% to 85%, 24% to 84%, 25% to 83%, 26% to 82%, 27% to 81%, 28% to 80%, 29% to 79%, 30% to 78%, 31% to 77%, 32% to 76%, 33% to 75%, 34% to 74%, 35% to 73%, 36% to 72%, 37% to 71%, 38% to 70%, 39% to 69%, 40% to 68%, 41% to 67%, 42% to 66%, 43% to 65%, 44% to 64%, 45% to 63%, 46% to 62%, 47% to 61%, 48% to 60%, 49% to 59%, 50% to 58%, 51% to 57%, 52% to 56%, or 53% to 55. In a second set of ranges, the strain at break in the machine direction for a machine direction-oriented polymeric film having a thickness of less than about 2.0 mil—in some embodiments, less than about 1.9 mil, 1.8 mil, 1.7 mil, 1.6 mil, 1.5 mil, 1.4 mil, 1.3 mil, 1.2 mil, 1.1 mil, 1.0 mil, 0.9 mil, 0.8 mil, 0.7 mil, 0.6 mil, 0.5 mil, or 0.4 mil—is in one of the following ranges: about 11% to 100%, 12% to 100%, 13% to 100%, 14% to 100%, 15% to 100%, 16% to 100%, 17% to 100%, 18% to 100%, 19% to 100%, 20% to 100%, 21% to 100%, 22% to 100%, 23% to 100%, 24% to 100%, 25% to 100%, 26% to 100%, 27% to 100%, 28% to 100%, 29% to 100%, 30% to 100%, 31% to 100%, 32% to 100%, 33% to 100%, 34% to 100%, 35% to 100%, 36% to 100%, 37% to 100%, 38% to 100%, 39% to 100%, 40% to 100%, 41% to 100%, 42% to 100%, 43% to 100%, 44% to 100%, 45% to 100%, 46% to 100%, 47% to 100%, 48% to 100%, 49% to 100%, 50% to 100%, 51% to 100%, 52% to 100%, 53% to 100%, 54% to 100%, 55% to 100%, 56% to 100%, 57% to 100%, 58% to 100%, 59% to 100%,60% to 100%, 61% to 100%, 62% to 100%, 63% to 100%, 64% to 100%, 65% to 100%, 66% to 100%, 67% to 100%, 68% to 100%, 69% to 100%, 70% to 100%, 71% to 100%, 72% to 100%, 73% to 100%, 74% to 100%, 75% to 100%, 76% to 100%, 77% to 100%, 78% to 100%, 79% to 100%, 80% to 100%, 81% to 100%, 82% to 100%, 83% to 100%, 84% to 100%, 85% to 100%, 86% to 100%, 87% to 100%, 88% to 100%, 89% to 100%, 90% to 100%, 91% to 100%, 92% to 100%, 93% to 100%, 94% to 100%, 95% to 100%, 96% to 100%, 97% to 100%, 98% to 100%, or 99% to 100%. In a third set of ranges, the strain at break in the machine direction for a machine direction-oriented polymeric film having a thickness of less than about 2.0 mil—in some embodiments, less than about 1.9 mil, 1.8 mil, 1.7 mil, 1.6 mil, 1.5 mil, 1.4 mil, 1.3 mil, 1.2 mil, 1.1 mil, 1.0 mil, 0.9 mil, 0.8 mil, 0.7 mil, 0.6 mil, 0.5 mil, or 0.4 mil—is in one of the following ranges: about 10% to 99%, 10% to 98%, 10% to 97%, 10% to 96%, 10% to 95%, 10% to 94%, 10% to 93%, 10% to 92%, 10% to 91%, 10% to 90%, 10% to 89%, 10% to 88%, 10% to 87%, 10% to 86%, 10% to 85%, 10% to 84%, 10% to 83%, 10% to 82%, 10% to 81%, 10% to 80%, 10% to 79%, 10% to 78%, 10% to 77%, 10% to 76%, 10% to 75%, 10% to 74%, 10% to 73%, 10% to 72%, 10% to 71%, 10% to 70%, 10% to 69%, 10% to 68%, 10% to 67%, 10% to 66%, 10% to 65%, 10% to 64%, 10% to 63%, 10% to 62%, 10% to 61%, 10% to 60%, 10% to 59%, 10% to 58%, 10% to 57%, 10% to 56%, 10% to 55%, 10% to 54%, 10% to 53%, 10% to 52%, 10% to 51%, 10% to 50%, 10% to 49%, 10% to 48%, 10% to 47%, 10% to 46%, 10% to 45%, 10% to 44%, 10% to 43%, 10% to 42%, 10% to 41%, 10% to 40%, 10% to 39%, 10% to 38%, 10% to 37%, 10% to 36%, 10% to 35%, 10% to 34%, 10% to 33%, 10% to 32%, 10% to 31%, 10% to 30%, 10% to 29%, 10% to 28%, 10% to 27%, 10% to 26%, 10% to 25%, 10% to 24%, 10% to 23%, 10% to 22%, 10% to 21%, 10% to 20%, 10% to 19%, 10% to 18%, 10% to 17%, 10% to 16%, 10% to 15%, 10% to 14%, 10% to 13%, 10% to 12%, or 10% to 11%.

The 1% secant modulus in the machine direction of a machine direction-oriented polymeric film in accordance with the present disclosure may be one of several different values or fall within one of several different ranges. For example, for a machine direction-oriented polymeric film having a thickness of less than about 2.0 mil—in some embodiments, less than about 1.9 mil, 1.8 mil, 1.7 mil, 1.6 mil, 1.5 mil, 1.4 mil, 1.3 mil, 1.2 mil, 1.1 mil, 1.0 mil, 0.9 mil, 0.8 mil, 0.7 mil, 0.6 mil, 0.5 mil, or 0.4 mil—it is within the scope of the present disclosure to select a 1% secant modulus in the machine direction to be greater than or equal to one of the following values: about 150,000 psi; 151,000 psi; 152,000 psi; 153,000 psi; 154,000 psi; 155,000 psi; 156,000 psi; 157,000 psi; 158,000 psi; 159,000 psi; 160,000 psi; 161,000 psi; 162,000 psi; 163,000 psi; 164,000 psi; 165,000 psi; 166,000 psi; 167,000 psi; 168,000 psi; 169,000 psi; 170,000 psi; 171,000 psi; 172,000 psi; 173,000 psi; 174,000 psi; 175,000 psi; 176,000 psi; 177,000 psi; 178,000 psi; 179,000 psi; 180,000 psi; 181,000 psi; 182,000 psi; 183,000 psi; 184,000 psi; 185,000 psi; 186,000 psi; 187,000 psi; 188,000 psi; 189,000 psi; 190,000 psi; 191,000 psi; 192,000 psi; 193,000 psi; 194,000 psi; 195,000 psi; 196,000 psi; 197,000 psi; 198,000 psi; 199,000 psi; 200,000 psi; 201,000 psi; 202,000 psi; 203,000 psi; 204,000 psi; 205,000 psi; 206,000 psi; 207,000 psi; 208,000 psi; 209,000 psi; 210,000 psi; 211,000 psi; 212,000 psi; 213,000 psi; 214,000 psi; 215,000 psi; 216,000 psi; 217,000 psi; 218,000 psi; 219,000 psi; 220,000 psi; 221,000 psi; 222,000 psi; 223,000 psi; 224,000 psi; 225,000 psi; 226,000 psi; 227,000 psi; 228,000 psi; 229,000 psi; 230,000 psi; 231,000 psi; 232,000 psi; 233,000 psi; 234,000 psi; 235,000 psi; 236,000 psi; 237,000 psi; 238,000 psi; 239,000 psi; 240,000 psi; 241,000 psi; 242,000 psi; 243,000 psi; 244,000 psi; 245,000 psi; 246,000 psi; 247,000 psi; 248,000 psi; 249,000 psi; 250,000 psi; 251,000 psi; 252,000 psi; 253,000 psi; 254,000 psi; 255,000 psi; 256,000 psi; 257,000 psi; 258,000 psi; 259,000 psi; 260,000 psi; 261,000 psi; 262,000 psi; 263,000 psi; 264,000 psi; 265,000 psi; 266,000 psi; 267,000 psi; 268,000 psi; 269,000 psi; 270,000 psi; 271,000 psi; 272,000 psi; 273,000 psi; 274,000 psi; 275,000 psi; 276,000 psi; 277,000 psi; 278,000 psi; 279,000 psi; 280,000 psi; 281,000 psi; 282,000 psi; 283,000 psi; 284,000 psi; 285,000 psi; 286,000 psi; 287,000 psi; 288,000 psi; 289,000 psi; 290,000 psi; 291,000 psi; 292,000 psi; 293,000 psi; 294,000 psi; 295,000 psi; 296,000 psi; 297,000 psi; 298,000 psi; 299,000 psi; 300,000 psi; 301,000 psi; 302,000 psi; 303,000 psi; 304,000 psi; 305,000 psi; 306,000 psi; 307,000 psi; 308,000 psi; 309,000 psi; 310,000 psi; 311,000 psi; 312,000 psi; 313,000 psi; 314,000 psi; 315,000 psi; 316,000 psi; 317,000 psi; 318,000 psi; 319,000 psi; 320,000 psi; 321,000 psi; 322,000 psi; 323,000 psi; 324,000 psi; 325,000 psi; 326,000 psi; 327,000 psi; 328,000 psi; 329,000 psi; 330,000 psi; 331,000 psi; 332,000 psi; 333,000 psi; 334,000 psi; 335,000 psi; 336,000 psi; 337,000 psi; 338,000 psi; 339,000 psi; 340,000 psi; 341,000 psi; 342,000 psi; 343,000 psi; 344,000 psi; 345,000 psi; 346,000 psi; 347,000 psi; 348,000 psi; 349,000 psi; 350,000 psi; 351,000 psi; 352,000 psi; 353,000 psi; 354,000 psi; 355,000 psi; 356,000 psi; 357,000 psi; 358,000 psi; 359,000 psi; 360,000 psi; 361,000 psi; 362,000 psi; 363,000 psi; 364,000 psi; 365,000 psi; 366,000 psi; 367,000 psi; 368,000 psi; 369,000 psi; 370,000 psi; 371,000 psi; 372,000 psi; 373,000 psi; 374,000 psi; 375,000 psi; 376,000 psi; 377,000 psi; 378,000 psi; 379,000 psi; 380,000 psi; 381,000 psi; 382,000 psi; 383,000 psi; 384,000 psi; 385,000 psi; 386,000 psi; 387,000 psi; 388,000 psi; 389,000 psi; 390,000 psi; 391,000 psi; 392,000 psi; 393,000 psi; 394,000 psi; 395,000 psi; 396,000 psi; 397,000 psi; 398,000 psi; 399,000 psi; 400,000 psi; 401,000 psi; 402,000 psi; 403,000 psi; 404,000 psi; 405,000 psi; 406,000 psi; 407,000 psi; 408,000 psi; 409,000 psi; 410,000 psi; 411,000 psi; 412,000 psi; 413,000 psi; 414,000 psi; 415,000 psi; 416,000 psi; 417,000 psi; 418,000 psi; 419,000 psi; 420,000 psi; 421,000 psi; 422,000 psi; 423,000 psi; 424,000 psi; 425,000 psi; 426,000 psi; 427,000 psi; 428,000 psi; 429,000 psi; 430,000 psi; 431,000 psi; 432,000 psi; 433,000 psi; 434,000 psi; 435,000 psi; 436,000 psi; 437,000 psi; 438,000 psi; 439,000 psi; 440,000 psi; 441,000 psi; 442,000 psi; 443,000 psi; 444,000 psi; 445,000 psi; 446,000 psi; 447,000 psi; 448,000 psi; 449,000 psi; 450,000 psi; 451,000 psi; 452,000 psi; 453,000 psi; 454,000 psi; 455,000 psi; 456,000 psi; 457,000 psi; 458,000 psi; 459,000 psi; 460,000 psi; 461,000 psi; 462,000 psi; 463,000 psi; 464,000 psi; 465,000 psi; 466,000 psi; 467,000 psi; 468,000 psi; 469,000 psi; 470,000 psi; 471,000 psi; 472,000 psi; 473,000 psi; 474,000 psi; 475,000 psi; 476,000 psi; 477,000 psi; 478,000 psi; 479,000 psi; 480,000 psi; 481,000 psi; 482,000 psi; 483,000 psi; 484,000 psi; 485,000 psi; 486,000 psi; 487,000 psi; 488,000 psi; 489,000 psi; 490,000 psi; 491,000 psi; 492,000 psi; 493,000 psi; 494,000 psi; 495,000 psi; 496,000 psi; 497,000 psi; 498,000 psi; 499,000 psi; or 500,000 psi.

It is also within the scope of the present disclosure for the 1% secant modulus in machine direction of the machine direction-oriented polymeric film to fall within one of many different ranges. In a first set of ranges, the 1% secant modulus in machine direction for a machine direction-oriented polymeric film having a thickness of less than about 2.0 mil—in some embodiments, less than about 1.9 mil, 1.8 mil, 1.7 mil, 1.6 mil, 1.5 mil, 1.4 mil, 1.3 mil, 1.2 mil, 1.1 mil, 1.0 mil, 0.9 mil, 0.8 mil, 0.7 mil, 0.6 mil, 0.5 mil, or 0.4 mil—is in one of the following ranges: about 150,000 psi to 500,000 psi; 155,000 psi to 495,000 psi; 160,000 psi to 490,000 psi; 165,000 psi to 485,000 psi; 170,000 psi to 480,000 psi; 175,000 psi to 475,000 psi; 180,000 psi to 470,000 psi; 185,000 psi to 465,000 psi; 190,000 psi to 460,000 psi; 195,000 psi to 455,000 psi; 200,000 psi to 450,000 psi; 205,000 psi to 445,000 psi; 210,000 psi to 440,000 psi; 215,000 psi to 435,000 psi; 220,000 psi to 430,000 psi; 225,000 psi to 425,000 psi; 230,000 psi to 420,000 psi; 235,000 psi to 415,000 psi; 240,000 psi to 410,000 psi; 245,000 psi to 405,000 psi; 250,000 psi to 400,000 psi; 255,000 psi to 395,000 psi; 260,000 psi to 390,000 psi; 265,000 psi to 385,000 psi; 270,000 psi to 380,000 psi; 275,000 psi to 375,000 psi; 280,000 psi to 370,000 psi; 285,000 psi to 365,000 psi; 290,000 psi to 360,000 psi; 295,000 psi to 355,000 psi; 300,000 psi to 350,000 psi; 305,000 psi to 345,000 psi; 310,000 psi to 340,000 psi; 315,000 psi to 335,000 psi; or 320,000 psi to 330,000 psi. In a second set of ranges, the 1% secant modulus in machine direction for a machine direction-oriented polymeric film having a thickness of less than about 2.0 mil—in some embodiments, less than about 1.9 mil, 1.8 mil, 1.7 mil, 1.6 mil, 1.5 mil, 1.4 mil, 1.3 mil, 1.2 mil, 1.1 mil, 1.0 mil, 0.9 mil, 0.8 mil, 0.7 mil, 0.6 mil, 0.5 mil, or 0.4 mil—is in one of the following ranges: about 151,000 psi to 500,000 psi; 155,000 psi to 500,000 psi; 160,000 psi to 500,000 psi; 165,000 psi to 500,000 psi; 170,000 psi to 500,000 psi; 175,000 psi to 500,000 psi; 180,000 psi to 500,000 psi; 185,000 psi to 500,000 psi; 190,000 psi to 500,000 psi; 195,000 psi to 500,000 psi; 200,000 psi to 500,000 psi; 205,000 psi to 500,000 psi; 210,000 psi to 500,000 psi; 215,000 psi to 500,000 psi; 220,000 psi to 500,000 psi; 225,000 psi to 500,000 psi; 230,000 psi to 500,000 psi; 235,000 psi to 500,000 psi; 240,000 psi to 500,000 psi; 245,000 psi to 500,000 psi; 250,000 psi to 500,000 psi; 255,000 psi to 500,000 psi; 260,000 psi to 500,000 psi; 265,000 psi to 500,000 psi; 270,000 psi to 500,000 psi; 275,000 psi to 500,000 psi; 280,000 psi to 500,000 psi; 285,000 psi to 500,000 psi; 290,000 psi to 500,000 psi; 295,000 psi to 500,000 psi; 300,000 psi to 500,000 psi; 305,000 psi to 500,000 psi; 310,000 psi to 500,000 psi; 315,000 psi to 500,000 psi; 320,000 psi to 500,000 psi; 325,000 psi to 500,000 psi; 330,000 psi to 500,000 psi; 335,000 psi to 500,000 psi; 340,000 psi to 500,000 psi; 345,000 psi to 500,000 psi; 350,000 psi to 500,000 psi; 355,000 psi to 500,000 psi; 360,000 psi to 500,000 psi; 365,000 psi to 500,000 psi; 370,000 psi to 500,000 psi; 375,000 psi to 500,000 psi; 380,000 psi to 500,000 psi; 385,000 psi to 500,000 psi; 390,000 psi to 500,000 psi; 400,000 psi to 500,000 psi; 405,000 psi to 500,000 psi; 410,000 psi to 500,000 psi; 415,000 psi to 500,000 psi; 420,000 psi to 500,000 psi; 425,000 psi to 500,000 psi; 430,000 psi to 500,000 psi; 435,000 psi to 500,000 psi; 440,000 psi to 500,000 psi; 445,000 psi to 500,000 psi; 450,000 psi to 500,000 psi; 455,000 psi to 500,000 psi; 460,000 psi to 500,000 psi; 465,000 psi to 500,000 psi; 470,000 psi to 500,000 psi; 475,000 psi to 500,000 psi; 480,000 psi to 500,000 psi; 485,000 psi to 500,000 psi; 490,000 psi to 500,000 psi; or 495,000 psi to 500,000 psi. In a third set of ranges, the 1% secant modulus in machine direction for a machine direction-oriented polymeric film having a thickness of less than about 2.0 mil—in some embodiments, less than about 1.9 mil, 1.8 mil, 1.7 mil, 1.6 mil, 1.5 mil, 1.4 mil, 1.3 mil, 1.2 mil, 1.1 mil, 1.0 mil, 0.9 mil, 0.8 mil, 0.7 mil, 0.6 mil, 0.5 mil, or 0.4 mil—is in one of the following ranges: about 150,000 psi to 499,000 psi; 150,000 psi to 495,000 psi; 150,000 psi to 490,000 psi; 150,000 psi to 485,000 psi; 150,000 psi to 480,000 psi; 150,000 psi to 475,000 psi; 150,000 psi to 470,000 psi; 150,000 psi to 465,000 psi; 150,000 psi to 460,000 psi; 150,000 psi to 455,000 psi; 150,000 psi to 450,000 psi; 150,000 psi to 445,000 psi; 150,000 psi to 440,000 psi; 150,000 psi to 435,000 psi; 150,000 psi to 430,000 psi; 150,000 psi to 425,000 psi; 150,000 psi to 420,000 psi; 150,000 psi to 415,000 psi; 150,000 psi to 410,000 psi; 150,000 psi to 405,000 psi; or 150,000 psi to 400,000 psi; 150,000 psi to 395,000 psi; 150,000 psi to 390,000 psi; 150,000 psi to 385,000 psi; 150,000 psi to 380,000 psi; 150,000 psi to 375,000 psi; 150,000 psi to 370,000 psi; 150,000 psi to 365,000 psi; 150,000 psi to 360,000 psi; 150,000 psi to 355,000 psi; 150,000 psi to 350,000 psi; 150,000 psi to 345,000 psi; 150,000 psi to 340,000 psi; 150,000 psi to 335,000 psi; 150,000 psi to 330,000 psi; 150,000 psi to 325,000 psi; 150,000 psi to 320,000 psi; 150,000 psi to 315,000 psi; 150,000 psi to 310,000 psi; 150,000 psi to 305,000 psi; 150,000 psi to 300,000 psi; 150,000 psi to 295,000 psi; 150,000 psi to 290,000 psi; 150,000 psi to 285,000 psi; 150,000 psi to 280,000 psi; 150,000 psi to 275,000 psi; 150,000 psi to 270,000 psi; 150,000 psi to 265,000 psi; 150,000 psi to 260,000 psi; 150,000 psi to 255,000 psi; 150,000 psi to 250,000 psi; 150,000 psi to 245,000 psi; 150,000 psi to 240,000 psi; 150,000 psi to 235,000 psi; 150,000 psi to 230,000 psi; 150,000 psi to 225,000 psi; 150,000 psi to 220,000 psi; 150,000 psi to 215,000 psi; 150,000 psi to 210,000 psi; 150,000 psi to 205,000 psi; 150,000 psi to 200,000 psi; 150,000 psi to 195,000 psi; 150,000 psi to 190,000 psi; 150,000 psi to 185,000 psi; 150,000 psi to 180,000 psi; 150,000 psi to 175,000 psi; 150,000 psi to 170,000 psi; 150,000 psi to 165,000 psi; 150,000 psi to 160,000 psi; or 150,000 psi to 155,000 psi.

The gloss of a machine direction-oriented polymeric film in accordance with the present disclosure may be one of several different values or fall within one of several different ranges. For example, it is within the scope of the present disclosure to select a gloss to be greater than or equal to one of the following values: about 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, or 99%. In some embodiments, the gloss of the film may be greater than about 20%.

It is also within the scope of the present disclosure for the gloss of the machine direction-oriented polymeric film to fall within one of many different ranges. In a first set of ranges, the gloss for a machine direction-oriented polymeric film in accordance with the present disclosure is in one of the following ranges: about 20% to 99%, 21% to 98%, 22% to 97%, 23% to 96%, 24% to 95%, 25% to 94%, 26% to 93%, 27% to 92%, 28% to 91%, 29% to 90%, 30% to 89%, 31% to 88%, 32% to 87%, 33% to 86%, 34% to 85%, 35% to 84%, 36% to 83%, 37% to 82%, 38% to 81%, 39% to 80%, 40% to 79%, 41% to 78%, 42% to 77%, 43% to 76%, 44% to 75%, 45% to 74%, 46% to 73%, 47% to 72%, 48% to 71%, 49% to 70% 50% to 69%, 51% to 68%, 52% to 67%, 53% to 66%, 54% to 65%, 55% to 64%, 56% to 63%, 57% to 62%, 58% to 61%, or 59% to 60%. In a second set of ranges, the gloss for a machine direction-oriented polymeric film in accordance with the present disclosure is in one of the following ranges: about 19% to 99%, 20% to 99%, 21% to 99%, 22% to 99%, 23% to 99%, 24% to 99%, 25% to 99%, 26% to 99%, 27% to 99%, 28% to 99%, 29% to 99%, 30% to 99%, 31% to 99%, 32% to 99%, 33% to 99%, 34% to 99%, 35% to 99%, 36% to 99%, 37% to 99%, 38% to 99%, 39% to 99%, 40% to 99%, 41% to 99%, 42% to 99%, 43% to 99%, 44% to 99%, 45% to 99%, 46% to 99%, 47% to 99%, 48% to 99%, 49% to 99%, 50% to 99%, 51% to 99%, 52% to 99%, 53% to 99%, 54% to 99%, 55% to 99%, 56% to 99%, 57% to 99%, 58% to 99%, 59% to 99%, 60% to 99%, 61% to 99%, 62% to 99%, 63% to 99%, 64% to 99%, 65% to 99%, 66% to 99%, 67% to 99%, 68% to 99%, 69% to 99%, 70% to 99%, 71% to 99%, 72% to 99%, 73% to 99%, 74% to 99%, 75% to 99%, 76% to 99%, 77% to 99%, 78% to 99%, 79% to 99%, 80% to 99%, 81% to 99%, 82% to 99%, 83% to 99%, 84% to 99%, 85% to 99%, 86% to 99%, 87% to 99%, 88% to 99%, 89% to 99%, or 90% to 99%. In a third set of ranges, the gloss for a machine direction-oriented polymeric film in accordance with the present disclosure is in one of the following ranges: about 20% to 98%, 20% to 97%, 20% to 96%, 20% to 95%, 20% to 94%, 20% to 93%, 20% to 92%, 20% to 91%, 20% to 90%, 20% to 89%, 20% to 88%, 20% to 87%, 20% to 86%, 20% to 85%, 20% to 84%, 20% to 83%, 20% to 82%, 20% to 81%, 20% to 80%, 20% to 79%, 20% to 78%, 20% to 77%, 20% to 76%, 20% to 75%, 20% to 74%, 20% to 73%, 20% to 72%, 20% to 71%, 20% to 70%, 20% to 69%, 20% to 68%, 20% to 67%, 20% to 66%, 20% to 65%, 20% to 64%, 20% to 63%, 20% to 62%, 20% to 61%, 20% to 60%, 20% to 59%, 20% to 58%, 20% to 57%, 20% to 56%, 20% to 55%, 20% to 54%, 20% to 53%, 20% to 52%, 20% to 51%, 20% to 50%, 20% to 49%, 20% to 48%, 20% to 47%, 20% to 46%, 20% to 45%, 20% to 44%, 20% to 43%, 20% to 42%, 20% to 41%, 20% to 40%, 20% to 39%, 20% to 38%, 20% to 37%, 20% to 36%, 20% to 35%, 20% to 34%, 20% to 33%, 20% to 32%, 20% to 31%, 20% to 30%, 20% to 29%, 20% to 28%, 20% to 27%, 20% to 26%, 20% to 25%, 20% to 24%, 20% to 23%, 20% to 22%, or 20% to 21%.

The haze of a machine direction-oriented polymeric film in accordance with the present disclosure may be one of several different values or fall within one of several different ranges. For example, it is within the scope of the present disclosure to select a haze to be less than or equal to one of the following values: about 60%, 59%, 58%, 57%, 56%, 55%, 54%, 53%, 52%, 51%, 50%, 49%, 48%, 47%, 46%, 45%, 44%, 43%, 42%, 41%, 40%, 39%, 38%, 37%, 36%, 35%, 34%, 33%, 32%, 31%, 30%, 29%, 28%, 27%, 26%, 25%, 24%, 23%, 22%, 21%, 20%, 19%, 18%, 17%, 16%, 15%, 14%, 13%, 12%, 11%, 10%, 9%, 8%, 7%, 6%, 5%, 4%, 3%, 2%, or 1%.

It is also within the scope of the present disclosure for the haze of the machine direction-oriented polymeric film to fall within one of many different ranges. In a first set of ranges, the haze for a machine direction-oriented polymeric film in accordance with the present disclosure is in one of the following ranges: about 1% to 60%, 2% to 59%, 3% to 58%, 4% to 57%, 5% to 56%, 6% to 55%, 7% to 54%, 8% to 53%, 9% to 52%, 10% to 51%, 11% to 50%, 12% to 49%, 13% to 48%, 14% to 47%, 15% to 46%, 16% to 45%, 17% to 44%, 18% to 43%, 19% to 42%, 20% to 41%, 21% to 40%, 22% to 39%, 23% to 38%, 24% to 37%, 25% to 36%, 26% to 35%, 27% to 34%, 28% to 33%, 29% to 32%, or 30% to 31%. In a second set of ranges, the haze for a machine direction-oriented polymeric film in accordance with the present disclosure is in one of the following ranges: about 2% to 60%, 3% to 60%, 4% to 60%, 5% to 60%, 6% to 60%, 7% to 60%, 8% to 60%, 9% to 60%, 10% to 60%, 11% to 60%, 12% to 60%, 13% to 60%, 14% to 60%, 15% to 60%, 16% to 60%, 17% to 60%, 18% to 60%, 19% to 60%, 20% to 60%, 21% to 60%, 22% to 60%, 23% to 60%, 24% to 60%, 25% to 60%, 26% to 60%, 27% to 60%, 28% to 60%, 29% to 60%, 30% to 60%, 31% to 60%, 32% to 60%, 33% to 60%, 34% to 60%, 35% to 60%, 36% to 60%, 37% to 60%, 38% to 60%, 39% to 60%, 40% to 60%, 41% to 60%, 42% to 60%, 43% to 60%, 44% to 60%, 45% to 60%, 46% to 60%, 47% to 60%, 48% to 60%, 49% to 60%, 50% to 60%, 51% to 60%, 52% to 60%, 53% to 60%, 54% to 60%, 55% to 60%, 56% to 60%, 57% to 60%, 58% to 60%, or 59% to 60%. In a third set of ranges, the haze for a machine direction-oriented polymeric film in accordance with the present disclosure is in one of the following ranges: about 1% to 59%, 1% to 58%, 1% to 57%, 1% to 56%, 1% to 55%, 1% to 54%, 1% to 53%, 1% to 52%, 1% to 51%, 1% to 50%, 1% to 49%, 1% to 48%, 1% to 47%, 1% to 46%, 1% to 45%, 1% to 44%, 1% to 43%, 1% to 42%, 1% to 41%, 1% to 40%, 1% to 39%, 1% to 38%, 1% to 37%, 1% to 36%, 1% to 35%, 1% to 34%, 1% to 33%, 1% to 32%, 1% to 31%, 1% to 30%, 1% to 29%, 1% to 28%, 1% to 27%, 1% to 26%, 1% to 25%, 1% to 24%, 1% to 23%, 1% to 22%, 1% to 21%, 1% to 20%, 1% to 19%, 1% to 18%, 1% to 17%, 1% to 16%, 1% to 15%, 1% to 14%, 1% to 13%, 1% to 12%, 1% to 11%, 1% to 10%, 1% to 9%, 1% to 8%, 1% to 7%, 1% to 6%, 1% to 5%, 1% to 4%, 1% to 3%, or 1% to 2%.

The stress at break in the machine direction of a machine direction-oriented polymeric film in accordance with the present disclosure may be one of several different values or fall within one of several different ranges. For example, for a machine direction-oriented polymeric film having a thickness of less than about 2.0 mil—in some embodiments, less than about 1.9 mil, 1.8 mil, 1.7 mil, 1.6 mil, 1.5 mil, 1.4 mil, 1.3 mil, 1.2 mil, 1.1 mil, 1.0 mil, 0.9 mil, 0.8 mil, 0.7 mil, 0.6 mil, 0.5 mil, or 0.4 mil—it is within the scope of the present disclosure to select a stress at break in the machine direction to be greater than or equal to one of the following values: about 25,000 psi; 26,000 psi; 27,000 psi; 28,000 psi; 29,000 psi; 30,000 psi; 31,000 psi; 32,000 psi; 33,000 psi; 34,000 psi; 35,000 psi; 36,000 psi; 37,000 psi; 38,000 psi; 39,000 psi; 40,000 psi; 41,000 psi; 42,000 psi; 43,000 psi; 44,000 psi; 45,000 psi; 46,000 psi; 47,000 psi; 48,000 psi; 49,000 psi; or 50,000 psi.

It is also within the scope of the present disclosure for the stress at break in the machine direction of the machine direction-oriented polymeric film to fall within one of many different ranges. In a first set of ranges, the stress at break in the machine direction for a machine direction-oriented polymeric film having a thickness of less than about 2.0 mil—in some embodiments, less than about 1.9 mil, 1.8 mil, 1.7 mil, 1.6 mil, 1.5 mil, 1.4 mil, 1.3 mil, 1.2 mil, 1.1 mil, 1.0 mil, 0.9 mil, 0.8 mil, 0.7 mil, 0.6 mil, 0.5 mil, or 0.4 mil—is in one of the following ranges: about 25,000 psi to about 60,000 psi; 26,000 psi to about 59,000 psi; 27,000 psi to about 58,000 psi; 28,000 psi to about 57,000 psi; 29,000 psi to about 56,000 psi; 30,000 psi to about 55,000 psi; 31,000 psi to about 54,000 psi; 32,000 psi to about 53,000 psi; 33,000 psi to about 52,000 psi; 34,000 psi to about 51,000 psi; 35,000 psi to about 50,000 psi; 36,000 psi to about 49,000 psi; 37,000 psi to about 48,000 psi; 38,000 psi to about 47,000 psi; 39,000 psi to about 46,000 psi; 40,000 psi to about 45,000 psi; 41,000 psi to about 44,000 psi; or 42,000 psi to about 43,000 psi. In a second set of ranges, the stress at break in the machine direction for a machine direction-oriented polymeric film having a thickness of less than about 2.0 mil—in some embodiments, less than about 1.9 mil, 1.8 mil, 1.7 mil, 1.6 mil, 1.5 mil, 1.4 mil, 1.3 mil, 1.2 mil, 1.1 mil, 1.0 mil, 0.9 mil, 0.8 mil, 0.7 mil, 0.6 mil, 0.5 mil, or 0.4 mil—is in one of the following ranges: about 26,000 psi to about 60,000 psi; 27,000 psi to about 60,000 psi; 28,000 psi to about 60,000 psi; 29,000 psi to about 60,000 psi; 30,000 psi to about 60,000 psi; 31,000 psi to about 60,000 psi; 32,000 psi to about 60,000 psi; 33,000 psi to about 60,000 psi; 34,000 psi to about 60,000 psi; 35,000 psi to about 60,000 psi; 36,000 psi to about 60,000 psi; 37,000 psi to about 60,000 psi; 38,000 psi to about 60,000 psi; 39,000 psi to about 60,000 psi; 40,000 psi to about 60,000 psi; 41,000 psi to about 60,000 psi; 42,000 psi to about 60,000 psi; 43,000 psi to about 60,000 psi; 44,000 psi to about 60,000 psi; 45,000 psi to about 60,000 psi; 46,000 psi to about 60,000 psi; 47,000 psi to about 60,000 psi; 48,000 psi to about 60,000 psi; 49,000 psi to about 60,000 psi; 50,000 psi to about 60,000 psi; 51,000 psi to about 60,000 psi; 52,000 psi to about 60,000 psi; 53,000 psi to about 60,000 psi; 54,000 psi to about 60,000 psi; or 55,000 psi to about 60,000 psi. In a third set of ranges, the stress at break in the machine direction for a machine direction-oriented polymeric film having a thickness of less than about 2.0 mil—in some embodiments, less than about 1.9 mil, 1.8 mil, 1.7 mil, 1.6 mil, 1.5 mil, 1.4 mil, 1.3 mil, 1.2 mil, 1.1 mil, 1.0 mil, 0.9 mil, 0.8 mil, 0.7 mil, 0.6 mil, 0.5 mil, or 0.4 mil—is in one of the following ranges: about 25,000 psi to about 59,000 psi; 25,000 psi to about 58,000 psi; 25,000 psi to about 57,000 psi; 25,000 psi to about 56,000 psi; 25,000 psi to about 55,000 psi; 25,000 psi to about 54,000 psi; 25,000 psi to about 53,000 psi; 25,000 psi to about 52,000 psi; 25,000 psi to about 51,000 psi; 25,000 psi to about 50,000 psi; 25,000 psi to about 49,000 psi; 25,000 psi to about 48,000 psi; 25,000 psi to about 47,000 psi; 25,000 psi to about 46,000 psi; 25,000 psi to about 45,000 psi; 25,000 psi to about 44,000 psi; 25,000 psi to about 43,000 psi; 25,000 psi to about 42,000 psi; 25,000 psi to about 41,000 psi; 25,000 psi to about 40,000 psi; 25,000 psi to about 39,000 psi; 25,000 psi to about 38,000 psi; 25,000 psi to about 37,000 psi; 25,000 psi to about 36,000 psi; 25,000 psi to about 35,000 psi; 25,000 psi to about 34,000 psi; 25,000 psi to about 33,000 psi; 25,000 psi to about 32,000 psi; 25,000 psi to about 31,000 psi; or 25,000 psi to about 30,000 psi.

In illustrative embodiments, a machine direction-oriented polymeric film in accordance with the present disclosure exhibits a moisture vapor transmission rate (MVTR)-also known as water vapor transmission rate (WVTR)-that is lower than conventional polymeric films of similar thickness. In one example, the MVTR at 90% relative humidity (RH) for a machine direction-oriented polymeric film having a thickness of less than about 2.0 mil—in some embodiments, less than about 1.9 mil, 1.8 mil, 1.7 mil, 1.6 mil, 1.5 mil, 1.4 mil, 1.3 mil, 1.2 mil, 1.1 mil, 1.0 mil, 0.9 mil, 0.8 mil, 0.7 mil, 0.6 mil, 0.5 mil, or 0.4 mil—ranges from about 0.05 grams/100 in²/day to 0.35 grams/100 in²/day. In another example, the MVTR at 90% relative humidity (RH) for a machine direction-oriented polymeric film having a thickness of less than about 2.0 mil—in some embodiments, less than about 1.9 mil, 1.8 mil, 1.7 mil, 1.6 mil, 1.5 mil, 1.4 mil, 1.3 mil, 1.2 mil, 1.1 mil, 1.0 mil, 0.9 mil, 0.8 mil, 0.7 mil, 0.6 mil, 0.5 mil, or 0.4 mil—ranges from about 0.10 grams/100 in²/day to 0.30 grams/100 in²/day. In another example, the MVTR at 90% relative humidity (RH) for a machine direction-oriented polymeric film having a thickness of less than about 2.0 mil—in some embodiments, less than about 1.9 mil, 1.8 mil, 1.7 mil, 1.6 mil, 1.5 mil, 1.4 mil, 1.3 mil, 1.2 mil, 1.1 mil, 1.0 mil, 0.9 mil, 0.8 mil, 0.7 mil, 0.6 mil, 0.5 mil, or 0.4 mil—ranges from about 0.10 grams/100 in²/day to 0.25 grams/100 in²/day. In a further example, the MVTR at 90% relative humidity (RH) for a machine direction-oriented polymeric film having a thickness of less than about 2.0 mil—in some embodiments, less than about 1.9 mil, 1.8 mil, 1.7 mil, 1.6 mil, 1.5 mil, 1.4 mil, 1.3 mil, 1.2 mil, 1.1 mil, 1.0 mil, 0.9 mil, 0.8 mil, 0.7 mil, 0.6 mil, 0.5 mil, or 0.4 mil—ranges from about 0.10 grams/100 in²/day to 0.15 grams/100 in²/day.

The moisture vapor transmission rate (MVTR) of a machine direction-oriented polymeric film in accordance with the present disclosure may be one of several different values or fall within one of several different ranges. For example, for a machine direction-oriented polymeric film having a thickness of less than about 2.0 mil—in some embodiments, less than about 1.9 mil, 1.8 mil, 1.7 mil, 1.6 mil, 1.5 mil, 1.4 mil, 1.3 mil, 1.2 mil, 1.1 mil, 1.0 mil, 0.9 mil, 0.8 mil, 0.7 mil, 0.6 mil, 0.5 mil, or 0.4 mil—it is within the scope of the present disclosure to select a MVTR at 90% relative humidity (RH) to be less than or equal to one of the following values: about 0.35 grams/100 in²/day, 0.34 grams/100 in²/day, 0.33 grams/100 in²/day, 0.32 grams/100 in²/day, 0.31 grams/100 in²/day, 0.30 grams/100 in²/day, 0.29 grams/100 in²/day, 0.28 grams/100 in²/day, 0.27 grams/100 in²/day, 0.26 grams/100 in²/day, 0.25 grams/100 in²/day, 0.24 grams/100 in²/day, 0.23 grams/100 in²/day, 0.22 grams/100 in²/day, 0.21 grams/100 in²/day, 0.20 grams/100 in²/day, 0.19 grams/100 in²/day, 0.18 grams/100 in²/day, 0.17 grams/100 in²/day, 0.16 grams/100 in²/day, 0.15 grams/100 in²/day, 0.14 grams/100 in²/day, 0.13 grams/100 in²/day, 0.12 grams/100 in²/day, 0.11 grams/100 in²/day, 0.10 grams/100 in²/day, 0.09 grams/100 in²/day, 0.08 grams/100 in²/day, 0.07 grams/100 in²/day, 0.06 grams/100 in²/day, or 0.05 grams/100 in²/day.

It is also within the scope of the present disclosure for the MVTR at 90% RH of the machine direction-oriented polymeric film to fall within one of many different ranges. In a first set of ranges, the MVTR at 90% relative humidity (RH) for a machine direction-oriented polymeric film having a thickness of less than about 2.0 mil—in some embodiments, less than about 1.9 mil, 1.8 mil, 1.7 mil, 1.6 mil, 1.5 mil, 1.4 mil, 1.3 mil, 1.2 mil, 1.1 mil, 1.0 mil, 0.9 mil, 0.8 mil, 0.7 mil, 0.6 mil, 0.5 mil, or 0.4 mil—is in one of the following ranges: about 0.05 grams/100 in²/day to 0.35 grams/100 in²/day, 0.06 grams/100 in²/day to 0.34 grams/100 in²/day, 0.07 grams/100 in²/day to 0.33 grams/100 in²/day, 0.08 grams/100 in²/day to 0.32 grams/100 in²/day, 0.09 grams/100 in²/day to 0.31 grams/100 in²/day, 0.10 grams/100 in²/day to 0.30 grams/100 in²/day, 0.11 grams/100 in²/day to 0.29 grams/100 in²/day, 0.12 grams/100 in²/day to 0.28 grams/100 in²/day, 0.13 grams/100 in²/day to 0.27 grams/100 in²/day, 0.14 grams/100 in²/day to 0.26 grams/100 in²/day, 0.15 grams/100 in²/day to 0.25 grams/100 in²/day, 0.16 grams/100 in²/day to 0.24 grams/100 in²/day, 0.17 grams/100 in²/day to 0.23 grams/100 in²/day, 0.18 grams/100 in²/day to 0.22 grams/100 in²/day, or 0.19 grams/100 in²/day to 0.21 grams/100 in²/day. In a second set of ranges, the MVTR at 90% relative humidity (RH) for a machine direction-oriented polymeric film having a thickness of less than about 2.0 mil—in some embodiments, less than about 1.9 mil, 1.8 mil, 1.7 mil, 1.6 mil, 1.5 mil, 1.4 mil, 1.3 mil, 1.2 mil, 1.1 mil, 1.0 mil, 0.9 mil, 0.8 mil, 0.7 mil, 0.6 mil, 0.5 mil, or 0.4 mil—is in one of the following ranges: about 0.06 grams/100 in²/day to 0.35 grams/100 in²/day, 0.07 grams/100 in²/day to 0.35 grams/100 in²/day, 0.08 grams/100 in²/day to 0.35 grams/100 in²/day, 0.09 grams/100 in²/day to 0.35 grams/100 in²/day, 0.10 grams/100 in²/day to 0.35 grams/100 in²/day, 0.11 grams/100 in²/day to 0.35 grams/100 in²/day, 0.12 grams/100 in²/day to 0.35 grams/100 in²/day, 0.13 grams/100 in²/day to 0.35 grams/100 in²/day, 0.14 grams/100 in²/day to 0.35 grams/100 in²/day, 0.15 grams/100 in²/day to 0.35 grams/100 in²/day, 0.16 grams/100 in²/day to 0.35 grams/100 in²/day, 0.17 grams/100 in²/day to 0.35 grams/100 in²/day, 0.18 grams/100 in²/day to 0.35 grams/100 in²/day, 0.19 grams/100 in²/day to 0.35 grams/100 in²/day, 0.20 grams/100 in²/day to 0.35 grams/100 in²/day, 0.21 grams/100 in²/day to 0.35 grams/100 in²/day, 0.22 grams/100 in²/day to 0.35 grams/100 in²/day, 0.23 grams/100 in²/day to 0.35 grams/100 in²/day, 0.24 grams/100 in²/day to 0.35 grams/100 in²/day, 0.25 grams/100 in²/day to 0.35 grams/100 in²/day, 0.26 grams/100 in²/day to 0.35 grams/100 in²/day, 0.27 grams/100 in²/day to 0.35 grams/100 in²/day, 0.28 grams/100 in²/day to 0.35 grams/100 in²/day, 0.29 grams/100 in²/day to 0.35 grams/100 in²/day, 0.30 grams/100 in²/day to 0.35 grams/100 in²/day, 0.31 grams/100 in²/day to 0.35 grams/100 in²/day, 0.32 grams/100 in²/day to 0.33 grams/100 in²/day, or 0.34 grams/100 in²/day to 0.35 grams/100 in²/day. In a third set of ranges, the MVTR at 90% relative humidity (RH) for a machine direction-oriented polymeric film having a thickness of less than about 2.0 mil—in some embodiments, less than about 1.9 mil, 1.8 mil, 1.7 mil, 1.6 mil, 1.5 mil, 1.4 mil, 1.3 mil, 1.2 mil, 1.1 mil, 1.0 mil, 0.9 mil, 0.8 mil, 0.7 mil, 0.6 mil, 0.5 mil, or 0.4 mil—is in one of the following ranges: about 0.05 grams/100 in²/day to 0.34 grams/100 in²/day, 0.05 grams/100 in²/day to 0.33 grams/100 in²/day, 0.05 grams/100 in²/day to 0.32 grams/100 in²/day, 0.05 grams/100 in²/day to 0.31 grams/100 in²/day, 0.05 grams/100 in²/day to 0.30 grams/100 in²/day, 0.05 grams/100 in²/day to 0.29 grams/100 in²/day, 0.05 grams/100 in²/day to 0.28 grams/100 in²/day, 0.05 grams/100 in²/day to 0.27 grams/100 in²/day, 0.05 grams/100 in²/day to 0.26 grams/100 in²/day, 0.05 grams/100 in²/day to 0.25 grams/100 in²/day, 0.05 grams/100 in²/day to 0.24 grams/100 in²/day, 0.05 grams/100 in²/day to 0.23 grams/100 in²/day, 0.05 grams/100 in²/day to 0.22 grams/100 in²/day, 0.05 grams/100 in²/day to 0.21 grams/100 in²/day, 0.05 grams/100 in²/day to 0.20 grams/100 in²/day, 0.05 grams/100 in²/day to 0.19 grams/100 in²/day, 0.05 grams/100 in²/day to 0.18 grams/100 in²/day, 0.05 grams/100 in²/day to 0.17 grams/100 in²/day, 0.05 grams/100 in²/day to 0.16 grams/100 in²/day, 0.05 grams/100 in²/day to 0.15 grams/100 in²/day, 0.05 grams/100 in²/day to 0.14 grams/100 in²/day, 0.05 grams/100 in²/day to 0.13 grams/100 in²/day, 0.05 grams/100 in²/day to 0.12 grams/100 in²/day, 0.05 grams/100 in²/day to 0.11 grams/100 in²/day, 0.05 grams/100 in²/day to 0.10 grams/100 in²/day, 0.05 grams/100 in²/day to 0.09 grams/100 in²/day, 0.05 grams/100 in²/day to 0.08 grams/100 in²/day, 0.05 grams/100 in²/day to 0.07 grams/100 in²/day, or 0.05 grams/100 in²/day to 0.06 grams/100 in²/day.

The heat seal initiation of a machine direction-oriented polymeric film in accordance with the present disclosure may be one of several different values or fall within one of several different ranges and, in illustrative embodiments, may be measured using ASTM F2029-00 and ASTM F88-00. For example, it is within the scope of the present disclosure to select a heat seal initiation as measured by ASTM F2029-00 and ASTM F88-00 to be less than or equal to one of the following values: about 250° F., 249° F., 248° F., 247° F., 246° F., 245° F., 244° F., 243° F., 242° F., 241° F., 240° F., 239° F., 238° F., 237° F., 236° F., 235° F., 234° F., 233° F., 232° F., 231° F., 230° F., 229° F., 228° F., 227° F., 226° F., 225° F., 224° F., 223° F., 222° F., 221° F., 220° F., 219° F., 218° F., 217° F., 216° F., 215° F., 214° F., 213° F., 212° F., 211° F., 210° F., 209° F., 208° F., 207° F., 206° F., 205° F., 204° F., 203° F., 202° F., 201° F., 200° F., 199° F., 198° F., 197° F., 196° F., 195° F., 194° F., 193° F., 192° F., 191° F., 190° F., 189° F., 188° F., 187° F., 186° F., 185° F., 184° F., 183° F., 182° F., 181° F., 180° F., 179° F., 178° F., 177° F., 176° F., 175° F., 174° F., 173° F., 172° F., 171° F., 170° F., 169° F., 168° F., 167° F., 166° F., 165° F., 249° F., 164° F., 163° F., 162° F., 161° F., or 160° F. It is also within the scope of the present disclosure to select a heat seal initiation as measured by ASTM F2029-00 and ASTM F88-00 to be less than or equal to one of the following values: about 135° C., 134° C., 133° C., 132° C., 131° C., 130° C., 129° C., 128° C., 127° C., 126° C., 125° C., 124° C., 123° C., 122° C., 121° C., 120° C., 119° C., 118° C., 117° C., 116° C., 115° C., 114° C., 113° C., 112° C., 111° C., 110° C., 109° C., 108° C., 107° C., 106° C., 105° C., 104° C., 103° C., 102° C., 101° C., 100° C., 99° C., 98° C., 97° C., 96° C., 95° C., 94° C., 93° C., 92° C., 91° C., or 90° C.

It is also within the scope of the present disclosure for the heat seal initiation of the machine direction-oriented polymeric film as measured by ASTM F2029-00 and ASTM F88-00 to fall within one of many different ranges. In a first set of ranges, the heat seal initiation for a machine direction-oriented polymeric film in accordance with the present disclosure as measured by ASTM F2029-00 and ASTM F88-00 is in one of the following ranges: about 160° F. to 250° F., 161° F. to 249° F., 162° F. to 248° F., 163° F. to 247° F., 164° F. to 246° F., 165° F. to 245° F., 166° F. to 244° F., 167° F. to 243° F., 168° F. to 242° F., 169° F. to 241° F., 170° F. to 240° F., 171° F. to 239° F., 172° F. to 238° F., 173° F. to 237° F., 174° F. to 236° F., 175° F. to 235° F., 176° F. to 234° F., 177° F. to 233° F., 178° F. to 232° F., 179° F. to 231° F., 180° F. to 230° F., 181° F. to 229° F., 182° F. to 228° F., 183° F. to 227° F., 184° F. to 226° F., 185° F. to 225° F., 186° F. to 224° F., 187° F. to 223° F., 188° F. to 222° F., 189° F. to 221° F., 190° F. to 220° F., 191° F. to 219° F., 192° F. to 218° F., 193° F. to 217° F., 194° F. to 216° F., 195° F. to 215° F., 196° F. to 214° F., 197° F. to 213° F., 198° F. to 212° F., 199° F. to 211° F., 200° F. to 210° F., 201° F. to 209° F., 202° F. to 208° F., 203° F. to 207° F., or 204° F. to 206° F. In a second set of ranges, the heat seal initiation for a machine direction-oriented polymeric film in accordance with the present disclosure as measured by ASTM F2029-00 and ASTM F88-00 is in one of the following ranges is in one of the following ranges: about 160° F. to 250° F., 161° F. to 250° F., 162° F. to 250° F., 163° F. to 250° F., 164° F. to 250° F., 165° F. to 250° F., 166° F. to 250° F., 167° F. to 250° F., 168° F. to 250° F., 169° F. to 250° F., 170° F. to 250° F., 171° F. to 250° F., 172° F. to 250° F., 173° F. to 250° F., 174° F. to 250° F., 175° F. to 250° F., 176° F. to 250° F., 177° F. to 250° F., 178° F. to 250° F., 179° F. to 250° F., 180° F. to 250° F., 181° F. to 250° F., 182° F. to 250° F., 183° F. to 250° F., 184° F. to 250° F., 185° F. to 250° F., 186° F. to 250° F., 187° F. to 250° F., 188° F. to 250° F., 189° F. to 250° F., 190° F. to 250° F., 191° F. to 250° F., 192° F. to 250° F., 193° F. to 250° F., 194° F. to 250° F., 195° F. to 250° F., 196° F. to 250° F., 197° F. to 250° F., 198° F. to 250° F., 199° F. to 250° F., 200° F. to 250° F., 201° F. to 250° F., 202° F. to 250° F., 203° F. to 250° F., 204° F. to 250° F., 205° F. to 250° F., 206° F. to 250° F., 207° F. to 250° F., 208° F. to 250° F., 209° F. to 250° F., 210° F. to 250° F., 211° F. to 250° F., 212° F. to 250° F., 213° F. to 250° F., 214° F. to 250° F., 215° F. to 250° F., 216° F. to 250° F., 217° F. to 250° F., 218° F. to 250° F., 219° F. to 250° F., 220° F. to 250° F., 221° F. to 250° F., 222° F. to 250° F., 223° F. to 250° F., 224° F. to 250° F., 225° F. to 250° F., 226° F. to 250° F., 227° F. to 250° F., 228° F. to 250° F., 229° F. to 250° F., 230° F. to 250° F., 231° F. to 250° F., 232° F. to 250° F., 233° F. to 250° F., 234° F. to 250° F., 235° F. to 250° F., 236° F. to 250° F., 237° F. to 250° F., 238° F. to 250° F., 239° F. to 250° F., 240° F. to 250° F., 241° F. to 250° F., 242° F. to 250° F., 243° F. to 250° F., 244° F. to 250° F., 245° F. to 250° F., 246° F. to 250° F., 247° F. to 250° F., or 248° F. to 250° F. In a third set of ranges, the heat seal initiation for a machine direction-oriented polymeric film in accordance with the present disclosure as measured by ASTM F2029-00 and ASTM F88-00 is in one of the following ranges is in one of the following ranges: about 160° F. to 250° F., 160° F. to 249° F., 160° F. to 248° F., 160° F. to 247° F., 160° F. to 246° F., 160° F. to 245° F., 160° F. to 244° F., 160° F. to 243° F., 160° F. to 242° F., 160° F. to 241° F., 160° F. to 240° F., 160° F. to 239° F., 160° F. to 238° F., 160° F. to 237° F., 160° F. to 236° F., 160° F. to 235° F., 160° F. to 234° F., 160° F. to 233° F., 160° F. to 232° F., 160° F. to 231° F., 160° F. to 230° F., 160° F. to 229° F., 160° F. to 228° F., 160° F. to 227° F., 160° F. to 226° F., 160° F. to 225° F., 160° F. to 224° F., 160° F. to 223° F., 160° F. to 222° F., 160° F. to 221° F., 160° F. to 220° F., 160° F. to 219° F., 160° F. to 218° F., 160° F. to 217° F., 160° F. to 216° F., 160° F. to 215° F., 160° F. to 214° F., 160° F. to 213° F., 160° F. to 212° F., 160° F. to 211° F., 160° F. to 210° F., 160° F. to 209° F., 160° F. to 208° F., 160° F. to 207° F., 160° F. to 206° F., 160° F. to 205° F., 160° F. to 204° F., 160° F. to 203° F., 160° F. to 202° F., 160° F. to 201° F., 160° F. to 200° F., 160° F. to 199° F., 160° F. to 198° F., 160° F. to 197° F., 160° F. to 196° F., 160° F. to 195° F., 160° F. to 194° F., 160° F. to 193° F., 160° F. to 192° F., 160° F. to 191° F., 160° F. to 190° F., 160° F. to 189° F., 160° F. to 188° F., 160° F. to 187° F., 160° F. to 186° F., 160° F. to 185° F., 160° F. to 184° F., 160° F. to 183° F., 160° F. to 182° F., 160° F. to 181° F., 160° F. to 180° F., 160° F. to 179° F., 160° F. to 178° F., 160° F. to 177° F., 160° F. to 176° F., 160° F. to 175° F., 160° F. to 174° F., 160° F. to 173° F., 160° F. to 172° F., 160° F. to 171° F., 160° F. to 170° F., 160° F. to 169° F., 160° F. to 168° F., 160° F. to 167° F., 160° F. to 166° F., 160° F. to 165° F., 160° F. to 164° F., 160° F. to 163° F., 160° F. to 162° F., or 160° F. to 161° F. In a fourth set of ranges, the heat seal initiation for a machine direction-oriented polymeric film in accordance with the present disclosure as measured by ASTM F2029-00 and ASTM F88-00 is in one of the following ranges: about 90° C. to 135° C., 91° C. to 134° C., 92° C. to 133° C., 93° C. to 132° C., 94° C. to 131° C., 95° C. to 130° C., 96° C. to 129° C., 97° C. to 128° C., 98° C. to 127° C., 99° C. to 126° C., 100° C. to 125° C., 101° C. to 124° C., 102° C. to 123° C., 103° C. to 122° C., 104° C. to 121° C., 105° C. to 120° C., 106° C. to 119° C., 107° C. to 118° C., 108° C. to 117° C., 109° C. to 116° C., 110° C. to 115° C., 111° C. to 114° C., or 112° C. to 113° C. Ina fifth set of ranges, the heat seal initiation for a machine direction-oriented polymeric film in accordance with the present disclosure as measured by ASTM F2029-00 and ASTM F88-00 is in one of the following ranges: about 90° C. to 134° C., 91° C. to 135° C., 92° C. to 135° C., 93° C. to 135° C., 94° C. to 135° C., 95° C. to 135° C., 96° C. to 135° C., 97° C. to 135° C., 98° C. to 135° C., 99° C. to 135° C., 100° C. to 135° C., 101° C. to 135° C., 102° C. to 135° C., 103° C. to 135° C., 104° C. to 135° C., 105° C. to 135° C., 106° C. to 135° C., 107° C. to 135° C., 108° C. to 135° C., 109° C. to 135° C., 110° C. to 135° C., 111° C. to 135° C., 112° C. to 135° C., 113° C. to 135° C., 114° C. to 135° C., 115° C. to 135° C., 116° C. to 135° C., 117° C. to 135° C., 118° C. to 135° C., 119° C. to 135° C., 120° C. to 135° C., 121° C. to 135° C., 122° C. to 135° C., 123° C. to 135° C., 124° C. to 135° C., 125° C. to 135° C., 126° C. to 135° C., 127° C. to 135° C., 128° C. to 135° C., 129° C. to 135° C., 130° C. to 135° C., 131° C. to 135° C., 132° C. to 135° C., 133° C. to 135° C., or 135° C. to 135° C. Ina sixth set of ranges, the heat seal initiation for a machine direction-oriented polymeric film in accordance with the present disclosure as measured by ASTM F2029-00 and ASTM F88-00 is in one of the following ranges: about 91° C. to 135° C., 90° C. to 134° C., 90° C. to 133° C., 90° C. to 132° C., 90° C. to 131° C., 90° C. to 130° C., 90° C. to 129° C., 90° C. to 128° C., 90° C. to 127° C., 90° C. to 126° C., 90° C. to 125° C., 90° C. to 124° C., 90° C. to 123° C., 90° C. to 122° C., 90° C. to 121° C., 90° C. to 120° C., 90° C. to 119° C., 90° C. to 118° C., 90° C. to 117° C., 90° C. to 116° C., 90° C. to 115° C., 90° C. to 114° C., 90° C. to 113° C., 90° C. to 112° C., 90° C. to 111° C., 90° C. to 110° C., 90° C. to 109° C., 90° C. to 108° C., 90° C. to 107° C., 90° C. to 106° C., 90° C. to 105° C., 90° C. to 104° C., 90° C. to 103° C., 90° C. to 102° C., 90° C. to 101° C., 90° C. to 100° C., 90° C. to 99° C., 90° C. to 98° C., 90° C. to 97° C., 90° C. to 96° C., 90° C. to 95° C., 90° C. to 94° C., 90° C. to 93° C., 90° C. to 92° C., or 90° C. to 91° C.

The thickness of a machine direction-oriented polymeric film in accordance with the present disclosure may be varied based on a desired end use (e.g., the desired properties and/or applications of the machine direction-oriented polymeric film). In one example, the thickness ranges from about 0.2 mil to about 3.0 mil. In another example, the thickness ranges from about 0.3 mil to about 2.5 mil. In illustrative embodiments, the thickness is less than about 2.0 mil, in some examples less than about 1.5 mil, in some examples less than about 1.0 mil, in some examples less than about 0.9 mil, in some examples less than about 0.8 mil, in some examples less than about 0.7 mil, in some examples less than about 0.6 mil, and in some examples less than about 0.5 mil. Although thicknesses outside this range may also be employed (e.g., thicknesses above about 3.0 mil), lower thicknesses minimize material cost. The thickness of a machine direction-oriented polymeric film in accordance with the present disclosure may be one of several different values or fall within one of several different ranges. For example, it is within the scope of the present disclosure to select a thickness to be less than or equal to one of the following values: about 3.0 mil, 2.9 mil, 2.8 mil, 2.7 mil, 2.6 mil, 2.5 mil, 2.4 mil, 2.3 mil, 2.2 mil, 2.1 mil, 2.0 mil, 1.9 mil, 1.8 mil, 1.7 mil, 1.6 mil, 1.5 mil, 1.4 mil, 1.3 mil, 1.2 mil, 1.1 mil, 1.0 mil, 0.9 mil, 0.8 mil, 0.7 mil, 0.6 mil, 0.5 mil, or 0.4 mil.

It is also within the scope of the present disclosure for the thickness of the machine direction-oriented polymeric film to fall within one of many different ranges. In a first set of ranges, the thickness of the machine direction-oriented polymeric film is in one of the following ranges: about 0.2 mil to 3.0 mil, 0.3 mil to 2.9 mil, 0.4 mil to 2.8 mil, 0.5 mil to 2.7 mil, 0.6 mil to 2.6 mil, 0.7 mil to 2.5 mil, 0.8 mil to 2.4 mil, 0.9 mil to 2.3 mil, 1.0 mil to 2.2 mil, 1.1 mil to 2.1 mil, 1.2 mil to 2.0 mil, 1.3 mil to 1.9 mil, 1.4 mil to 1.8 mil, or 1.5 mil to 1.7 mil. In a second set of ranges, the thickness of the machine direction-oriented polymeric film is in one of the following ranges: about 0.3 mil to 3.0 mil, 0.4 mil to 3.0 mil, 0.5 mil to 3.0 mil, 0.6 mil to 3.0 mil, 0.7 mil to 3.0 mil, 0.8 mil to 3.0 mil, 0.9 mil to 3.0 mil, 1.0 mil to 3.0 mil, 1.1 mil to 3.0 mil, 1.2 mil to 3.0 mil, 1.3 mil to 3.0 mil, 1.4 mil to 3.0 mil, 1.5 mil to 3.0 mil, 1.6 mil to 3.0 mil, 1.7 mil to 3.0 mil, 1.8 mil to 3.0 mil, 1.9 mil to 3.0 mil, 2.0 mil to 3.0 mil, 2.1 mil to 3.0 mil, 2.2 mil to 3.0 mil, 2.3 mil to 3.0 mil, 2.4 mil to 3.0 mil, 2.5 mil to 3.0 mil, 2.6 mil to 3.0 mil, 2.7 mil to 3.0 mil, 2.8 mil to 3.0 mil, or 2.9 mil to 3.0 mil. In a third set of ranges, the thickness of the machine direction-oriented polymeric film is in one of the following ranges: about 0.3 mil to 2.9 mil, 0.3 mil to 2.8 mil, 0.3 mil to 2.7 mil, 0.3 mil to 2.6 mil, 0.3 mil to 2.5 mil, 0.3 mil to 2.4 mil, 0.3 mil to 2.3 mil, 0.3 mil to 2.2 mil, 0.3 mil to 2.1 mil, 0.3 mil to 2.0 mil, 0.3 mil to 1.9 mil, 0.3 mil to 1.8 mil, 0.3 mil to 1.7 mil, 0.3 mil to 1.6 mil, 0.3 mil to 1.5 mil, 0.3 mil to 1.4 mil, 0.3 mil to 1.3 mil, 0.3 mil to 1.2 mil, 0.3 mil to 1.1 mil, 0.3 mil to 1.0 mil, 0.3 mil to 0.9 mil, 0.3 mil to 0.8 mil, 0.3 mil to 0.7 mil, 0.3 mil to 0.6 mil, 0.3 mil to 0.5 mil, or 0.3 mil to 0.4 mil.

Machine direction-oriented polymeric films of a type described above are not limited to any specific kind of film structure. Other film structures may achieve the same or similar result as the A-B-C three-layer film 2 shown in FIG. 1, the A-B-C-D four-layer structure 3 shown in FIG. 3, the A-B-C-B-D five layer structure 56 shown in FIG. 4, and the A-B-B-C-D-C-B-B-D film structure shown in FIG. 5. Film structure is a function of equipment design and capability. For example, the number of layers in a film depends only on the technology available and the desired end use for the film. Representative examples of film structures in accordance with the present disclosure that may be implemented using a blown film process include but are not limited to the following:
A-B-C
A-B-C-D
A-B-C-D-E
A-B-C-D-E-F
A-B-C-D-E-F-G
A-B-C-D-E-F-G-H
A-B-C-D-E-F-G-H-I
A-B-C-D-E-F-G-H-I-J
A-B-C-D-E-F-G-H-I-J-K
A-B-C-D-E-F-G-H-I-J-K-L
A-B-C-D-E-F-G-H-I-J-K-L-M

In the representative examples of blown film structures shown above, it is to be understood that any two or more of the individual layers—even though they may be designated by different letters—may in fact contain identical compositions. By way of example, a three-layer blown film structure designated as A-B-C in the scheme above includes both a structure in which the A and C layers have identical compositions as well as a structure in which the A and C layers have different compositions.

Representative examples of film structures in accordance with the present disclosure that may be implemented in a cast film process include but are not limited to the following:
A-B-A
A-A-B-A
A-B-A-A
A-A-B-A-A
A-B-A-A-A
A-B-A-B-A
A-B-A-A-A-A-A
A-A-B-A-A-A-A
A-A-A-B-A-A-A
A-B-A-A-A-B-A
A-B-A-A-B-A-A
A-B-A-B-A-A-A
A-B-A-B-A-B-A
A-B-A-A-A-A-AA
A-A-B-A-A-A-A-A
A-A-A-B-A-A-A-A
A-B-A-A-A-A-B-A
A-C-B-C-A
A-C-A-C-B-C-A
A-C-B-C-A-C-A
A-C-A-C-B-C-A-C-A
A-C-B-C-A-C-A-C-A
A-C-B-C-A-B-C-A.

Additionally, die technology that allows production of multiple layers in a multiplier fashion may be used. For example, an ABA structure may be multiplied from about 10 to about 1000 times. The resulting 10-time multiplied ABA structure may be expressed as follows:
A-B-A-A-B-A-A-B-A-A-B-A-A-B-A-A-B-A-A-B-A-A-B-A-A-B-A-A-B-A

Representative applications using a machine direction-oriented polymeric film in accordance with the present disclosure include but are not limited to packaging applications (e.g., bag-in-box packaging, dry food packaging, stand-up pouches, liquid packaging, pillow pouches, bags, container lidding, and/or the like). The presence of high density polyethylene in at least one skin layer of a machine direction-oriented polymeric film in accordance with the present disclosure facilitates the use of higher temperatures during the sealing process of a packaging container (e.g., a flexible pouch), which in turn facilitates strong seal formation in the finished package. By way of example, the sealing process may utilize temperatures up to the melt temperature of the skin layer (in illustrative embodiments, 5-10° below the melt temperature).

Machine direction-oriented polymeric films in accordance with the present disclosure may be laminated, bonded, or otherwise adhered to moisture barrier webs (with or without oxygen barrier). Adhesive bonding may be used to prepare such laminates. Adhesive bonding may be performed with adhesive agents including but not limited to powders, adhesive webs, liquid adhesives, hot-melt adhesives, solvent-based adhesives, solvent-less adhesives, aqueous adhesives, polymeric adhesives (e.g., extrusion lamination), and the like. Additionally, these types of support may be used with ultrasonic bonding, thermal bonding, or thermal lamination if the polymers in the support are compatible with the film surface.

The following examples and representative procedures illustrate features in accordance with the present disclosure, and are provided solely by way of illustration. They are not intended to limit the scope of the appended claims or their equivalents.

### EXAMPLES

### Example 1

### Five-Layered Machine Direction-Oriented Polymeric Film

In this experiment, a five-layered precursor film was made using a blown film process and later subjected to MD orientation to form machine direction-oriented polymeric films in accordance with the present disclosure. The five-layered precursor films was made from the formulations X18-056A shown in Table 1.

TABLE 1
Composition of X18-056A.

| | | | Amount of |
|---|---|---|---|
| | Layer % | | Component |
| EXTRUDER | (Total) | COMPONENT | (Weight %) |
| A | 15.0 | UE637-000 | 66.0 |
| | | (Lyondell Basell, | |
| | | ULTRATHENE ® EVA | |
| | | 9%) | |
| | | 3132 | 10.0 |
| | | (ExxonMobil, EXACT ® | |
| | | POP-C6) | |
| | | PB8640M | 16.0 |
| | | (Lyondell Basell, | |
| | | polybutene-1) | |
| | | 102109 | 6.0 |
| | | (Ampacet, slip agent) | |
| | | ABC5000 | 2.0 |
| | | (Polyfil, AB de50%) | |
| B | 8.0 | 8656 ML | 96.0 |
| | | (ExxonMobil, | |
| | | EXCEED ® XP, LLDPE) | |
| | | 10090 | 4.0 |
| | | (Ampacet, slip agent, | |
| | | e5%) | |
| C | 20.0 | L5885 | 100.0 |
| | | (Lyondell Basell, | |
| | | ALATHON ® HDPE) | |
| D | 8.0 | 8656 ML | 100.0 |
| | | (ExxonMobil, | |
| | | EXCEED ® XP, LLDPE) | |
| E | 49.0 | L5885 | 98.5 |
| | | (Lyondell Basell, | |
| | | ALATHON ® HDPE) | |
| | | ABC2000 | 1.5 |
| | | (Polyfil, AB de20%) | |

The physical properties of a machine direction-oriented polymeric film made from a precursor film derived from composition X18-056A and having an initial gauge of 7 mil prior to being stretched in a machine direction at a draw ratio of 5.8 to 1 are shown in Table 2.

TABLE 2
Physical Properties of Five-Layered Machine
Direction-Oriented Polymeric Film.

| Physical Property | Units | X18-056A |
|---|---|---|
| Haze (avg. 3) | % | 22 |
| COF (avg. 3), Static - Seal/Seal | — | 0.275 |
| COF (avg. 3), Static - Out\Out | — | 0.238 |
| COF (avg. 3), Kinetic - Seal/Seal | — | 0.278 |
| COF (avg. 3), Kinetic - Out\Out | — | 0.221 |
| WVTR 3/31 mil (avg. 3) | mil | 0.990 |
| WVTR 3/31 (avg. 3) | g/100 in²/day | 0.238 |
| WVTR 90% RH | g/100 in²/day | 0.214 |
| Tensile Gauge MD (avg. 5) | mil | 1.03 |
| Stress @ Peak MD (avg. 5) | PSI | 32940 |
| Strain @ Peak MD (avg. 5) | % | 20 |
| Stress @ Break MD (avg. 5) | PSI | 32940 |
| Strain @ Break MD (avg. 5) | % | 20 |
| Stress @ Yield MD (avg. 5) | PSI | 17981 |
| Strain @ Yield MD (avg. 5) | % | 8 |
| Stress @ 5% Strain MD (avg. 5) | PSI | 10959 |
| Stress @ 10% Strain MD (avg. 5) | PSI | 20602 |
| Stress @ 25% Strain MD (avg. 5) | PSI | 0 |
| Stress @ 50% Strain MD (avg. 5) | PSI | 0 |
| Stress @ 100% Strain MD (avg. 5) | PSI | 0 |
| Secant Modulus MD (1%) (avg. 5) | PSI | 341821 |
| TEA MD (avg. 5) | in · lbf | 8 |
| Elmendorf Tear MD Arm | g | 200 |
| Elmendorf Tear MD (avg. 5) | gf | 105 |
| Tensile Gauge TD (avg. 5) | mil | 1.03 |
| Stress @ Peak TD (avg. 5) | PSI | 4110 |
| Strain @ Peak TD (avg. 5) | % | 3 |
| Stress @ Break TD (avg. 5) | PSI | 4110 |
| Strain @ Break TD (avg. 5) | % | 3 |
| Stress @ Yield TD (avg. 5) | PSI | 3000 |
| Strain @ Yield TD (avg. 5) | % | 3 |
| Stress @ 5% Strain TD (avg. 5) | PSI | 0 |
| Stress @ 10% Strain TD (avg. 5) | PSI | 0 |
| Stress @ 25% Strain TD (avg. 5) | PSI | 0 |
| Stress @ 50% Strain TD (avg. 5) | PSI | 0 |
| Stress @ 100% Strain TD (avg. 5) | PSI | 0 |
| Secant Modulus TD (1%) (avg. 5) | PSI | 256446 |
| TEA TD (avg. 5) | in · lbf | 0.10 |
| Elmendorf Tear TD Arm | g | 200 |
| Elmendorf Tear TD (avg. 5) | gf | 115 |
| Slow Puncture (avg. 5) - ⅛″ (Kraft) | gf | 410 |
| Slow Puncture (avg. 5) - 1/32″ | gf | 161 |

### Example 2

### Nine-Layered Machine Direction-Oriented Polymeric Film

In this experiment, a nine-layered precursor film was made using a blown film process and later subjected to MD orientation to form a machine direction-oriented polymeric film in accordance with the present disclosure. The nine-layered precursor film was made from the formulation X18-108B shown in Table 3.

TABLE 3
Composition of X18-108B.

| | | | Amount of |
|---|---|---|---|
| | Layer % | | Component |
| EXTRUDER | (Total) | COMPONENT | (Weight %) |
| A | 15.0 | EF528XW | 53.0 |
| | | (Westlake, ELEVATE ® | |
| | | EVA 18.5%) | |
| | | 640i | 8.0 |
| | | (Dow Chemical | |
| | | Company, LDPE) | |
| | | 3132 | 15.0 |
| | | (ExxonMobil, EXACT ® | |
| | | POP-C6) | |
| | | PB8640M | 16.0 |
| | | (Lyondell Basell, | |
| | | polybutene-1) | |
| | | 102109 | 6.0 |
| | | (Ampacet, slip agent) | |
| | | ABC5000 | 2.0 |
| | | (Polyfil, AB de50%) | |
| B | 13.0 | L5885 | 95.0 |
| | | (Lyondell Basell, | |
| | | ALATHON ® HDPE) | |
| | | 10090 | 5.0 |
| | | (Ampacet, slip agent, | |
| | | e5%) | |
| C | 12.0 | L5885 | 91.0 |
| | | (Lyondell Basell, | |
| | | ALATHON ® HDPE) | |
| | | 1801048-N | 9.0 |
| | | (Ampacet, cAmber 35%) | |
| D | 7.0 | 8656 ML | 85.0 |
| | | (ExxonMobil, | |
| | | EXCEED ® XP, LLDPE) | |
| | | 41E710 | 15.0 |
| | | (Dupont, BYNEL ®, | |
| | | anhydride-modified | |
| | | LLDPE) | |
| E | 3.5 | ET3803 | 100.0 |
| | | (Soarus, SOARNOL ® | |
| | | EVOH 38%) | |
| F | 7.0 | 8656 ML | 85.0 |
| | | (ExxonMobil, | |
| | | EXCEED ® XP, LLDPE) | |
| | | 41E710 | 15.0 |
| | | (Dupont, BYNEL ®, | |
| | | anhydride-modified | |
| | | LLDPE) | |
| G | 14.0 | L5885 | 90.0 |
| | | (Lyondell Basell, | |
| | | ALATHON ® HDPE) | |
| | | 1801048-N | 10.0 |
| | | (Ampacet, cAmber 35%) | |
| H | 13.5 | L5885 | 100.0 |
| | | (Lyondell Basell, | |
| | | ALATHON ® HDPE) | |
| I | 15.0 | L5885 | 98.5 |
| | | (Lyondell Basell, | |
| | | ALATHON ® HDPE) | |
| | | ABC2000 | 1.5 |
| | | (Polyfil, AB de20%) | |

The physical properties of a machine direction-oriented polymeric film made from a precursor film derived from composition X18-108B and having an initial gauge of 7.5 mil prior to being stretched in a machine direction at a draw ratio of 6.8 to 1 are shown below in Table 4.

TABLE 4
Physical Properties of Nine-Layered Machine
Direction-Oriented Polymeric Film.

| Physical Property | Units | X18-108B |
|---|---|---|
| Haze (avg. 3) | % | |
| COF (avg. 3), Static - Seal/Seal | — | 0.122 |
| COF (avg. 3), Static - Out\Out | — | 0.348 |
| COF (avg. 3), Kinetic - Seal/Seal | — | 0.115 |
| COF (avg. 3), Kinetic - Out\Out | — | 0.351 |
| WVTR 3/31 mil (avg. 3) | mil | 1.160 |
| WVTR 3/31 (avg. 3) | g/100 in²/day | 0.140 |
| WVTR 90% RH | g/100 in²/day | 0.126 |
| Tensile Gauge MD (avg. 5) | mil | 1.25 |
| Stress @ Peak MD (avg. 5) | PSI | 31011 |
| Strain @ Peak MD (avg. 5) | % | 21 |
| Stress @ Break MD (avg. 5) | PSI | 30420 |
| Strain @ Break MD (avg. 5) | % | 23 |
| Stress @ Yield MD (avg. 5) | PSI | 16448 |
| Strain @ Yield MD (avg. 5) | % | 7 |
| Stress @ 5% Strain MD (avg. 5) | PSI | 11828 |
| Stress @ 10% Strain MD (avg. 5) | PSI | 21466 |
| Stress @ 25% Strain MD (avg. 5) | PSI | 33085 |
| Stress @ 50% Strain MD (avg. 5) | PSI | 0 |
| Stress @ 100% Strain MD (avg. 5) | PSI | 0 |
| Secant Modulus MD (1%) (avg. 5) | PSI | 314685 |
| TEA MD (avg. 5) | in · lbf | 12 |
| Elmendorf Tear MD Arm | g | 200 |
| Elmendorf Tear MD (avg. 5) | gf | 86 |
| Tensile Gauge TD (avg. 5) | mil | 1.16 |
| Stress @ Peak TD (avg. 5) | PSI | 4983 |
| Strain @ Peak TD (avg. 5) | % | 5 |
| Stress @ Break TD (avg. 5) | PSI | 4776 |
| Strain @ Break TD (avg. 5) | % | 6 |
| Stress @ Yield TD (avg. 5) | PSI | 4435 |
| Strain @ Yield TD (avg. 5) | % | 4 |
| Stress @ 5% Strain TD (avg. 5) | PSI | 4632 |
| Stress @ 10% Strain TD (avg. 5) | PSI | 0 |
| Stress @ 25% Strain TD (avg. 5) | PSI | 0 |
| Stress @ 50% Strain TD (avg. 5) | PSI | 0 |
| Stress @ 100% Strain TD (avg. 5) | PSI | 0 |
| Secant Modulus TD (1%) (avg. 5) | PSI | 243886 |
| TEA TD (avg. 5) | in · lbf | 0.30 |
| Elmendorf Tear TD Arm | g | 400 |
| Elmendorf Tear TD (avg. 5) | gf | 160 |
| Slow Puncture (avg. 5) - ⅛″ (Kraft) | gf | 535 |
| Slow Puncture (avg. 5) - 1/32″ | gf | 947 |

### Example 3

### Nine-Layered Machine Direction-Oriented Polymeric Film

In this experiment, a nine-layered precursor film was made using a blown film process and later subjected to MD orientation to form a machine direction-oriented polymeric film in accordance with the present disclosure. The nine-layered precursor film was made from the formulation X18-108D shown in Table 5.

TABLE 5
Composition of X18-108D.

| | | | Amount of |
|---|---|---|---|
| | Layer % | | Component |
| EXTRUDER | (Total) | COMPONENT | (Weight %) |
| A | 15.0 | EF528XW | 54.0 |
| | | (Westlake, ELEVATE ® | |
| | | EVA 18.5%) | |
| | | 640i | 10.0 |
| | | (Dow Chemical | |
| | | Company, LDPE) | |
| | | 3132 | 10.0 |
| | | (ExxonMobil, EXACT ® | |
| | | POP-C6) | |
| | | PB8640M | 18.0 |
| | | (Lyondell Basell, | |
| | | polybutene-1) | |
| | | 102109 | 6.0 |
| | | (Ampacet, slip agent) | |
| | | ABC5000 | 2.0 |
| | | (Polyfil, AB de50%) | |
| B | 12.0 | L5885 | 90.0 |
| | | (Lyondell Basell, | |
| | | ALATHON ® HDPE) | |
| | | 8656 ML | 5.0 |
| | | (ExxonMobil, | |
| | | EXCEED ® XP, | |
| | | mLLDPE) | |
| | | 10090 | 5.0 |
| | | (Ampacet, slip agent, | |
| | | e5%) | |
| C | 12.0 | L5885 | 86.0 |
| | | (Lyondell Basell, | |
| | | ALATHON ® HDPE) | |
| | | 8656 ML | 5.0 |
| | | (ExxonMobil, | |
| | | EXCEED ® XP, | |
| | | mLLDPE) | |
| | | 1801048-N | 9.0 |
| | | (Ampacet, cAmber 35%) | |
| D | 9.0 | NF908A | 100.0 |
| | | (Mitsui, ADMER ® Adh- | |
| | | POP) | |
| E | 3.5 | ET3803 | 100.0 |
| | | (Soarus, SOARNOL ® | |
| | | EVOH 38%) | |
| F | 9.0 | NF908A | 100.0 |
| | | (Mitsui, ADMER ® Adh- | |
| | | POP) | |
| G | 12.0 | L5885 | 85.0 |
| | | (Lyondell Basell, | |
| | | ALATHON ® HDPE) | |
| | | 8656 ML | 5.0 |
| | | (ExxonMobil, | |
| | | EXCEED ® XP, | |
| | | mLLDPE) | |
| | | 1801048-N | 10.0 |
| | | (Ampacet, cAmber 35%) | |
| H | 12.5 | L5885 | 95.0 |
| | | (Lyondell Basell, | |
| | | ALATHON ® HDPE) | |
| | | 8656 ML | 5.0 |
| | | (ExxonMobil, | |
| | | EXCEED ® XP, | |
| | | mLLDPE) | |
| I | 15.0 | L5885 | 98.5 |
| | | (Lyondell Basell, | |
| | | ALATHON ® HDPE) | |
| | | ABC5000 | 1.5 |
| | | (Polyfil, AB de50%) | |

The physical properties of a machine direction-oriented polymeric film made from a precursor film derived from composition X18-108D and having an initial gauge of 7.5 mil prior to being stretched in a machine direction at a draw ratio of 6.04 to 1 to a finished gauge of 1.4 mil are shown below in Table 6.

TABLE 6
Physical Properties of Nine-Layered Machine
Direction-Oriented Polymeric Film.

| Physical Property | Units | X18-108D |
|---|---|---|
| Gauge (avg. 5) | mil | 1.40 |
| Haze (avg. 3) | % | 68.3 |
| Light Transmission (avg. 3) | % | 63.0 |
| Gloss (avg. 3) - In | % @ 45° | 24.3 |
| Gloss (avg. 3) - Out | % @ 45° | 20.7 |
| COF (avg. 3), Static - In\In | — | 0.330 |
| COF (avg. 3), Static - Out\Out | — | 0.148 |
| COF (avg. 3), Kinetic In\In | — | 0.314 |
| COF (avg. 3), Kinetic - Out\Out | — | 0.142 |
| WVTR 3/31 mil (avg. 2) | mil | 1.35 |
| WVTR 3/31 (avg. 2) | g/100 in²/day | 0.178 |
| OTR 2/20H mil (avg. 2) | mil | 1.40 |
| OTR 2/20H (avg. 2) | cc/100 in²/day | 0.342 |
| Heat Shrink MD (avg. 3) | MD, % | 3 |
| Heat Shrink TD (avg. 3) | TD, % | 0 |
| Tensile Gauge MD (avg. 5) | mil | 1.37 |
| Stress @ Peak MD (avg. 5) | PSI | 27,359 |
| Strain @ Peak MD (avg. 5) | % | 28 |
| Stress @ Break MD (avg. 5) | PSI | 26,276 |
| Strain @ Break MD (avg. 5) | % | 34 |
| Stress @ Yield MD (avg. 5) | PSI | 10,934 |
| Strain @ Yield MD (avg. 5) | % | 7 |
| Stress @ 5% Strain MD (avg. 5) | PSI | 7,992 |
| Stress @ 10% Strain MD (avg. 5) | PSI | 15,028 |
| Stress @ 25% Strain MD (avg. 5) | PSI | 27,003 |
| Stress @ 50% Strain MD (avg. 5) | PSI | 0 |
| Stress @ 100% Strain MD (avg. 5) | PSI | 0 |
| Secant Modulus MD (1%) (avg. 5) | PSI | 244,168 |
| TEA MD (avg. 5) | in · lbf | 18 |
| Elmendorf Tear MD Arm | g | 200 |
| Elmendorf Tear MD (avg. 5) | gf | 61 |
| Tensile Gauge TD (avg. 5) | mil | 1.49 |
| Stress @ Peak TD (avg. 5) | PSI | 4,376 |
| Strain @ Peak TD (avg. 5) | % | 6 |
| Stress @ Break TD (avg. 5) | PSI | 2,362 |
| Strain @ Break TD (avg. 5) | % | 17 |
| Stress @ Yield TD (avg. 5) | PSI | 4,157 |
| Strain @ Yield TD (avg. 5) | % | 5 |
| Stress @ 5% Strain TD (avg. 5) | PSI | 3,871 |
| Stress @ 10% Strain TD (avg. 5) | PSI | 3,438 |
| Stress @ 25% Strain TD (avg. 5) | PSI | 1,686 |
| Stress @ 50% Strain TD (avg. 5) | PSI | 0 |
| Stress @ 100% Strain TD (avg. 5) | PSI | 0 |
| Secant Modulus TD (1%) (avg. 5) | PSI | 212,797 |
| TEA TD (avg. 5) | in · lbf | 1 |
| Elmendorf Tear TD Arm | g | 800 |
| Elmendorf Tear TD (avg. 5) | gf | 166 |
| Puncture (avg. 5) - ⅛″ (Kraft) | gf | 672 |

### Example 4

### Nine-Layered Machine Direction-Oriented Polymeric Film

In this experiment, a nine-layered precursor film was made using a blown film process and later subjected to MD orientation to form a machine direction-oriented polymeric film in accordance with the present disclosure. The nine-layered precursor film was made from the formulation X18-056B shown in Table 7.

TABLE 7
Composition of X18-056B.

| | | | Amount of |
|---|---|---|---|
| | Layer % | | Component |
| EXTRUDER | (Total) | COMPONENT | (Weight %) |
| A | 15.0 | UE637-000 | 66.0 |
| | | (Lyondell Basell, | |
| | | ULTRATHENE ® EVA | |
| | | 9%) | |
| | | 3132 | 10.0 |
| | | (ExxonMobil, EXACT ® | |
| | | POP-C6) | |
| | | PB8640M | 16.0 |
| | | (Lyondell Basell, | |
| | | polybutene-1) | |
| | | 102109 | 6.0 |
| | | (Ampacet, slip agent) | |
| | | ABC5000 | 2.0 |
| | | (Polyfil, AB de50%) | |
| B | 11.0 | 8656 ML | 96.0 |
| | | (ExxonMobil, | |
| | | EXCEED ® XP, | |
| | | mLLDPE) | |
| | | 10090 | 4.0 |
| | | (Ampacet, slip agent, | |
| | | e5%) | |
| C | 10.0 | L5885 | 95.0 |
| | | (Lyondell Basell, | |
| | | ALATHON ® HDPE) | |
| | | 8656 ML | 5.0 |
| | | (ExxonMobil, | |
| | | EXCEED ® XP, | |
| | | mLLDPE) | |
| D | 6.0 | L5885 | 95.0 |
| | | (Lyondell Basell, | |
| | | ALATHON ® HDPE) | |
| | | 8656 ML | 5.0 |
| | | (ExxonMobil, | |
| | | EXCEED ® XP, | |
| | | mLLDPE) | |
| E | 5.0 | L5885 | 95.0 |
| | | (Lyondell Basell, | |
| | | ALATHON ® HDPE) | |
| | | 8656 ML | 5.0 |
| | | (ExxonMobil, | |
| | | EXCEED ® XP, | |
| | | mLLDPE) | |
| F | 7.0 | 8656 ML | 100.0 |
| | | (ExxonMobil, | |
| | | EXCEED ® XP, | |
| | | mLLDPE) | |
| G | 15.0 | L5885 | 95.0 |
| | | (Lyondell Basell, | |
| | | ALATHON ® HDPE) | |
| | | 8656 ML | 5.0 |
| | | (ExxonMobil, | |
| | | EXCEED ® XP, | |
| | | mLLDPE) | |
| H | 16.0 | L5885 | 95.0 |
| | | (Lyondell Basell, | |
| | | ALATHON ® HDPE) | |
| | | 8656 ML | 5.0 |
| | | (ExxonMobil, | |
| | | EXCEED ® XP, | |
| | | mLLDPE) | |
| I | 15.0 | L5885 | 98.5 |
| | | (Lyondell Basell, | |
| | | ALATHON ® HDPE) | |
| | | ABC5000 | 1.5 |
| | | (Polyfil, AB de50%) | |

The physical properties of a machine direction-oriented polymeric film made from a precursor film derived from composition X18-056B and having an initial gauge of 7.0 mil prior to being stretched in a machine direction at a draw ratio of 6.3 to 1 to a finished gauge of 1.25 mil are shown below in Table 8.

TABLE 8
Physical Properties of Nine-Layered Machine
Direction-Oriented Polymeric Film.

| Physical Property | Units | X18-056B |
|---|---|---|
| Gauge (avg. 5) | mil | 1.27 |
| Haze (avg. 3) | % | 37.9 |
| Gloss (avg. 3) - In | % @ 45° | 28.4 |
| Gloss (avg. 3) - Out | % @ 45° | 27.0 |
| COF (avg. 3), Static - In\In | — | 0.293 |
| COF (avg. 3), Static - Out\Out | — | 0.238 |
| COF (avg. 3), Kinetic In\In | — | 0.226 |
| COF (avg. 3), Kinetic - Out\Out | — | 0.211 |
| WVTR 3/31 mil (avg. 2) | mil | 1.24 |
| WVTR 3/31 (avg. 2) 100% RH | g/100 in²/day | 0.205 |
| Heat Shrink MD (avg. 3) | MD, % | 3 |
| Heat Shrink TD (avg. 3) | TD, % | 0 |
| Tensile Gauge MD (avg. 5) | mil | 1.27 |
| Stress @ Peak MD (avg. 5) | PSI | 25,764 |
| Strain @ Peak MD (avg. 5) | % | 26 |
| Stress @ Break MD (avg. 5) | PSI | 25,298 |
| Strain @ Break MD (avg. 5) | % | 29 |
| Stress @ Yield MD (avg. 5) | PSI | 19,320 |
| Strain @ Yield MD (avg. 5) | % | 14 |
| Stress @ 5% Strain MD (avg. 5) | PSI | 7,505 |
| Stress @ 10% Strain MD (avg. 5) | PSI | 14,914 |
| Stress @ 25% Strain MD (avg. 5) | PSI | 25,749 |
| Stress @ 50% Strain MD (avg. 5) | PSI | 0 |
| Stress @ 100% Strain MD (avg. 5) | PSI | 0 |
| Secant Modulus MD (1%) (avg. 5) | PSI | 223,743 |
| TEA MD (avg. 5) | in · lbf | 13 |
| Elmendorf Tear MD Arm | g | 200 |
| Elmendorf Tear MD (avg. 5) | gf | 90 |
| Tensile Gauge TD (avg. 5) | mil | 1.21 |
| Stress @ Peak TD (avg. 5) | PSI | 4,614 |
| Strain @ Peak TD (avg. 5) | % | 5 |
| Stress @ Break TD (avg. 5) | PSI | 4,614 |
| Strain @ Break TD (avg. 5) | % | 5 |
| Stress @ Yield TD (avg. 5) | PSI | 4,335 |
| Strain @ Yield TD (avg. 5) | % | 5 |
| Stress @ 5% Strain TD (avg. 5) | PSI | 4,541 |
| Stress @ 10% Strain TD (avg. 5) | PSI | 0 |
| Stress @ 25% Strain TD (avg. 5) | PSI | 0 |
| Stress @ 50% Strain TD (avg. 5) | PSI | 0 |
| Stress @ 100% Strain TD (avg. 5) | PSI | 0 |
| Secant Modulus TD (1%) (avg. 5) | PSI | 205,473 |
| TEA TD (avg. 5) | in · lbf | 0 |
| Elmendorf Tear TD Arm | g | 800 |
| Elmendorf Tear TD (avg. 5) | gf | 258 |
| Puncture (avg. 5) - ASTM 7192 1/32″ | gf | 261 |
| Puncture (avg. 5) - ⅛″ (Kraft) | gf | 719 |

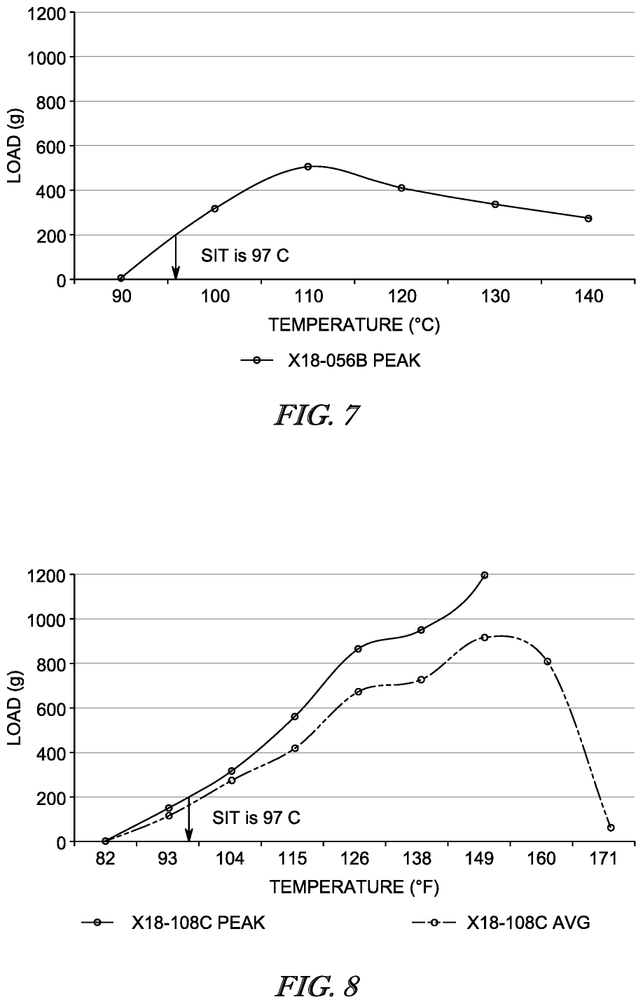

FIG. 7 shows a heat seal curve of load (grams) vs. temperature (° C.) for the film prepared from formulation X18-056B described in Example 4.

The seal initiation temperature (SIT) describes the temperature point on the heat seal curve at which the force reaches 200 grams/inch during the pull. The test conditions that were used for measuring heat seal strength in Examples 4 through 8 (FIGS. 7-11) were as follows: Jaw Pressure=60 PSI; Test Speed=30 cm/min; Dwell Time=1 second; and Cooling=10 seconds. ASTM F88-00 describes a method for measuring seal strength in flexible materials (e.g., the force required to separate the test strips after the seal is made). ASTM F2029-00 describes the laboratory preparation of heat seals and evaluation of seal strength, and is used for measuring seal parameters (e.g., temperature, dwell time, pressure, and speed). The entire contents of ASTM F88-00 and ASTM F2029-00 are incorporated by reference herein, except that in the event of any inconsistent disclosure or definition from the present specification, the disclosure or definition herein shall be deemed to prevail.

As shown in FIG. 7, the SIT for the film prepared from formulation X18-056B is 97° C.

### Example 5

### Nine-Layered Machine Direction-Oriented Polymeric Film

In this experiment, a nine-layered precursor film was made using a blown film process and later subjected to MD orientation to form a machine direction-oriented polymeric film in accordance with the present disclosure. The nine-layered precursor film was made from the formulation X18-108C shown in Table 9.

TABLE 9
Composition of X18-108C.

| | | | Amount of |
|---|---|---|---|
| | Layer % | | Component |
| EXTRUDER | (Total) | COMPONENT | (Weight %) |
| A | 15.0 | EF528XW | 53.0 |
| | | (Westlake, ELEVATE ® | |
| | | EVA 18.5%) | |
| | | 640i | 8.0 |
| | | (Dow Chemical | |
| | | Company, LDPE) | |
| | | 3132 | 13.0 |
| | | (ExxonMobil, EXACT ® | |
| | | POP-C6) | |
| | | PB8640M | 18.0 |
| | | (Lyondell Basell, | |
| | | polybutene-1) | |
| | | 102109 | 6.0 |
| | | (Ampacet, slip agent) | |
| | | ABC5000 | 2.0 |
| | | (Polyfil, AB de50%) | |
| B | 13.0 | L5885 | 85.0 |
| | | (Lyondell Basell, | |
| | | ALATHON ® HDPE) | |
| | | 8656 ML | 10.0 |
| | | (ExxonMobil, | |
| | | EXCEED ® XP, | |
| | | mLLDPE) | |
| | | 10090 | 5.0 |
| | | (Ampacet, slip agent, | |
| | | e5%) | |
| C | 12.0 | L5885 | 81.0 |
| | | (Lyondell Basell, | |
| | | ALATHON ® HDPE) | |
| | | 8656 ML | 10.0 |
| | | (ExxonMobil, | |
| | | EXCEED ® XP, | |
| | | mLLDPE) | |
| | | 1801048-N | 9.0 |
| | | (Ampacet, cAmber 35%) | |
| D | 7.0 | 8656 ML | 80.0 |
| | | (ExxonMobil, | |
| | | EXCEED ® XP, | |
| | | mLLDPE) | |
| | | 41E710 | 20.0 |
| | | (Dupont, BYNEL ®, | |
| | | anhydride-modified | |
| | | LLDPE) | |
| E | 3.5 | ET3803 | 100.0 |
| | | (Soarus, SOARNOL ® | |
| | | EVOH 38%) | |
| F | 7.0 | 8656 ML | 80.0 |
| | | (ExxonMobil, | |
| | | EXCEED ® XP, | |
| | | mLLDPE) | |
| | | 41E710 | 20.0 |
| | | (Dupont, BYNEL ®, | |
| | | anhydride-modified | |
| | | LLDPE) | |
| G | 14.0 | L5885 | 80.0 |
| | | (Lyondell Basell, | |
| | | ALATHON ® HDPE) | |
| | | 8656 ML | 10.0 |
| | | (ExxonMobil, | |
| | | EXCEED ® XP, | |
| | | mLLDPE) | |
| | | 1801048-N | 10.0 |
| | | (Ampacet, cAmber 35%) | |
| H | 13.5 | L5885 | 90.0 |
| | | (Lyondell Basell, | |
| | | ALATHON ® HDPE) | |
| | | 8656 ML | 10.0 |
| | | (ExxonMobil, | |
| | | EXCEED ® XP, | |
| | | mLLDPE) | |
| I | 15.0 | L5885 | 98.5 |
| | | (Lyondell Basell, | |
| | | ALATHON ® HDPE) | |
| | | ABC5000 | 1.5 |
| | | (Polyfil, AB de50%) | |

The physical properties of a machine direction-oriented polymeric film made from a precursor film derived from composition X18-108C and having an initial gauge of 8.5 mil prior to being stretched in a machine direction at a draw ratio of 6.04 to 1 to a finished gauge of 1.4 mil are shown below in Table 10.

TABLE 10
Physical Properties of Nine-Layered Machine
Direction-Oriented Polymeric Film.

| Physical Property | Units | X18-108C |
|---|---|---|
| Gauge (avg. 5) | mil | 1.40 |
| Haze (avg. 3) | % | 68.3 |
| Light Transmission (avg. 3) | % | 63.0 |
| Gloss (avg. 3) - In | % @ 45° | 24.3 |
| Gloss (avg. 3) - Out | % @ 45° | 20.7 |
| COF (avg. 3), Static - In\In | — | 0.330 |
| COF (avg. 3), Static - Out\Out | — | 0.148 |
| COF (avg. 3), Kinetic In\In | — | 0.314 |
| COF (avg. 3), Kinetic - Out\Out | — | 0.142 |
| WVTR 3/31 mil (avg. 2) | mil | 1.35 |
| WVTR 3/31 (avg. 2) | g/100 in²/day | 0.178 |
| OTR 2/20H mil (avg. 2) | mil | 1.40 |
| OTR 2/20H (avg. 2) | cc/100 in²/day | 0.342 |
| Heat Shrink MD (avg. 3) | MD, % | 3 |
| Heat Shrink TD (avg. 3) | TD, % | 0 |
| Tensile Gauge MD (avg. 5) | mil | 1.37 |
| Stress @ Peak MD (avg. 5) | PSI | 27,359 |
| Strain @ Peak MD (avg. 5) | % | 28 |
| Stress @ Break MD (avg. 5) | PSI | 26,276 |
| Strain @ Break MD (avg. 5) | % | 34 |
| Stress @ Yield MD (avg. 5) | PSI | 10,934 |
| Strain @ Yield MD (avg. 5) | % | 7 |
| Stress @ 5% Strain MD (avg. 5) | PSI | 7,992 |
| Stress @ 10% Strain MD (avg. 5) | PSI | 15,028 |
| Stress @ 25% Strain MD (avg. 5) | PSI | 27,003 |
| Stress @ 50% Strain MD (avg. 5) | PSI | 0 |
| Stress @ 100% Strain MD (avg. 5) | PSI | 0 |
| Secant Modulus MD (1%) (avg. 5) | PSI | 244,168 |
| TEA MD (avg. 5) | in · lbf | 18 |
| Elmendorf Tear MD Arm | g | 200 |
| Elmendorf Tear MD (avg. 5) | gf | 61 |
| Tensile Gauge TD (avg. 5) | mil | 1.49 |
| Stress @ Peak TD (avg. 5) | PSI | 4,376 |
| Strain @ Peak TD (avg. 5) | % | 6 |
| Stress @ Break TD (avg. 5) | PSI | 2,362 |
| Strain @ Break TD (avg. 5) | % | 17 |
| Stress @ Yield TD (avg. 5) | PSI | 4,157 |
| Strain @ Yield TD (avg. 5) | % | 5 |
| Stress @ 5% Strain TD (avg. 5) | PSI | 3,871 |
| Stress @ 10% Strain TD (avg. 5) | PSI | 3,438 |
| Stress @ 25% Strain TD (avg. 5) | PSI | 1,686 |
| Stress @ 50% Strain TD (avg. 5) | PSI | 0 |
| Stress @ 100% Strain TD (avg. 5) | PSI | 0 |
| Secant Modulus TD (1%) (avg. 5) | PSI | 212,797 |
| TEA TD (avg. 5) | in · lbf | 1 |
| Elmendorf Tear TD Arm | g | 800 |
| Elmendorf Tear TD (avg. 5) | gf | 166 |
| Puncture (avg. 5) - ⅛″ (Kraft) | gf | 672 |

As shown in FIG. 8, the SIT for the film prepared from formulation X18-108C is 97° C.

### Example 6

### Nine-Layered Machine Direction-Oriented Polymeric Film

In this experiment, a nine-layered precursor film was made using a blown film process and later subjected to MD orientation to form a machine direction-oriented polymeric film in accordance with the present disclosure. The nine-layered precursor film was made from the formulation X18-056G shown in Table 11.

TABLE 11
Composition of X18-056G.

| | | | Amount of |
|---|---|---|---|
| | Layer % | | Component |
| EXTRUDER | (Total) | COMPONENT | (Weight %) |
| A | 15.0 | UE637-000 | 71.0 |
| | | (Lyondell Basell, | |
| | | ULTRATHENE ® EVA | |
| | | 9%) | |
| | | PB8640M | 10.0 |
| | | (Lyondell Basell, | |
| | | polybutene-1) | |
| | | 3132 | 10.0 |
| | | (ExxonMobil, EXACT ® | |
| | | POP-C6) | |
| | | 102109 | 6.0 |
| | | (Ampacet, slip agent) | |
| | | ABC5000 | 3.0 |
| | | (Polyfil, AB de50%) | |
| B | 11.0 | 8656 ML | 96.0 |
| | | (ExxonMobil, | |
| | | EXCEED ® XP, | |
| | | mLLDPE) | |
| | | 10090 | 4.0 |
| | | (Ampacet, slip agent, | |
| | | e5%) | |
| C | 10.0 | L5885 | 75.0 |
| | | (Lyondell Basell, | |
| | | ALATHON ® HDPE) | |
| | | FX1001 | 25.0 |
| | | (Borealis, BORSHAPE ® | |
| | | PE terpolymer) | |
| D | 9.0 | L5885 | 75.0 |
| | | (Lyondell Basell, | |
| | | ALATHON ® HDPE) | |
| | | FX1001 | 25.0 |
| | | (Borealis, BORSHAPE ® | |
| | | PE terpolymer) | |
| E | 9.0 | L5885 | 75.0 |
| | | (Lyondell Basell, | |
| | | ALATHON ® HDPE) | |
| | | FX1001 | 25.0 |
| | | (Borealis, BORSHAPE ® | |
| | | PE terpolymer) | |
| F | 9.0 | L5885 | 75.0 |
| | | (Lyondell Basell, | |
| | | ALATHON ® HDPE) | |
| | | FX1001 | 25.0 |
| | | (Borealis, BORSHAPE ® | |
| | | PE terpolymer) | |
| G | 12.0 | L5885 | 75.0 |
| | | (Lyondell Basell, | |
| | | ALATHON ® HDPE) | |
| | | FX1001 | 25.0 |
| | | (Borealis, BORSHAPE ® | |
| | | PE terpolymer) | |
| H | 8.0 | 8656 ML | 100.0 |
| | | (ExxonMobil, | |
| | | EXCEED ® XP, | |
| | | mLLDPE) | |
| I | 17.0 | L5885 | 99.0 |
| | | (Lyondell Basell, | |
| | | ALATHON ® HDPE) | |
| | | ABC5000 | 1.0 |
| | | (Polyfil, AB de50%) | |

The physical properties of a machine direction-oriented polymeric film made from a precursor film derived from composition X18-056G and having an initial gauge of 6.93 mil prior to being stretched in a machine direction at a draw ratio of 6.3 to 1 to a finished gauge of 1.15 mil are shown below in Table 12.

TABLE 12
Physical Properties of Nine-Layered Machine
Direction-Oriented Polymeric Film.

| Physical Property | Units | X18-056G |
|---|---|---|
| Gauge (avg. 5) | mil | 1.15 |
| Basis Weight (avg. 5) | g/m² | 27.27 |
| Haze (avg. 3) | % | 43.67 |
| Gloss (avg. 3) - In | % @ 45° | 21.70 |
| Gloss (avg. 3) - Out | % @ 45° | 51.77 |
| COF (avg. 3), Static - Seal\Seal | — | 0.278 |
| COF (avg. 3), Static - Out\Out | — | 0.238 |
| COF (avg. 3), Kinetic - Seal\Seal | — | 0.228 |
| COF (avg. 3), Kinetic - Out\Out | — | 0.234 |
| WVTR mil (avg. 2) | mil | 1.115 |
| WVTR @ 100% RH | g/100 in²/day | 0.263 |
| WVTR @ 90% RH | g/100 in²/day | 0.236 |
| WVTR Normalized 90% RH | g/100 in²/day-mil | 0.263 |
| Heat Shrink MD (avg. 3) | MD, % | 2 |
| Tensile Gauge MD (avg. 5) | mil | 1.14 |
| Stress @ Peak MD (avg. 5) | PSI | 30753 |
| Strain @ Peak MD (avg. 5) | % | 47 |
| Stress @ Break MD (avg. 5) | PSI | 30603 |
| Strain @ Break MD (avg. 5) | % | 56 |
| Stress @ Yield MD (avg. 5) | PSI | 10158 |
| Strain @ Yield MD (avg. 5) | % | 7 |
| Stress @ 5% Strain MD (avg. 5) | PSI | 6656 |
| Stress @ 10% Strain MD (avg. 5) | PSI | 14686 |
| Stress @ 25% Strain MD (avg. 5) | PSI | 28867 |
| Stress @ 50% Strain MD (avg. 5) | PSI | 29848 |
| Stress @ 100% Strain MD (avg. 5) | PSI | 0 |
| Secant Modulus MD (1%) (avg. 5) | PSI | 226285 |
| Trouser Tear MD (avg. 5) | gf | 82.17 |
| TEA MD (avg. 5) | in · lbf | 30.20 |
| Elmendorf Tear MD Arm | g | 400 |
| Elmendorf Tear MD (avg. 5) | gf | 207 |
| Tensile Gauge TD (avg. 5) | mil | 1.17 |
| Stress @ Peak TD (avg. 5) | PSI | 4611 |
| Strain @ Peak TD (avg. 5) | % | 7 |
| Stress @ Break TD (avg. 5) | PSI | 2271 |
| Strain @ Break TD (avg. 5) | % | 148 |
| Stress @ Yield TD (avg. 5) | PSI | 4599 |
| Strain @ Yield TD (avg. 5) | % | 7 |
| Stress @ 5% Strain TD (avg. 5) | PSI | 3354 |
| Stress @ 10% Strain TD (avg. 5) | PSI | 3896 |
| Stress @ 25% Strain TD (avg. 5) | PSI | 2338 |
| Stress @ 50% Strain TD (avg. 5) | PSI | 2047 |
| Stress @ 100% Strain TD (avg. 5) | PSI | 2155 |
| Secant Modulus TD (1%) (avg. 5) | PSI | 204363 |
| Trouser Tear TD (avg. 5) | gf | 375 |
| TEA TD (avg. 5) | in · lbf | 8 |
| Elmendorf Tear TD Arm | g | 400 |
| Elmendorf Tear TD (avg. 5) | gf | 224 |
| Dart Drop (26″) (avg. 10) | g | 40 |
| Puncture (avg. 5) - ⅛″ (Kraft) | gf | 1025 |
| Puncture (avg. 5) - 1/16″ | gf | 709 |

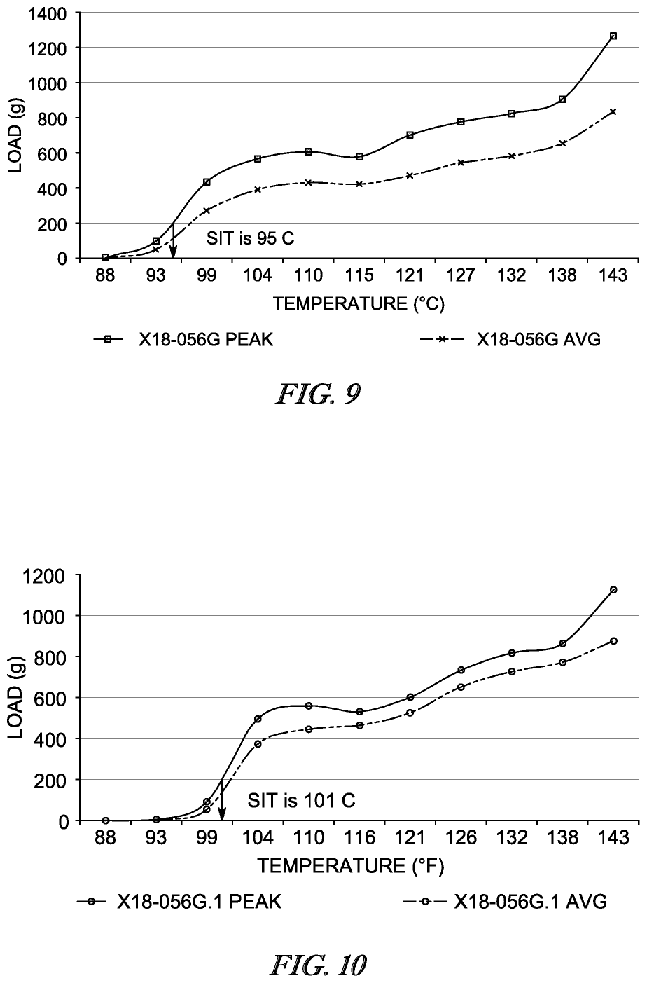

As shown in FIG. 9, the SIT for the film prepared from formulation X18-056G is 95° C.

### Example 7

### Nine-Layered Machine Direction-Oriented Polymeric Film

In this experiment, a nine-layered precursor film was made using a blown film process and later subjected to MD orientation to form a machine direction-oriented polymeric film in accordance with the present disclosure. The nine-layered precursor film was made from the formulation X18-056G.1 shown in Table 13.

TABLE 13
Composition of X18-056G.1.

| | | | Amount of |
|---|---|---|---|
| | Layer % | | Component |
| EXTRUDER | (Total) | COMPONENT | (Weight %) |
| A | 15.0 | UE637-000 | 70.0 |
| | | (Lyondell Basell, | |
| | | ULTRATHENE ® EVA | |
| | | 9%) | |
| | | PB8640M | 10.0 |
| | | (Lyondell Basell, | |
| | | polybutene-1) | |
| | | 3132 | 10.0 |
| | | (ExxonMobil, EXACT ® | |
| | | POP-C6) | |
| | | MB425V (Polymer | 4.0 |
| | | Dynamix, slip agent, | |
| | | siloxane 25%) | |
| | | 102109 | 4.0 |
| | | (Ampacet, slip agent) | |
| | | ABC5000 | 2.0 |
| | | (Polyfil, AB de50%) | |
| B | 8.0 | 8656 ML | 96.0 |
| | | (ExxonMobil, | |
| | | EXCEED ® XP, | |
| | | mLLDPE) | |
| | | 10090 | 4.0 |
| | | (Ampacet, slip agent, | |
| | | e5%) | |
| C | 12.5 | L5885 | 77.0 |
| | | (Lyondell Basell, | |
| | | ALATHON ® HDPE) | |
| | | FX1001 | 23.0 |
| | | (Borealis, BORSHAPE ® | |
| | | PE terpolymer) | |
| D | 9.0 | L5885 | 77.0 |
| | | (Lyondell Basell, | |
| | | ALATHON ® HDPE) | |
| | | FX1001 | 23.0 |
| | | (Borealis, BORSHAPE ® | |
| | | PE terpolymer) | |
| E | 9.0 | L5885 | 77.0 |
| | | (Lyondell Basell, | |
| | | ALATHON ® HDPE) | |
| | | FX1001 | 23.0 |
| | | (Borealis, BORSHAPE ® | |
| | | PE terpolymer) | |
| F | 9.0 | L5885 | 77.0 |
| | | (Lyondell Basell, | |
| | | ALATHON ® HDPE) | |
| | | FX1001 | 23.0 |
| | | (Borealis, BORSHAPE ® | |
| | | PE terpolymer) | |
| G | 12.5 | L5885 | 77.0 |
| | | (Lyondell Basell, | |
| | | ALATHON ® HDPE) | |
| | | FX1001 | 23.0 |
| | | (Borealis, BORSHAPE ® | |
| | | PE terpolymer) | |
| H | 8.0 | 8656 ML | 100.0 |
| | | (ExxonMobil, | |
| | | EXCEED ® XP, | |
| | | mLLDPE) | |
| I | 17.0 | L5885 | 99.0 |
| | | (Lyondell Basell, | |
| | | ALATHON ® HDPE) | |
| | | ABC5000 | 1.0 |
| | | (Polyfil, AB de50%) | |

The physical properties of a machine direction-oriented polymeric film made from a precursor film derived from composition X18-056G.1 and having an initial gauge of 6.8 mil prior to being stretched in a machine direction at a draw ratio of 6.2 to 1 to a finished gauge of 1.1 mil are shown below in Table 14.

TABLE 14
Physical Properties of Nine-Layered Machine
Direction-Oriented Polymeric Film.

| Physical Property | Units | X18-056G.1 |
|---|---|---|
| Gauge (avg. 5) | mil | 1.14 |
| Basis Weight (avg. 5) | g/m² | 29.11 |
| Haze (avg. 3) | % | 33.03 |
| Gloss (avg. 3) - In | % @ 45° | 29.93 |
| Gloss (avg. 3) - Out | % @ 45° | 33.57 |
| COF (avg. 3), Static - Seal\Seal | — | 0.322 |
| COF (avg. 3), Static - Out\Out | — | 0.243 |
| COF (avg. 3), Kinetic - Seal\Seal | — | 0.277 |
| COF (avg. 3), Kinetic - Out\Out | — | 0.234 |
| WVTR mil (avg. 2) | mil | 1.190 |
| WVTR @ 100% RH | g/100 in²/day | 0.224 |
| WVTR @ 90% RH | g/100 in²/day | 0.202 |
| WVTR Normalized 90% RH | g/100 in²/day-mil | 0.240 |
| Heat Shrink MD (avg. 3) | MD, % | 3 |
| Tensile Gauge MD (avg. 5) | mil | 1.19 |
| Stress @ Peak MD (avg. 5) | PSI | 24561 |
| Strain @ Peak MD (avg. 5) | % | 39 |
| Stress @ Break MD (avg. 5) | PSI | 24228 |
| Strain @ Break MD (avg. 5) | % | 61 |
| Stress @ Yield MD (avg. 5) | PSI | 14737 |
| Strain @ Yield MD (avg. 5) | % | 12 |
| Stress @ 5% Strain MD (avg. 5) | PSI | 7789 |
| Stress @ 10% Strain MD (avg. 5) | PSI | 13259 |
| Stress @ 25% Strain MD (avg. 5) | PSI | 23605 |
| Stress @ 50% Strain MD (avg. 5) | PSI | 23749 |
| Stress @ 100% Strain MD (avg. 5) | PSI | 0 |
| Secant Modulus MD (1%) (avg. 5) | PSI | 189598 |
| Trouser Tear MD (avg. 5) | gf | 145.10 |
| TEA MD (avg. 5) | in · lbf | 28.90 |
| Elmendorf Tear MD Arm | g | 400 |
| Elmendorf Tear MD (avg. 5) | gf | 136 |
| Tensile Gauge TD (avg. 5) | mil | 1.19 |
| Stress @ Peak TD (avg. 5) | PSI | 4334 |
| Strain @ Peak TD (avg. 5) | % | 6 |
| Stress @ Break TD (avg. 5) | PSI | 2156 |
| Strain @ Break TD (avg. 5) | % | 181 |
| Stress @ Yield TD (avg. 5) | PSI | 4189 |
| Strain @ Yield TD (avg. 5) | % | 5 |
| Stress @ 5% Strain TD (avg. 5) | PSI | 4223 |
| Stress @ 10% Strain TD (avg. 5) | PSI | 3425 |
| Stress @ 25% Strain TD (avg. 5) | PSI | 2264 |
| Stress @ 50% Strain TD (avg. 5) | PSI | 1912 |
| Stress @ 100% Strain TD (avg. 5) | PSI | 2100 |
| Secant Modulus TD (1%) (avg. 5) | PSI | 201591 |
| Trouser Tear TD (avg. 5) | gf | 370 |
| TEA TD (avg. 5) | in · lbf | 9 |
| Elmendorf Tear TD Arm | g | 800 |
| Elmendorf Tear TD (avg. 5) | gf | 384 |
| Dart Drop (26″) (avg. 10) | g | |
| Puncture (avg. 5) - ⅛″ (Kraft) | gf | 1011 |
| Puncture (avg. 5) - 1/16″ | gf | 639 |

As shown in FIG. 10, the SIT for the film prepared from formulation X18-056G.1 is 101° C.

### Example 8

### Nine-Layered Machine Direction-Oriented Polymeric Film

In this experiment, a nine-layered precursor film was made using a blown film process and later subjected to MD orientation to form a machine direction-oriented polymeric film in accordance with the present disclosure. The nine-layered precursor film was made from the formulation X19-129A shown in Table 15.

TABLE 15
Composition of X19-129A.

| | | | Amount of |
|---|---|---|---|
| | Layer % | | Component |
| EXTRUDER | (Total) | COMPONENT | (Weight %) |
| A | 17.5 | EF528XW | 77.0 |
| | | (Westlake, ELEVATE ® | |
| | | EVA 18.5%) | |
| | | PB8640M | 12.5 |
| | | (Lyondell Basell, | |
| | | polybutene-1) | |
| | | MB425V (Polymer | 4.0 |
| | | Dynamix, slip agent, | |
| | | siloxane 25%) | |
| | | 102109 | 4.0 |
| | | (Ampacet, slip agent) | |
| | | ABC5000 | 2.5 |
| | | (Polyfil, AB de50%) | |
| B | 12.5 | L5885 | 90.0 |
| | | (Lyondell Basell, | |
| | | ALATHON ® HDPE) | |
| | | FX1001 | 5.0 |
| | | (Borealis, BORSHAPE ® | |
| | | PE terpolymer) | |
| | | 10090 | 5.0 |
| | | (Ampacet, slip agent, | |
| | | e5%) | |
| C | 12.0 | L5885 | 92.0 |
| | | (Lyondell Basell, | |
| | | ALATHON ® HDPE) | |
| | | 1801048-N | 8.0 |
| | | (Ampacet, cAmber 35%) | |
| D | 6.5 | NF908A | 100.0 |
| | | (Mitsui, ADMER ® Adh- | |
| | | POP) | |
| E | 3.5 | ET3803 | 100.0 |
| | | (Soarus, SOARNOL ® | |
| | | EVOH 38%) | |
| F | 6.5 | NF908A | 100.0 |
| | | (Mitsui, ADMER ® Adh- | |
| | | POP) | |
| G | 12.0 | L5885 | 92.0 |
| | | (Lyondell Basell, | |
| | | ALATHON ® HDPE) | |
| | | 1801048-N | 8.0 |
| | | (Ampacet, cAmber 35%) | |
| H | 13.5 | L5885 | 95.0 |
| | | (Lyondell Basell, | |
| | | ALATHON ® HDPE) | |
| | | FX1001 | 5.0 |
| | | (Borealis, BORSHAPE ® | |
| | | PE terpolymer) | |
| I | 16.0 | L5885 | 99.0 |
| | | (Lyondell Basell, | |
| | | ALATHON ® HDPE) | |
| | | ABC5000 | 1.0 |
| | | (Polyfil, AB de50%) | |

The physical properties of a machine direction-oriented polymeric film made from a precursor film derived from composition X19-129A and having an initial gauge of 7.5 mil prior to being stretched in a machine direction at a draw ratio of 6.3 to 1 to a finished gauge of 1.18 mil are shown below in Table 16.

TABLE 16
Physical Properties of Nine-Layered Machine
Direction-Oriented Polymeric Film.

| Physical Property | Units | X19-129A |
|---|---|---|
| Gauge (avg. 5) | mil | 1.18 |
| Basis Weight (avg. 5) | g/m² | 26.89 |
| Haze (avg. 3) | % | 65.2 |
| Light Transmission (avg. 3) | % | 72.8 |
| Gloss (avg. 3) - In | % @ 45° | 19.3 |
| Gloss (avg. 3) - Out | % @ 45° | 24.9 |
| COF (avg. 3), Static - In\In | — | 0.208 |
| COF (avg. 3), Static - Out\Out | — | 0.285 |
| COF (avg. 3), Kinetic - In\In | — | 0.184 |
| COF (avg. 3), Kinetic - Out\Out | — | 0.277 |
| WVTR gauge | mil | 1.13 |
| WVTR @ 100% RH | g/100 in²/day | 0.188 |
| WVTR normalized @ 90% RH | | 0.190 |
| OTR 2/20H mil (avg. 2) | mil | 1.15 |
| OTR 2/20H (avg. 2) | cc/100 in²/day | 0.345 |
| Heat Shrink MD (avg. 3) | MD, % | 3 |
| Heat Shrink TD (avg. 3) | TD, % | 1 |
| Tensile Gauge MD (avg. 5) | mil | 1.18 |
| Stress @ Peak MD (avg. 5) | PSI | 20,605 |
| Strain @ Peak MD (avg. 5) | % | 23 |
| Stress @ Break MD (avg. 5) | PSI | 19,323 |
| Strain @ Break MD (avg. 5) | % | 29 |
| Stress @ Yield MD (avg. 5) | PSI | 10,929 |
| Strain @ Yield MD (avg. 5) | % | 8 |
| Stress @ 5% Strain MD (avg. 5) | PSI | 6,872 |
| Stress @ 10% Strain MD (avg. 5) | PSI | 12,907 |
| Stress @ 25% Strain MD (avg. 5) | PSI | 21,683 |
| Stress @ 50% Strain MD (avg. 5) | PSI | 0 |
| Stress @ 100% Strain MD (avg. 5) | PSI | 0 |
| Secant Modulus MD (1%) (avg. 5) | PSI | 232,639 |
| Trouser Tear MD (avg. 5) | gf | 299 |
| TEA MD (avg. 5) | in · lbf | 10 |
| Elmendorf Tear MD Arm | g | 200 |
| Elmendorf Tear MD (avg. 5) | gf | 94 |
| Tensile Gauge TD (avg. 5) | mil | 1.19 |
| Stress @ Peak TD (avg. 5) | PSI | 4.067 |
| Strain @ Peak TD (avg. 5) | % | 6 |
| Stress @ Break TD (avg. 5) | PSI | 880 |
| Strain @ Break TD (avg. 5) | % | 26 |
| Stress @ Yield TD (avg. 5) | PSI | 4.026 |
| Strain @ Yield TD (avg. 5) | % | 7 |
| Stress @ 5% Strain TD (avg. 5) | PSI | 3.770 |
| Stress @ 10% Strain TD (avg. 5) | PSI | 2.862 |
| Stress @ 25% Strain TD (avg. 5) | PSI | 809 |
| Stress @ 50% Strain TD (avg. 5) | PSI | 0 |
| Stress @ 100% Strain TD (avg. 5) | PSI | 0 |
| Secant Modulus TD (1%) (avg. 5) | PSI | 194.592 |
| Trouser Tear TD (avg. 5) | gf | 370 |
| TEA TD (avg. 5) | in · lbf | 1 |
| Elmendorf Tear TD Arm | g | 200 |
| Elmendorf Tear TD (avg. 5) | gf | 29.4* |
| Puncture (avg. 5) - ⅛″ (Kraft) | gf | 413 |
| Puncture (avg. 5) - 1/16″ | gf | 280 |

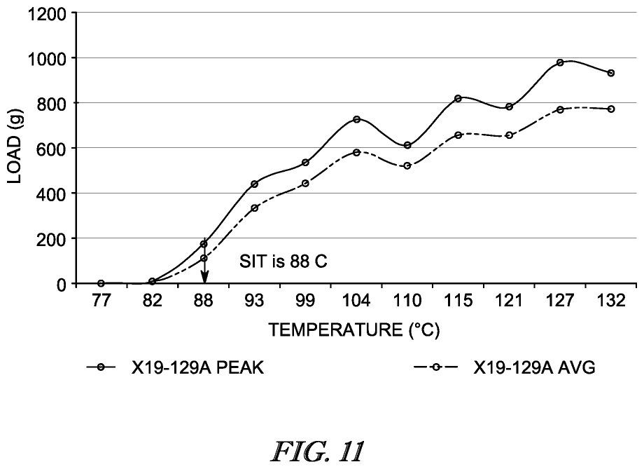

As shown in FIG. 11, the SIT for the film prepared from formulation X19-129A is 88° C.

Additional features and advantages of the present teachings can be described by the embodiments set forth in any of the following enumerated clauses. It is to be understood that any of the embodiments described herein can be used in connection with any other embodiments described herein to the extent that the embodiments do not contradict one another.

Clause 1. A machine direction-oriented polymeric film comprising

a first skin layer comprising medium molecular weight high density polyethylene,

a core layer, and

a second skin layer comprising a heat-sealable polymer.

Clause 2. The machine direction-oriented polymeric film of clause 1 further comprising at least one sub-skin layer interposed between (a) the core layer and the first skin layer and/or (b) the core layer and the second skin layer.

Clause 3. The machine direction-oriented polymeric film of any one of clauses 1-2 wherein the at least one sub-skin layer comprises polyethylene.

Clause 4. The machine direction-oriented polymeric film of any one of clauses 1-3 wherein the at least one sub-skin layer comprises linear low density polyethylene.

Clause 5. The machine direction-oriented polymeric film of any one of clauses 1-4 wherein the at least one sub-skin layer comprises metallocene linear low density polyethylene (mLLDPE).

Clause 6. The machine direction-oriented polymeric film of any one of clauses 1-5 wherein the at least one sub-skin layer comprises high density polyethylene (HDPE).

Clause 7. The machine direction-oriented polymeric film of any one of clauses 1-6 wherein the heat-sealable polymer has a lower melting point than a melting point of the high density polyethylene.

Clause 8. The machine direction-oriented polymeric film of any one of clauses 1-7 wherein the heat-sealable polymer comprises polyethylene or a copolymer thereof.

Clause 9. The machine direction-oriented polymeric film of any one of clauses 1-8 wherein the heat-sealable polymer comprises ethylene-vinyl acetate (EVA).

Clause 10. The machine direction-oriented polymeric film of any one of clauses 1-9 wherein the heat-sealable polymer comprises ethylene-propylene copolymer.

Clause 11. The machine direction-oriented polymeric film of any one of clauses 1-10 wherein the core layer comprises low density polyethylene, medium density polyethylene, high density polyethylene, linear low density polyethylene, metallocene linear low density polyethylene, ultra-low density polyethylene, or a combination thereof.

Clause 12. The machine direction-oriented polymeric film of any one of clauses 1-11 wherein the core layer comprises high density polyethylene (HDPE).

Clause 13. The machine direction-oriented polymeric film of any one of clauses 1-12 wherein the core layer comprises metallocene linear low density polyethylene (mLLDPE)

Clause 14. The machine direction-oriented polymeric film of any one of clauses 1-13 wherein the heat-sealable polymer comprises ethylene-vinyl-acetate (EVA), and wherein the core layer comprises high density polyethylene, medium density polyethylene, metallocene linear low density polyethylene, or a combination thereof.

Clause 15. The machine direction-oriented polymeric film of any one of clauses 1-14 wherein molecular weight of the medium molecular weight high density polyethylene ranges from about 5,000 to about 1,000,000 grams per mole.

Clause 16. The machine direction-oriented polymeric film of any one of clauses 1-15 wherein molecular weight of the medium molecular weight high density polyethylene ranges from about 15,000 to about 500,000 grams per mole.

Clause 17. The machine direction-oriented polymeric film of any one of clauses 1-16 wherein each of the first skin layer and the second skin layer independently comprises from about 5% to about 45% by weight of the machine direction-oriented polymeric film, wherein each of the at least one sub-skin layer comprises from about 3% to about 40% by weight of the machine direction-oriented film, and wherein the core layer comprises from about 2% to about 80% by weight of the machine direction-oriented polymeric film.

Clause 18. The machine direction-oriented polymeric film of any one of clauses 1-17 wherein the film has a thickness of between about 0.5 mil and about 2.0 mil.

Clause 19. The machine direction-oriented polymeric film of any one of clauses 1-18 wherein the film has a thickness of between about 0.5 mil and about 1.50 mil, between about 0.75 mil and about 1.30 mil, between about 0.9 mil and about 1.25 mil, between about 0.95 mil and about 1.20 mil, or between about 1.0 mil and about 1.2 mil.

Clause 20. The machine direction-oriented polymeric film of any one of clauses 1-19 wherein the film has a thickness less than about 1.25 mil.

Clause 21. A machine direction-oriented polymeric film comprising

a first skin layer,

a core layer, and

a second skin layer comprising a heat-sealable polymer, wherein a heat seal initiation temperature of the heat-sealable polymer is less than about 110° C. as measured by ASTM F2029-00 and ASTM F88-00.

Clause 22. The machine direction-oriented polymeric film of any one of clauses 1-21 further comprising at least one sub-skin layer interposed between (a) the core layer and the first skin layer and/or (b) the core layer and the second skin layer.

Clause 23. The machine direction-oriented polymeric film of any one of clauses 1-22 wherein the at least one sub-skin layer comprises polyethylene.

Clause 24. The machine direction-oriented polymeric film of any one of clauses 1-23 wherein the at least one sub-skin layer comprises linear low density polyethylene.

Clause 25. The machine direction-oriented polymeric film of any one of clauses 1-24 wherein the at least one sub-skin layer comprises metallocene linear low density polyethylene (mLLDPE).

Clause 26. The machine direction-oriented polymeric film of any one of clauses 1-25 wherein the at least one sub-skin layer comprises high density polyethylene (HDPE).

Clause 27. The machine direction-oriented polymeric film of any one of clauses 1-26 wherein the heat-sealable polymer has a lower melting point than a melting point of the high density polyethylene.

Clause 28. The machine direction-oriented polymeric film of any one of clauses 1-27 wherein the heat-sealable polymer comprises polyethylene or a copolymer thereof.

Clause 29. The machine direction-oriented polymeric film of any one of clauses 1-28 wherein the heat-sealable polymer comprises ethylene-vinyl acetate (EVA).

Clause 30. The machine direction-oriented polymeric film of any one of clauses 1-29 wherein the core layer comprises low density polyethylene, medium density polyethylene, high density polyethylene, linear low density polyethylene, metallocene linear low density polyethylene, ultra-low density polyethylene, or a combination thereof.

Clause 31. The machine direction-oriented polymeric film of any one of clauses 1-30 wherein the core layer comprises high density polyethylene (HDPE).

Clause 32. The machine direction-oriented polymeric film of any one of clauses 1-31 wherein the core layer comprises metallocene linear low density polyethylene (mLLDPE)

Clause 33. The machine direction-oriented polymeric film of any one of clauses 1-32 wherein the heat-sealable polymer comprises ethylene-vinyl-acetate (EVA), and wherein the core layer comprises high density polyethylene, medium density polyethylene, metallocene linear low density polyethylene, or a combination thereof.

Clause 34. The machine direction-oriented polymeric film of any one of clauses 1-33 wherein the heat seal initiation temperature of the heat-sealable polymer is less than about 105° C. as measured by ASTM F2029-00 and ASTM F88-00.

Clause 35. The machine direction-oriented polymeric film of any one of clauses 1-34 wherein the heat seal initiation temperature of the heat-sealable polymer is less than about 103° C. as measured by ASTM F2029-00 and ASTM F88-00.

Clause 36. The machine direction-oriented polymeric film of any one of clauses 1-35 wherein the heat seal initiation temperature of the heat-sealable polymer is less than about 100° C. as measured by ASTM F2029-00 and ASTM F88-00.

Clause 37. The machine direction-oriented polymeric film of any one of clauses 1-36 wherein the heat seal initiation temperature of the heat-sealable polymer is less than about 99° C. as measured by ASTM F2029-00 and ASTM F88-00.

Clause 38. The machine direction-oriented polymeric film of any one of clauses 1-37 wherein each of the first skin layer and the second skin layer independently comprises from about 5% to about 45% by weight of the machine direction-oriented polymeric film, wherein each of the at least one sub-skin layer comprises from about 3% to about 40% by weight of the machine direction-oriented film, and wherein the core layer comprises from about 2% to about 80% by weight of the machine direction-oriented polymeric film.

Clause 39. The machine direction-oriented polymeric film of any one of clauses 1-38 wherein the film has a thickness of between about 0.5 mil and about 2.0 mil.

Clause 40. The machine direction-oriented polymeric film of any one of clauses 1-39 wherein the film has a thickness of between about 0.5 mil and about 1.5 mil, between about 0.75 mil and about 1.30 mil, between about 0.9 mil and about 1.25 mil, between about 0.95 mil and about 1.20 mil, or between about 1.0 mil and about 1.2 mil.

Clause 41. The machine direction-oriented polymeric film of any one of clauses 1-40 wherein the film has a thickness less than about 1 mil.

Clause 42. A machine direction-oriented polymeric film comprising

a first skin layer comprising high density polyethylene,

a core layer, and

a second skin layer comprising a heat-sealable polymer,

wherein the machine direction-oriented polymeric film has a strain at break in a machine direction of less than about 100% and a 1% secant modulus in the machine direction of greater than about 150,000 pounds per square inch.

Clause 43. The machine direction-oriented polymeric film of any one of clauses 1-42 wherein the strain at break in the machine direction is less than about 75%.

Clause 44. The machine direction-oriented polymeric film of any one of clauses 1-43 wherein the strain at break in the machine direction is less than about 50%.

Clause 45. The machine direction-oriented polymeric film of any one of clauses 1-44 wherein the strain at break in the machine direction is less than about 30%.

Clause 46. The machine direction-oriented polymeric film of any one of clauses 1-45 wherein the 1% secant modulus in the machine direction is greater than about 175,000 pounds per square inch.

Clause 47. The machine direction-oriented polymeric film of any one of clauses 1-46 wherein the 1% secant modulus in the machine direction is greater than about 200,000 pounds per square inch.

Clause 48. The machine direction-oriented polymeric film of any one of clauses 1-47 wherein the 1% secant modulus in the machine direction is greater than about 225,000 pounds per square inch.

Clause 49. The machine direction-oriented polymeric film of any one of clauses 1-48 wherein the 1% secant modulus in the machine direction is greater than about 250,000 pounds per square inch.

Clause 50. The machine direction-oriented polymeric film of any one of clauses 1-49 wherein the 1% secant modulus in the machine direction is greater than about 300,000 pounds per square inch.

Clause 51. The machine direction-oriented polymeric film of any one of clauses 1-50 wherein the first skin layer has a melting point that is greater than or equal to about 115° C.

Clause 52. The machine direction-oriented polymeric film of any one of clauses 1-51 further comprising at least one sub-skin layer interposed between (a) the core layer and the first skin layer and/or (b) the core layer and the second skin layer.

Clause 53. The machine direction-oriented polymeric film of any one of clauses 1-52 wherein the at least one sub-skin layer comprises polyethylene.

Clause 54. The machine direction-oriented polymeric film of any one of clauses 1-53 wherein the at least one sub-skin layer comprises linear low density polyethylene.

Clause 55. The machine direction-oriented polymeric film of any one of clauses 1-54 wherein the at least one sub-skin layer comprises metallocene linear low density polyethylene (mLLDPE).

Clause 56. The machine direction-oriented polymeric film of any one of clauses 1-55 wherein the at least one sub-skin layer comprises high density polyethylene (HDPE).

Clause 57 The machine direction-oriented polymeric film of any one of clauses 1-56 wherein the heat-sealable polymer has a lower melting point than a melting point of the high density polyethylene.

Clause 58. The machine direction-oriented polymeric film of any one of clauses 1-57 wherein the heat-sealable polymer comprises polyethylene or a copolymer thereof.

Clause 59. The machine direction-oriented polymeric film of any one of clauses 1-58 wherein the heat-sealable polymer comprises ethylene-vinyl acetate (EVA).

Clause 60. The machine direction-oriented polymeric film of any one of clauses 1-59 wherein the core layer comprises low density polyethylene, medium density polyethylene, high density polyethylene, linear low density polyethylene, metallocene linear low density polyethylene, ultra-low density polyethylene, or a combination thereof.

Clause 61. The machine direction-oriented polymeric film of any one of clauses 1-60 wherein the core layer comprises high density polyethylene (HDPE).

Clause 62. The machine direction-oriented polymeric film of any one of clauses 1-61 wherein the core layer comprises metallocene linear low density polyethylene (mLLDPE)

Clause 63. The machine direction-oriented polymeric film of any one of clauses 1-62 wherein the heat-sealable polymer comprises ethylene-vinyl-acetate (EVA), and wherein the core layer comprises high density polyethylene, medium density polyethylene, metallocene linear low density polyethylene, or a combination thereof.

Clause 64. The machine direction-oriented polymeric film of any one of clauses 1-63 wherein each of the first skin layer and the second skin layer independently comprises from about 5% to about 45% by weight of the machine direction-oriented polymeric film, wherein each of the at least one sub-skin layer comprises from about 3% to about 40% by weight of the machine direction-oriented film, and wherein the core layer comprises from about 2% to about 80% by weight of the machine direction-oriented polymeric film.

Clause 65. The machine direction-oriented polymeric film of any one of clauses 1-64 wherein the film has a thickness of between about 0.5 mil and about 2.0 mil.

Clause 66. The machine direction-oriented polymeric film of any one of clauses 1-65 wherein the film has a thickness of between about 0.5 mil and about 1.50 mil, between about 0.75 mil and about 1.30 mil, between about 0.9 mil and about 1.25 mil, between about 0.95 mil and about 1.20 mil, or between about 1.0 mil and about 1.2 mil.

Clause 67. The machine direction-oriented polymeric film of any one of clauses 1-66 wherein the film has a thickness less than about 1.25 mil.

Clause 68. A machine direction-oriented polymeric film comprising

a first skin layer comprising high density polyethylene,

a core layer comprising ethylene vinyl alcohol (EVOH),

a second skin layer comprising ethylene-vinyl acetate (EVA),

a first tie layer interposed between the first skin layer and the core layer, the first tie layer comprising a first tie resin,

a second tie layer interposed between the second skin layer and the core layer, the second tie layer comprising a second tie resin, wherein the first tie resin and the second tie resin are the same or different,

a first sub-skin layer interposed between the first skin layer and the first tie layer, the first sub-skin layer comprising polyethylene, and

a second sub-skin layer interposed between the second skin layer and the second tie layer, the second sub-skin layer comprising polyethylene,

wherein the machine direction-oriented polymeric film has a strain at break in a machine direction of less than about 100%, and a 1% secant modulus in the machine direction of greater than about 150,000 pounds per square inch.

Clause 69. The machine direction-oriented polymeric film of any one of clauses 1-68 wherein each of the first tie resin and the second tie resin independently comprises an anhydride-modified polyethylene.

Clause 70. The machine direction-oriented polymeric film of any one of clauses 1-69 wherein each of the first tie layer and the second tie layer further comprises metallocene linear low density polyethylene (mLLDPE).

Clause 71. The machine direction-oriented polymeric film of any one of clauses 1-70 wherein each of the first sub-skin layer and the second sub-skin layer independently comprises high density polyethylene.

Clause 72. The machine direction-oriented polymeric film of any one of clauses 1-71 further comprising

a third sub-skin layer interposed between the first sub-skin layer and the first tie layer, the third sub-skin layer comprising polyethylene, and

a fourth sub-skin layer interposed between the second sub-skin layer and the second tie layer, the fourth sub-skin layer comprising polyethylene.

Clause 73. The machine direction-oriented polymeric film of any one of clauses 1-72 wherein each of the third sub-skin layer and the fourth sub-skin layer independently comprises high density polyethylene.

Clause 74. The machine direction-oriented polymeric film of any one of clauses 1-73 wherein each of the first skin layer and the second skin layer independently comprises from about 5% to about 45% by weight of the machine direction-oriented polymeric film, wherein each of the first tie layer and the second tie layer independently comprises from about 3% to about 25% by weight of the machine direction-oriented polymeric film, wherein each of the first sub-skin, the second sub-skin layer, the third sub-skin layer, and the fourth sub-skin independently comprises from about 3% to about 40% by weight of the machine direction-oriented film, and wherein the core layer comprises from about 2% to about 80% by weight of the machine direction-oriented polymeric film.

Clause 75. The machine direction-oriented polymeric film of any one of clauses 1-74 wherein the film has a thickness of between about 0.5 mil and about 2.0 mil.

Clause 76. The machine direction-oriented polymeric film of any one of clauses 1-75 wherein the film has a thickness of between about 0.5 mil and about 1.50 mil, between about 0.75 mil and about 1.30 mil, between about 0.9 mil and about 1.25 mil, between about 0.95 mil and about 1.20 mil, or between about 1.0 mil and about 1.2 mil.

Clause 77. The machine direction-oriented polymeric film of any one of clauses 1-76 wherein the film has a thickness less than about mil.

Clause 78. A packaging article comprising the machine direction-oriented polymeric film of any one of clauses 1-77.

Clause 79. The packaging article of clause 78 wherein the packaging article is selected from the group consisting of a stand-up pouch, a pillow pouch, a slug, a bag, and a container lidding.

Clause 80. A packaging article comprising the machine direction-oriented polymeric film of any one of clauses 1-77 and a moisture barrier web, wherein the machine direction-oriented polymeric film is laminated to the moisture barrier web.

Clause 81. The packing article of clause 80 wherein the moisture barrier web has oxygen barrier properties.

Clause 82. The packaging article of any one of clauses 80-81 wherein the packaging article is selected from the group consisting of a stand-up pouch, a slug, a pillow pouch, a bag, and a container lidding.

Clause 83. A process for making a machine direction-oriented polymeric film comprising the steps of

preheating a precursor film at or below a melt temperature of a polymer contained in the precursor film to form a preheated precursor film, the precursor film comprising a first skin layer comprising high density polyethylene, a core layer, and a second skin layer comprising a heat-sealable polymer,

stretching the preheated precursor film in a machine direction at a draw ratio of greater than or equal to about 5:1 at a temperature at or below the melt temperature of the polymer to form a machine direction-oriented stretched film, and

annealing the machine direction-oriented stretched film to form the machine direction-oriented polymeric film.

Clause 84. The process of clause 83 wherein the draw ratio is greater than or equal to about 6:1.

Clause 85. The process of any one of clauses 83-84 wherein the draw ratio is greater than or equal to about 7:1.

Clause 86. The process of any one of clauses 83-85 wherein the draw ratio is greater than or equal to about 8:1.

Clause 87. The process of any one of clauses 83-86 wherein the preheating is performed at a temperature between about 200° F. and about 260° F.

Clause 88. The process of any one of clauses 83-87 wherein the stretching in the machine direction is performed at a temperature between about 180° F. and about 260° F.

Clause 89. The process of any one of clauses 83-88 wherein the annealing is performed at a temperature between about 160° F. and about 260° F.

Clause 90. The process of any one of clauses 83-89 wherein the preheating is performed at a temperature between about 200° F. and about 260° F., wherein the stretching in the machine direction is performed at a temperature between about 180° F. and about 260° F., and wherein the annealing is performed at a temperature between about 160° F. and about 260° F.

Clause 91. The process of any one of clauses 83-90 further comprising the step of cooling the machine direction-oriented polymeric film after the annealing.

Clause 92. The process of any one of clauses 83-91 wherein the cooling is performed at a temperature between about 250° F. and about 140° F.

Clause 93. The process of any one of clauses 83-92 further comprising

co-extruding at least a first composition, a second composition, and a third composition to form a molten web, the first composition forming the first skin layer, the second composition forming the core layer, and the third composition forming the second skin layer, and

quenching the molten web to form the precursor film.

Clause 94. The process of any one of clauses 83-93 wherein the co-extruding, quenching, preheating, stretching, and annealing are achieved sequentially in an in-line process.

Clause 95. The process of any one of clauses 83-94 wherein the co-extruding and quenching are performed separately from the preheating, stretching, and annealing.

Clause 96. The process of any one of clauses 83-95 wherein the heat-sealable polymer comprises polyethylene or a copolymer thereof.

Clause 97. The process of any one of clauses 83-96 wherein the heat-sealable polymer comprises ethylene-vinyl-acetate (EVA).

Clause 98. The process of any one of clauses 83-97 wherein the core layer comprises low density polyethylene, medium density polyethylene, high density polyethylene, linear low density polyethylene, metallocene linear low density polyethylene, ultra-low density polyethylene, or a combination thereof.

Clause 99. The process of any one of clauses 83-98 wherein the core layer comprises high density polyethylene (HDPE).

Clause 100. The process of any one of clauses 83-99 wherein the core layer comprises metallocene linear low density polyethylene (mLLDPE)

Clause 101. The process of any one of clauses 83-100 wherein the heat-sealable polymer comprises ethylene-vinyl-acetate (EVA), and wherein the core layer comprises high density polyethylene, medium density polyethylene, metallocene linear low density polyethylene, or a combination thereof.

Clause 102. The process of any one of clauses 83-101 wherein the precursor film further comprises at least one sub-skin layer interposed between (a) the core layer and the first skin layer and/or (b) the core layer and the second skin layer, the at least one sub-skin layer comprising polyethylene.

Clause 103. The machine direction-oriented polymeric film of any one of clauses 83-102 wherein the at least one sub-skin layer comprises linear low density polyethylene.

Clause 104. The machine direction-oriented polymeric film of any one of clauses 83-103 wherein the at least one sub-skin layer comprises metallocene linear low density polyethylene (mLLDPE).

Clause 105. The machine direction-oriented polymeric film of any one of clauses 83-104 wherein the at least one sub-skin layer comprises high density polyethylene (HDPE).

Clause 106. A machine direction-oriented polymeric film comprising

a first skin layer comprising high density polyethylene,

a core layer, and

a second skin layer comprising a heat-sealable polymer,

wherein the machine direction-oriented polymeric film has a strain at break in a machine direction of less than about 100%, and a 1% secant modulus in the machine direction of greater than about 225,000 pounds per square inch.

Clause 107. The machine direction-oriented polymeric film of clause 106 further comprising at least one sub-skin layer interposed between (a) the core layer and the first skin layer and/or (b) the core layer and the second skin layer.

Clause 108. The machine direction-oriented polymeric film of any one of clauses 106-107 wherein the at least one sub-skin layer comprises polyethylene.

Clause 109. The machine direction-oriented polymeric film of any one of clauses 106-108 wherein the sub-skin layer comprises linear low density polyethylene.

Clause 110. The machine direction-oriented polymeric film of any one of clauses 106-109 wherein the sub-skin layer comprises metallocene linear low density polyethylene (mLLDPE).

Clause 111. The machine direction-oriented polymeric film of any one of clauses 106-110 wherein the heat-sealable polymer has a lower melting point than a melting point of the high density polyethylene.

Clause 112. The machine direction-oriented polymeric film of any one of clauses 106-111 wherein the heat-sealable polymer comprises polyethylene or a copolymer thereof.

Clause 113. The machine direction-oriented polymeric film of any one of clauses 106-112 wherein the heat-sealable polymer comprises ethylene-vinyl acetate (EVA).

Clause 114. The machine direction-oriented polymeric film of any one of clauses 106-113 wherein the core layer comprises low density polyethylene, medium density polyethylene, high density polyethylene, linear low density polyethylene, ultra-low density polyethylene, or a combination thereof.

Clause 115. The machine direction-oriented polymeric film of any one of clauses 106-114 wherein the core layer comprises high density polyethylene.

Clause 116. The machine direction-oriented polymeric film of any one of clauses 106-115 wherein the core layer comprises ethylene vinyl alcohol (EVOH), a polyamide, a polyester, or polyvinylidene chloride.

Clause 117. The machine direction-oriented polymeric film of any one of clauses 106-116 wherein the heat-sealable polymer comprises ethylene-vinyl-acetate (EVA), and wherein the core layer comprises ethylene vinyl alcohol (EVOH) or high density polyethylene.

Clause 118. The machine direction-oriented polymeric film of any one of clauses 106-117 wherein the core layer comprises ethylene vinyl alcohol (EVOH).

Clause 119. The machine direction-oriented polymeric film of any one of clauses 106-118 further comprising at least one tie layer adjacent to the core layer, the at least one tie layer comprising a first tie resin.

Clause 120. The machine direction-oriented polymeric film of any one of clauses 106-119 further comprising a first tie layer comprising a first tie resin and a second tie layer comprising a second tie resin, wherein the first tie resin and the second tie resin are the same or different, and wherein the core layer is interposed between the first tie layer and the second tie layer.

Clause 121. The machine direction-oriented polymeric film of any one of clauses 106-120 wherein each of the first tie resin and the second tie resin independently comprises an anhydride-modified polyethylene.

Clause 122. The machine direction-oriented polymeric film of any one of clauses 106-121 wherein each of the first tie layer and the second tie layer further comprises metallocene linear low density polyethylene (mLLDPE).

Clause 123. The machine direction-oriented polymeric film of any one of clauses 106-122 wherein the strain at break in the machine direction is less than about 50%.

Clause 124. The machine direction-oriented polymeric film of any one of clauses 106-123 wherein the strain at break in the machine direction is less than about 30%.

Clause 125. The machine direction-oriented polymeric film of any one of clauses 106-124 wherein the 1% secant modulus in the machine direction is greater than about 250,000 pounds per square inch.

Clause 126. The machine direction-oriented polymeric film of any one of clauses 106-125 wherein the 1% secant modulus in the machine direction is greater than about 300,000 pounds per square inch.

Clause 127. The machine direction-oriented polymeric film of any one of clauses 106-126 wherein the first skin layer has a melting point that is greater than or equal to about 115° C.

Clause 128. The machine direction-oriented polymeric film of any one of clauses 106-127 wherein the machine direction-oriented polymeric film has a stress at break in the machine direction of greater than about 25,000 pounds per square inch.

Clause 129. The machine direction-oriented polymeric film of any one of clauses 106-128 further comprising at least one sub-skin layer interposed between (a) the core layer and the first skin layer and/or (b) the core layer and the second skin layer, the at least one sub-skin layer comprising polyethylene.

Clause 130. The machine direction-oriented polymeric film of any one of clauses 106-129 wherein the at least one sub-skin layer comprises linear low density polyethylene or high density polyethylene.

Clause 131. The machine direction-oriented polymeric film of any one of clauses 106-130 wherein the polymeric film has a thickness of less than about 2 mil.

Clause 132. The machine direction-oriented polymeric film of any one of clauses 106-131 wherein the polymeric film has a thickness of less than about 1.5 mil.

Clause 133. The machine direction-oriented polymeric film of any one of clauses 106-132 wherein the polymeric film has a thickness of less than about 1.25 mil.

Clause 134. A machine direction-oriented polymeric film comprising

a first skin layer comprising high density polyethylene,

a core layer comprising high density polyethylene, and

a second skin layer comprising ethylene-vinyl acetate (EVA),

wherein the machine direction-oriented polymeric film has a strain at break in a machine direction of less than about 100%, and a 1% secant modulus in the machine direction of greater than about 225,000 pounds per square inch.

Clause 135. The machine direction-oriented polymeric film of any one of clauses 106-134 further comprising at least a first sub-skin layer interposed between (a) the first skin layer and the core layer and/or (b) the second skin layer and the core layer, the at least one sub-skin layer comprising linear low density polyethylene

Clause 136. The machine direction-oriented polymeric film of any one of clauses 106-135 wherein the first sub-skin layer comprises metallocene linear low density polyethylene.

Clause 137. The machine direction-oriented polymeric film of any one of clauses 106-136 further comprising at least a second sub-skin layer interposed between the core layer and the second skin layer, the second sub-skin layer comprising linear low density polyethylene.

Clause 138. The machine direction-oriented polymeric film of any one of clauses 106-137 wherein each of the first skin layer and the second skin layer independently comprises from about 5% to about 45% by weight of the machine direction-oriented polymeric film, wherein each of the first sub-skin layer and the second sub-skin layer independently comprises from about 3% to about 40% by weight of the machine direction-oriented film, and wherein the core layer comprises from about 2% to about 80% by weight of the machine direction-oriented polymeric film.

Clause 139. The machine direction-oriented polymeric film of any one of clauses 106-138 wherein the film has a thickness of between about 0.5 mil and about 2.0 mil.

Clause 140. The machine direction-oriented polymeric film of any one of clauses 106-139 wherein the film has a thickness of between about 0.5 mil and about 1.50 mil, between about 0.75 mil and about 1.30 mil, between about 0.9 mil and about 1.25 mil, between about 0.95 mil and about 1.20 mil, or between about 1.0 mil and about 1.2 mil.

Clause 141. The machine direction-oriented polymeric film of any one of clauses 106-140 wherein the film has a thickness less than about 1.25 mil.

Clause 142. A machine direction-oriented polymeric film comprising

a first skin layer comprising high density polyethylene,

a core layer comprising ethylene vinyl alcohol (EVOH),

a second skin layer comprising ethylene-vinyl acetate (EVA),

a first tie layer interposed between the first skin layer and the core layer, the first tie layer comprising a first tie resin,

a second tie layer interposed between the second skin layer and the core layer, the second tie layer comprising a second tie resin, wherein the first tie resin and the second tie resin are the same or different,

a first sub-skin layer interposed between the first skin layer and the first tie layer, the first sub-skin layer comprising polyethylene, and

a second sub-skin layer interposed between the second skin layer and the second tie layer, the second sub-skin layer comprising polyethylene,

wherein the machine direction-oriented polymeric film has a strain at break in a machine direction of less than about 100%, and a 1% secant modulus in the machine direction of greater than about 225,000 pounds per square inch.

Clause 143. The machine direction-oriented polymeric film of any one of clauses 106-142 wherein each of the first tie resin and the second tie resin independently comprises an anhydride-modified polyethylene.

Clause 144. The machine direction-oriented polymeric film of any one of clauses 106-143 wherein each of the first tie layer and the second tie layer further comprises metallocene linear low density polyethylene (mLLDPE).

Clause 145. The machine direction-oriented polymeric film of any one of clauses 106-144 wherein each of the first sub-skin layer and the second sub-skin layer independently comprises high density polyethylene.

Clause 146. The machine direction-oriented polymeric film of any one of clauses 106-145 further comprising

a third sub-skin layer interposed between the first sub-skin layer and the first tie layer, the third sub-skin layer comprising polyethylene, and

a fourth sub-skin layer interposed between the second sub-skin layer and the second tie layer, the fourth sub-skin layer comprising polyethylene.

Clause 147. The machine direction-oriented polymeric film of any one of clauses 106-146 wherein each of the third sub-skin layer and the fourth sub-skin layer independently comprises high density polyethylene.

Clause 148. The machine direction-oriented polymeric film of any one of clauses 106-147 wherein each of the first skin layer and the second skin layer independently comprises from about 5% to about 45% by weight of the machine direction-oriented polymeric film, wherein each of the first tie layer and the second tie layer independently comprises from about 3% to about 25% by weight of the machine direction-oriented polymeric film, wherein each of the first sub-skin, the second sub-skin layer, the third sub-skin layer, and the fourth sub-skin independently comprises from about 3% to about 40% by weight of the machine direction-oriented film, and wherein the core layer comprises from about 2% to about 80% by weight of the machine direction-oriented polymeric film.

Clause 149. The machine direction-oriented polymeric film of any one of clauses 106-148 wherein the film has a thickness of between about 0.5 mil and about 2.0 mil.

Clause 150. The machine direction-oriented polymeric film of any one of clauses 106-149 wherein the film has a thickness of between about 0.5 mil and about 1.50 mil, between about 0.75 mil and about 1.30 mil, between about 0.9 mil and about 1.25 mil, between about 0.95 mil and about 1.20 mil, or between about 1.0 mil and about 1.2 mil.

Clause 151. The machine direction-oriented polymeric film of any one of clauses 106-150 wherein the film has a thickness less than about 1.25 mil.

Clause 152. A packaging article comprising the machine direction-oriented polymeric film of any one of clauses 106-151.

Clause 153. The packaging article of clause 152 wherein the packaging article is selected from the group consisting of a stand-up pouch, a pillow pouch, a slug, a bag, and a container lidding.

Clause 154. A packaging article comprising the machine direction-oriented polymeric film of any one of clauses 106-151 and a moisture barrier web, wherein the machine direction-oriented polymeric film is laminated to the moisture barrier web.

Clause 155. The packing article of clause 154 wherein the moisture barrier web has oxygen barrier properties.

Clause 156. The packaging article of any one of clauses 154-155 wherein the packaging article is selected from the group consisting of a stand-up pouch, a pillow pouch, a slug, a bag, and a container lidding.

Clause 157. The process of any one of clauses 83-105 wherein the core layer comprises ethylene vinyl alcohol (EVOH), a polyamide, a polyester, or polyvinylidene chloride.

Clause 158. The process of any one of clauses 83-105 and 157 wherein the core layer comprises ethylene vinyl alcohol (EVOH).

Clause 159. The process of any one of clauses 83-105 and 157-158 wherein the precursor film further comprises a first tie layer comprising a first tie resin and a second tie layer comprising a second tie resin, wherein the first tie resin and the second tie resin are the same or different, and wherein the core layer is interposed between the first tie layer and the second tie layer.

Clause 160. The process of any one of clauses 83-105 and 157-159 wherein each of the first tie resin and the second tie resin independently comprises an anhydride-modified polyethylene.

Clause 161. The process of any one of clauses 83-105 and 157-160 wherein each of the first tie layer and the second tie layer further comprises metallocene linear low density polyethylene (mLLDPE).

Clause 162. The process of any one of clauses 83-105 and 157-161 wherein the precursor film further comprises at least one tie layer adjacent to the core layer, the at least one tie layer comprising a first tie resin.

Clause 163. The process of any one of clauses 83-105 and 157-162 wherein the at least one sub-skin layer comprises linear low density polyethylene.

Clause 164. The process of any one of clauses 83-105 and 157-163 wherein the at least one sub-skin comprises metallocene linear low density polyethylene (mLLDPE).

Clause 165. The process of any one of clauses 83-105 and 157-164 wherein the precursor film further comprises at least a first sub-skin layer interposed between (a) the core layer and the first skin layer and/or (b) the core layer and the second skin layer, the at least one sub-skin layer comprising polyethylene.

Clause 166. The process of any one of clauses 83-105 and 157-165 wherein the at least one sub-skin layer comprises linear low density polyethylene or high density polyethylene.

Clause 167. The process of any one of clauses 83-105 and 157-166 wherein the at least one sub-skin layer comprises metallocene linear low density polyethylene or high density polyethylene.

1. A machine direction-oriented polymeric film comprising
a first skin layer comprising medium molecular weight high density polyethylene (MMW-HDPE),
a core layer, and
a second skin layer comprising a heat-sealable polymer.

2. The machine direction-oriented polymeric film of claim 1 further comprising at least one sub-skin layer interposed between (a) the core layer and the first skin layer and/or (b) the core layer and the second skin layer.

3. The machine direction-oriented polymeric film of claim 1 wherein the heat-sealable polymer comprises polyethylene or a copolymer thereof.

4. The machine direction-oriented polymeric film of claim 1 wherein the heat-sealable polymer comprises ethylene-vinyl acetate (EVA).

5. The machine direction-oriented polymeric film of claim 1 wherein the heat-sealable polymer comprises ethylene-propylene copolymer.

6. The machine direction-oriented polymeric film of claim 1 wherein the core layer comprises low density polyethylene, medium density polyethylene, high density polyethylene, linear low density polyethylene, ultra-low density polyethylene, metallocene linear low density polyethylene, or a combination thereof.

7. The machine direction-oriented polymeric film of claim 1 wherein the heat-sealable polymer comprises ethylene-vinyl-acetate (EVA), and wherein the core layer comprises high density polyethylene, medium density polyethylene, metallocene linear low density polyethylene, or a combination thereof.

8. The machine direction-oriented polymeric film of claim 1 wherein number average molecular weight and weight average molecular weight of the medium molecular weight high density polyethylene (MMW-HDPE) range from about 5,000 to about 1,000,000 grams per mole.

9. A machine direction-oriented polymeric film comprising
a first skin layer,
a core layer, and
a second skin layer comprising a heat-sealable polymer, wherein a heat seal initiation temperature of the heat-sealable polymer is less than about 110° C. as measured by ASTM F2029-00 and ASTM F88-00.

10. The machine direction-oriented polymeric film of claim 9 further comprising at least one sub-skin layer interposed between (a) the core layer and the first skin layer and/or (b) the core layer and the second skin layer.

11. The machine direction-oriented polymeric film of claim 9 wherein the heat-sealable polymer comprises polyethylene or a copolymer thereof.

12. The machine direction-oriented polymeric film of claim 9 wherein the heat-sealable polymer comprises ethylene-vinyl acetate (EVA).

13. The machine direction-oriented polymeric film of claim 9 wherein the core layer comprises low density polyethylene, medium density polyethylene, high density polyethylene, linear low density polyethylene, ultra-low density polyethylene, metallocene linear low density polyethylene, or a combination thereof.

14. The machine direction-oriented polymeric film of claim 9 wherein the heat-sealable polymer comprises ethylene-vinyl-acetate (EVA), and wherein the core layer comprises high density polyethylene, medium density polyethylene, metallocene linear low density polyethylene, or a combination thereof.

15. A machine direction-oriented polymeric film comprising
a first skin layer comprising high density polyethylene,
a core layer, and
a second skin layer comprising a heat-sealable polymer,
wherein the machine direction-oriented polymeric film has a strain at break in a machine direction of less than about 100% and a 1% secant modulus in the machine direction of greater than about 150,000 pounds per square inch.

16. The machine direction-oriented polymeric film of claim 15 wherein the strain at break in the machine direction is less than about 75%.

17. The machine direction-oriented polymeric film of claim 15 wherein the 1% secant modulus in the machine direction is greater than about 175,000 pounds per square inch.

18. The machine direction-oriented polymeric film of claim 15 wherein the heat-sealable polymer comprises polyethylene or a copolymer thereof.

19. The machine direction-oriented polymeric film of claim 15 wherein the core layer comprises low density polyethylene, medium density polyethylene, high density polyethylene, linear low density polyethylene, ultra-low density polyethylene, metallocene linear low density polyethylene, or a combination thereof.

20. The machine direction-oriented polymeric film of claim 15 wherein the heat-sealable polymer comprises ethylene-vinyl-acetate (EVA), and wherein the core layer comprises high density polyethylene, medium density polyethylene, metallocene linear low density polyethylene, or a combination thereof.
